(19) United States
(12) Patent Application Publication
(10) Pub. No.: US 2025/0341951 A1
(43) Pub. Date: Nov. 6, 2025

(54) USER INTERFACES FOR MONITORING ONGOING ACTIVITIES AND TIME

(71) Applicant: Apple Inc., Cupertino, CA (US)

(72) Inventors: Christopher P. FOSS, San Francisco, CA (US); Taylor G. CARRIGAN, San Francisco, CA (US); Edward CHAO, Palo Alto, CA (US); Yeobeen CHUNG, Sunnyvale, CA (US); Louis R. MIKOLAY, San Francisco, CA (US)

(21) Appl. No.: 19/182,481

(22) Filed: Apr. 17, 2025

Related U.S. Application Data
(60) Provisional application No. 63/642,592, filed on May 3, 2024.
(60) Provisional application No. 63/657,259, filed on Jun. 7, 2024.

(51) Int. Cl. G06F 3/0484; G06F 3/0482

(52) U.S. Cl. CPC G06F 3/0484; G06F 3/0482

(57) ABSTRACT

The present disclosure generally relates to time interfaces (e.g., watch face user interfaces). In some embodiments, a computer system displays a time user interface that includes a condensed or expanded representation of time, based on whether an ongoing activity is currently active. In some embodiments, the state of on ongoing activity is synchronized across multiple computer systems. In some embodiments, a computer system includes different widgets in a set of widgets, depending on a current context. In some embodiments, one or more elements of a condensed representation of time are based on one or more elements of a corresponding expanded representation of time.

### CROSS-REFERENCE TO RELATED APPLICATIONS

This application claims priority to U.S. Provisional Patent Application No. 63/657,259, entitled “USER INTERFACES FOR MONITORING ONGOING ACTIVITIES AND TIME,” filed Jun. 7, 2024, and to U.S. Provisional Patent Application No. 63/642,592, entitled “USER INTERFACES FOR MONITORING ONGOING ACTIVITIES AND TIME,” filed May 3, 2024. The content of each of these applications is hereby incorporated by reference in their entirety.

### FIELD

The present disclosure relates generally to computer user interfaces, and more specifically to techniques for monitoring ongoing activities and time.

### BACKGROUND

Electronic devices include displays and user interface that can be used to display various types of content and to provide information to a user. Some electronic devices, such as smartphones and smartwatches, can display user interfaces that include an indication of time to provide a user with the current time. Such user interfaces can also include an indication of an ongoing activity, including ongoing activities managed at other devices and/or across multiple devices.

### BRIEF SUMMARY

Some techniques for monitoring ongoing activities and time using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for monitoring ongoing activities and time. Such methods and interfaces optionally complement or replace other methods for monitoring ongoing activities and time. Such methods and interfaces reduce the cognitive burden on a user and produce a more efficient human-machine interface. For battery-operated computing devices, such methods and interfaces conserve power and increase the time between battery charges.

In accordance with some embodiments, a method performed at a computer system that is in communication with one or more display generation components and one or more input devices is described. The method includes: receiving, via the one or more input devices, a request to display a time user interface; in response to receiving the request to display the time user interface: in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and in accordance with a determination that an activity of the first type is not in progress and the first style has been selected for the time user interface, displaying, via the one or more display generation components, a second time user interface that includes a first expanded representation of the current time without including a representation of an activity of the first type, wherein: the first condensed representation of the current time on the first time user interface is smaller than the first expanded representation of the current time on the second user interface; and both the first condensed representation of the current time and the first expanded representation of the current time are displayed with an appearance that is based on the first style; and in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and in accordance with a determination that an activity of the first type is not in progress and the second style has been selected for the time user interface, displaying, via the one or more display generation components, a fourth time user interface that includes a second expanded representation of the current time without including a representation of an activity of the first type, wherein: the second condensed representation of the current time on the third time user interface is smaller than the second expanded representation of the current time on the fourth time user interface; both the second condensed representation of the current time and the second expanded representation of the current time are displayed with an appearance that is based on the second style; the first expanded representation of the current time has a different appearance than the second expanded representation of the current time; and the first condensed representation of the current time has a different appearance than the second condensed representation of the current time.

In accordance with some embodiments, a non-transitory computer-readable storage medium storing one or more programs configured to be executed by one or more processors of a computer system that is in communication with one or more display generation components and one or more input devices is described. The one or more programs including instructions for: receiving, via the one or more input devices, a request to display a time user interface; in response to receiving the request to display the time user interface: in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and in accordance with a determination that an activity of the first type is not in progress and the first style has been selected for the time user interface, displaying, via the one or more display generation components, a second time user interface that includes a first expanded representation of the current time without including a representation of an activity of the first type, wherein: the first condensed representation of the current time on the first time user interface is smaller than the first expanded representation of the current time on the second user interface; and both the first condensed representation of the current time and the first expanded representation of the current time are displayed with an appearance that is based on the first style; and in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and in accordance with a determination that an activity of the first type is not in progress and the second style has been selected for the time user interface, displaying, via the one or more display generation components, a fourth time user interface that includes a second expanded representation of the current time without including a representation of an activity of the first type, wherein: the second condensed representation of the current time on the third time user interface is smaller than the second expanded representation of the current time on the fourth time user interface; both the second condensed representation of the current time and the second expanded representation of the current time are displayed with an appearance that is based on the second style; the first expanded representation of the current time has a different appearance than the second expanded representation of the current time; and the first condensed representation of the current time has a different appearance than the second condensed representation of the current time.

In accordance with some embodiments, a transitory computer-readable storage medium storing one or more programs configured to be executed by one or more processors of a computer system that is in communication with one or more display generation components and one or more input devices is described. The one or more programs including instructions for: receiving, via the one or more input devices, a request to display a time user interface; in response to receiving the request to display the time user interface: in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and in accordance with a determination that an activity of the first type is not in progress and the first style has been selected for the time user interface, displaying, via the one or more display generation components, a second time user interface that includes a first expanded representation of the current time without including a representation of an activity of the first type, wherein: the first condensed representation of the current time on the first time user interface is smaller than the first expanded representation of the current time on the second user interface; and both the first condensed representation of the current time and the first expanded representation of the current time are displayed with an appearance that is based on the first style; and in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and in accordance with a determination that an activity of the first type is not in progress and the second style has been selected for the time user interface, displaying, via the one or more display generation components, a fourth time user interface that includes a second expanded representation of the current time without including a representation of an activity of the first type, wherein: the second condensed representation of the current time on the third time user interface is smaller than the second expanded representation of the current time on the fourth time user interface; both the second condensed representation of the current time and the second expanded representation of the current time are displayed with an appearance that is based on the second style; the first expanded representation of the current time has a different appearance than the second expanded representation of the current time; and the first condensed representation of the current time has a different appearance than the second condensed representation of the current time.

In accordance with some embodiments, a computer system configured to communicate with one or more display generation components and one or more input devices is described. The computer system includes one or more processors and memory storing one or more programs configured to be executed by the one or more processors. The one or more programs including instructions for: receiving, via the one or more input devices, a request to display a time user interface; in response to receiving the request to display the time user interface: in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and in accordance with a determination that an activity of the first type is not in progress and the first style has been selected for the time user interface, displaying, via the one or more display generation components, a second time user interface that includes a first expanded representation of the current time without including a representation of an activity of the first type, wherein: the first condensed representation of the current time on the first time user interface is smaller than the first expanded representation of the current time on the second user interface; and both the first condensed representation of the current time and the first expanded representation of the current time are displayed with an appearance that is based on the first style; and in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and in accordance with a determination that an activity of the first type is not in progress and the second style has been selected for the time user interface, displaying, via the one or more display generation components, a fourth time user interface that includes a second expanded representation of the current time without including a representation of an activity of the first type, wherein: the second condensed representation of the current time on the third time user interface is smaller than the second expanded representation of the current time on the fourth time user interface; both the second condensed representation of the current time and the second expanded representation of the current time are displayed with an appearance that is based on the second style; the first expanded representation of the current time has a different appearance than the second expanded representation of the current time; and the first condensed representation of the current time has a different appearance than the second condensed representation of the current time.

In accordance with some embodiments, a computer system configured to communicate with one or more display generation components and one or more input devices is described. The computer system includes: means for receiving, via the one or more input devices, a request to display a time user interface; means for, in response to receiving the request to display the time user interface: in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and in accordance with a determination that an activity of the first type is not in progress and the first style has been selected for the time user interface, displaying, via the one or more display generation components, a second time user interface that includes a first expanded representation of the current time without including a representation of an activity of the first type, wherein: the first condensed representation of the current time on the first time user interface is smaller than the first expanded representation of the current time on the second user interface; and both the first condensed representation of the current time and the first expanded representation of the current time are displayed with an appearance that is based on the first style; and in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and in accordance with a determination that an activity of the first type is not in progress and the second style has been selected for the time user interface, displaying, via the one or more display generation components, a fourth time user interface that includes a second expanded representation of the current time without including a representation of an activity of the first type, wherein: the second condensed representation of the current time on the third time user interface is smaller than the second expanded representation of the current time on the fourth time user interface; both the second condensed representation of the current time and the second expanded representation of the current time are displayed with an appearance that is based on the second style; the first expanded representation of the current time has a different appearance than the second expanded representation of the current time; and the first condensed representation of the current time has a different appearance than the second condensed representation of the current time.

In accordance with some embodiments, a computer program product, comprising one or more programs configured to be executed by one or more processors of a computer system that is in communication with one or more display generation component and one or more input devices is described. The one or more programs including instructions for: receiving, via the one or more input devices, a request to display a time user interface; in response to receiving the request to display the time user interface: in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and in accordance with a determination that an activity of the first type is not in progress and the first style has been selected for the time user interface, displaying, via the one or more display generation components, a second time user interface that includes a first expanded representation of the current time without including a representation of an activity of the first type, wherein: the first condensed representation of the current time on the first time user interface is smaller than the first expanded representation of the current time on the second user interface; and both the first condensed representation of the current time and the first expanded representation of the current time are displayed with an appearance that is based on the first style; and in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and in accordance with a determination that an activity of the first type is not in progress and the second style has been selected for the time user interface, displaying, via the one or more display generation components, a fourth time user interface that includes a second expanded representation of the current time without including a representation of an activity of the first type, wherein: the second condensed representation of the current time on the third time user interface is smaller than the second expanded representation of the current time on the fourth time user interface; both the second condensed representation of the current time and the second expanded representation of the current time are displayed with an appearance that is based on the second style; the first expanded representation of the current time has a different appearance than the second expanded representation of the current time; and the first condensed representation of the current time has a different appearance than the second condensed representation of the current time.

In accordance with some embodiments, a method that is performed at a computer system that is in communication with one or more display generation components is described. The method includes: receiving a request to wake the computer system; in response to receiving the request to wake the computer system, concurrently displaying, via the one or more display generation components, a first user interface for first software and a second user interface for second software, wherein: the first software is different from the second software; and the first user interface represents an ongoing activity; and while concurrently displaying the first user interface for first software and the second user interface for second software, updating a state of the first user interface based on a change in the ongoing activity, wherein one or more remote devices that are different from the computer system are concurrently displaying a corresponding user interface that represents the ongoing activity, including: at a first remote device, concurrently displaying a first remote-device user interface for first remote-device software for the first remote device and second remote-device user interface for second remote-device software for the first remote device, wherein: the first remote-device software is different from the second remote-device software; and the state of the first remote-device user interface is also updated based on the change in the ongoing activity.

In accordance with some embodiments, a non-transitory computer-readable storage medium storing one or more programs configured to be executed by one or more processors of a computer system that is in communication with one or more display generation is described. The one or more programs including instructions for: receiving a request to wake the computer system; in response to receiving the request to wake the computer system, concurrently displaying, via the one or more display generation components, a first user interface for first software and a second user interface for second software, wherein: the first software is different from the second software; and the first user interface represents an ongoing activity; and while concurrently displaying the first user interface for first software and the second user interface for second software, updating a state of the first user interface based on a change in the ongoing activity, wherein one or more remote devices that are different from the computer system are concurrently displaying a corresponding user interface that represents the ongoing activity, including: at a first remote device, concurrently displaying a first remote-device user interface for first remote-device software for the first remote device and second remote-device user interface for second remote-device software for the first remote device, wherein: the first remote-device software is different from the second remote-device software; and the state of the first remote-device user interface is also updated based on the change in the ongoing activity.

In accordance with some embodiments, a transitory computer-readable storage medium storing one or more programs configured to be executed by one or more processors of a computer system that is in communication with one or more display generation is described. The one or more programs including instructions for: receiving a request to wake the computer system; in response to receiving the request to wake the computer system, concurrently displaying, via the one or more display generation components, a first user interface for first software and a second user interface for second software, wherein: the first software is different from the second software; and the first user interface represents an ongoing activity; and while concurrently displaying the first user interface for first software and the second user interface for second software, updating a state of the first user interface based on a change in the ongoing activity, wherein one or more remote devices that are different from the computer system are concurrently displaying a corresponding user interface that represents the ongoing activity, including: at a first remote device, concurrently displaying a first remote-device user interface for first remote-device software for the first remote device and second remote-device user interface for second remote-device software for the first remote device, wherein: the first remote-device software is different from the second remote-device software; and the state of the first remote-device user interface is also updated based on the change in the ongoing activity.

In accordance with some embodiments, a computer system configured to communicate with one or more display generation components is described. The computer system includes one or more processors and memory storing one or more programs configured to be executed by the one or more processors. The one or more programs including instructions for: receiving a request to wake the computer system; in response to receiving the request to wake the computer system, concurrently displaying, via the one or more display generation components, a first user interface for first software and a second user interface for second software, wherein: the first software is different from the second software; and the first user interface represents an ongoing activity; and while concurrently displaying the first user interface for first software and the second user interface for second software, updating a state of the first user interface based on a change in the ongoing activity, wherein one or more remote devices that are different from the computer system are concurrently displaying a corresponding user interface that represents the ongoing activity, including: at a first remote device, concurrently displaying a first remote-device user interface for first remote-device software for the first remote device and second remote-device user interface for second remote-device software for the first remote device, wherein: the first remote-device software is different from the second remote-device software; and the state of the first remote-device user interface is also updated based on the change in the ongoing activity.

In accordance with some embodiments, a computer system configured to communicate with one or more display generation components is described. The computer system includes: means for receiving a request to wake the computer system; means for, in response to receiving the request to wake the computer system, concurrently displaying, via the one or more display generation components, a first user interface for first software and a second user interface for second software, wherein: the first software is different from the second software; and the first user interface represents an ongoing activity; and means for, while concurrently displaying the first user interface for first software and the second user interface for second software, updating a state of the first user interface based on a change in the ongoing activity, wherein one or more remote devices that are different from the computer system are concurrently displaying a corresponding user interface that represents the ongoing activity, including: at a first remote device, concurrently displaying a first remote-device user interface for first remote-device software for the first remote device and second remote-device user interface for second remote-device software for the first remote device, wherein: the first remote-device software is different from the second remote-device software; and the state of the first remote-device user interface is also updated based on the change in the ongoing activity.

In accordance with some embodiments, a computer program product, comprising one or more programs configured to be executed by one or more processors of a computer system that is in communication with one or more display generation component is described. The one or more programs including instructions for: receiving a request to wake the computer system; in response to receiving the request to wake the computer system, concurrently displaying, via the one or more display generation components, a first user interface for first software and a second user interface for second software, wherein: the first software is different from the second software; and the first user interface represents an ongoing activity; and while concurrently displaying the first user interface for first software and the second user interface for second software, updating a state of the first user interface based on a change in the ongoing activity, wherein one or more remote devices that are different from the computer system are concurrently displaying a corresponding user interface that represents the ongoing activity, including: at a first remote device, concurrently displaying a first remote-device user interface for first remote-device software for the first remote device and second remote-device user interface for second remote-device software for the first remote device, wherein: the first remote-device software is different from the second remote-device software; and the state of the first remote-device user interface is also updated based on the change in the ongoing activity.

In accordance with some embodiments, a method performed at a computer system that is in communication with one or more display generation components and one or more input devices is described. The method includes: receiving a request to display a time user interface concurrently with a set of widgets; and in response to the request to display the time user interface concurrently with the set of widgets: in accordance with a determination that the computer system is operating in a first context while a first style of time user interface has been selected for the computer system, concurrently displaying: a representation of time with a first appearance based on the first style; and a set of widgets that includes a first set of widgets; in accordance with a determination that the computer system is operating in the first context while a second style of time user interface has been selected for the computer system, concurrently displaying: a representation of time with a second appearance based on the second style; and the set of widgets that includes the first set of widgets; in accordance with a determination that the computer system is operating in a second context while the first style of time user interface has been selected for the computer system, concurrently displaying: a representation of time with the first appearance based on the first style; and a set of widgets that includes a second set of widgets that is different from the first set of widgets; and in accordance with a determination that the computer system is operating in the second context while the second style of time user interface has been selected for the computer system, concurrently displaying: a representation of time with the second appearance based on the second style; and the set of widgets that includes the second set of widgets.

In accordance with some embodiments, a non-transitory computer-readable storage medium storing one or more programs configured to be executed by one or more processors of a computer system that is in communication with one or more display generation components and one or more input devices is described. The one or more programs including instructions for: receiving a request to display a time user interface concurrently with a set of widgets; and in response to the request to display the time user interface concurrently with the set of widgets: in accordance with a determination that the computer system is operating in a first context while a first style of time user interface has been selected for the computer system, concurrently displaying: a representation of time with a first appearance based on the first style; and a set of widgets that includes a first set of widgets; in accordance with a determination that the computer system is operating in the first context while a second style of time user interface has been selected for the computer system, concurrently displaying: a representation of time with a second appearance based on the second style; and the set of widgets that includes the first set of widgets; in accordance with a determination that the computer system is operating in a second context while the first style of time user interface has been selected for the computer system, concurrently displaying: a representation of time with the first appearance based on the first style; and a set of widgets that includes a second set of widgets that is different from the first set of widgets; and in accordance with a determination that the computer system is operating in the second context while the second style of time user interface has been selected for the computer system, concurrently displaying: a representation of time with the second appearance based on the second style; and the set of widgets that includes the second set of widgets.

In accordance with some embodiments, a transitory computer-readable storage medium storing one or more programs configured to be executed by one or more processors of a computer system that is in communication with one or more display generation components and one or more input devices is described. The one or more programs including instructions for: receiving a request to display a time user interface concurrently with a set of widgets; and in response to the request to display the time user interface concurrently with the set of widgets: in accordance with a determination that the computer system is operating in a first context while a first style of time user interface has been selected for the computer system, concurrently displaying: a representation of time with a first appearance based on the first style; and a set of widgets that includes a first set of widgets; in accordance with a determination that the computer system is operating in the first context while a second style of time user interface has been selected for the computer system, concurrently displaying: a representation of time with a second appearance based on the second style; and the set of widgets that includes the first set of widgets; in accordance with a determination that the computer system is operating in a second context while the first style of time user interface has been selected for the computer system, concurrently displaying: a representation of time with the first appearance based on the first style; and a set of widgets that includes a second set of widgets that is different from the first set of widgets; and in accordance with a determination that the computer system is operating in the second context while the second style of time user interface has been selected for the computer system, concurrently displaying: a representation of time with the second appearance based on the second style; and the set of widgets that includes the second set of widgets.

In accordance with some embodiments, a computer system configured to communicate with one or more display generation components and one or more input devices is described. The computer system includes one or more processors and memory storing one or more programs configured to be executed by the one or more processors. The one or more programs including instructions for: receiving a request to display a time user interface concurrently with a set of widgets; and in response to the request to display the time user interface concurrently with the set of widgets: in accordance with a determination that the computer system is operating in a first context while a first style of time user interface has been selected for the computer system, concurrently displaying: a representation of time with a first appearance based on the first style; and a set of widgets that includes a first set of widgets; in accordance with a determination that the computer system is operating in the first context while a second style of time user interface has been selected for the computer system, concurrently displaying: a representation of time with a second appearance based on the second style; and the set of widgets that includes the first set of widgets; in accordance with a determination that the computer system is operating in a second context while the first style of time user interface has been selected for the computer system, concurrently displaying: a representation of time with the first appearance based on the first style; and a set of widgets that includes a second set of widgets that is different from the first set of widgets; and in accordance with a determination that the computer system is operating in the second context while the second style of time user interface has been selected for the computer system, concurrently displaying: a representation of time with the second appearance based on the second style; and the set of widgets that includes the second set of widgets.

In accordance with some embodiments, a computer system configured to communicate with one or more display generation components and one or more input devices is described. The computer system includes: means for receiving a request to display a time user interface concurrently with a set of widgets; and means for, in response to the request to display the time user interface concurrently with the set of widgets: in accordance with a determination that the computer system is operating in a first context while a first style of time user interface has been selected for the computer system, concurrently displaying: a representation of time with a first appearance based on the first style; and a set of widgets that includes a first set of widgets; in accordance with a determination that the computer system is operating in the first context while a second style of time user interface has been selected for the computer system, concurrently displaying: a representation of time with a second appearance based on the second style; and the set of widgets that includes the first set of widgets; in accordance with a determination that the computer system is operating in a second context while the first style of time user interface has been selected for the computer system, concurrently displaying: a representation of time with the first appearance based on the first style; and a set of widgets that includes a second set of widgets that is different from the first set of widgets; and in accordance with a determination that the computer system is operating in the second context while the second style of time user interface has been selected for the computer system, concurrently displaying: a representation of time with the second appearance based on the second style; and the set of widgets that includes the second set of widgets.

In accordance with some embodiments, a computer program product, comprising one or more programs configured to be executed by one or more processors of a computer system that is in communication with one or more display generation component and one or more input devices is described. The one or more programs including instructions for: receiving a request to display a time user interface concurrently with a set of widgets; and in response to the request to display the time user interface concurrently with the set of widgets: in accordance with a determination that the computer system is operating in a first context while a first style of time user interface has been selected for the computer system, concurrently displaying: a representation of time with a first appearance based on the first style; and a set of widgets that includes a first set of widgets; in accordance with a determination that the computer system is operating in the first context while a second style of time user interface has been selected for the computer system, concurrently displaying: a representation of time with a second appearance based on the second style; and the set of widgets that includes the first set of widgets; in accordance with a determination that the computer system is operating in a second context while the first style of time user interface has been selected for the computer system, concurrently displaying: a representation of time with the first appearance based on the first style; and a set of widgets that includes a second set of widgets that is different from the first set of widgets; and in accordance with a determination that the computer system is operating in the second context while the second style of time user interface has been selected for the computer system, concurrently displaying: a representation of time with the second appearance based on the second style; and the set of widgets that includes the second set of widgets.

In accordance with some embodiments, a method performed at a computer system that is in communication with one or more display generation components and one or more input devices is described. The method includes: displaying, via the one or more display generation components, a time user interface that includes an expanded representation of time; detecting the occurrence of a condition; in response to detecting the occurrence of the condition, displaying a time user interface that includes a condensed representation of time that is smaller than the expanded representation of time, including: in accordance with a determination that a foreground element of the expanded representation of time had a first foreground color, a corresponding foreground element of the condensed representation of time with an appearance that includes the first foreground color; in accordance with a determination that the foreground element of the expanded representation of time had a second foreground color different from the first foreground color, the corresponding foreground element of the condensed representation of time with an appearance that includes the second foreground color; in accordance with a determination that a background element of the expanded representation of time had a first background color, a corresponding background element of the condensed representation of time with an appearance that includes the first background color; and in accordance with a determination that the background element of the expanded representation of time had a second background color different from the first background color, the corresponding background element of the condensed representation of time with an appearance that includes the second background color.

In accordance with some embodiments, a non-transitory computer-readable storage medium storing one or more programs configured to be executed by one or more processors of a computer system that is in communication with one or more display generation components and one or more input devices is described. The one or more programs including instructions for: displaying, via the one or more display generation components, a time user interface that includes an expanded representation of time; detecting the occurrence of a condition; in response to detecting the occurrence of the condition, displaying a time user interface that includes a condensed representation of time that is smaller than the expanded representation of time, including: in accordance with a determination that a foreground element of the expanded representation of time had a first foreground color, a corresponding foreground element of the condensed representation of time with an appearance that includes the first foreground color; in accordance with a determination that the foreground element of the expanded representation of time had a second foreground color different from the first foreground color, the corresponding foreground element of the condensed representation of time with an appearance that includes the second foreground color; in accordance with a determination that a background element of the expanded representation of time had a first background color, a corresponding background element of the condensed representation of time with an appearance that includes the first background color; and in accordance with a determination that the background element of the expanded representation of time had a second background color different from the first background color, the corresponding background element of the condensed representation of time with an appearance that includes the second background color.

In accordance with some embodiments, a transitory computer-readable storage medium storing one or more programs configured to be executed by one or more processors of a computer system that is in communication with one or more display generation components and one or more input devices is described. The one or more programs including instructions for: displaying, via the one or more display generation components, a time user interface that includes an expanded representation of time; detecting the occurrence of a condition; in response to detecting the occurrence of the condition, displaying a time user interface that includes a condensed representation of time that is smaller than the expanded representation of time, including: in accordance with a determination that a foreground element of the expanded representation of time had a first foreground color, a corresponding foreground element of the condensed representation of time with an appearance that includes the first foreground color; in accordance with a determination that the foreground element of the expanded representation of time had a second foreground color different from the first foreground color, the corresponding foreground element of the condensed representation of time with an appearance that includes the second foreground color; in accordance with a determination that a background element of the expanded representation of time had a first background color, a corresponding background element of the condensed representation of time with an appearance that includes the first background color; and in accordance with a determination that the background element of the expanded representation of time had a second background color different from the first background color, the corresponding background element of the condensed representation of time with an appearance that includes the second background color.

In accordance with some embodiments, a computer system configured to communicate with one or more display generation components and one or more input devices is described. The computer system includes one or more processors and memory storing one or more programs configured to be executed by the one or more processors. The one or more programs including instructions for: displaying, via the one or more display generation components, a time user interface that includes an expanded representation of time; detecting the occurrence of a condition; in response to detecting the occurrence of the condition, displaying a time user interface that includes a condensed representation of time that is smaller than the expanded representation of time, including: in accordance with a determination that a foreground element of the expanded representation of time had a first foreground color, a corresponding foreground element of the condensed representation of time with an appearance that includes the first foreground color; in accordance with a determination that the foreground element of the expanded representation of time had a second foreground color different from the first foreground color, the corresponding foreground element of the condensed representation of time with an appearance that includes the second foreground color; in accordance with a determination that a background element of the expanded representation of time had a first background color, a corresponding background element of the condensed representation of time with an appearance that includes the first background color; and in accordance with a determination that the background element of the expanded representation of time had a second background color different from the first background color, the corresponding background element of the condensed representation of time with an appearance that includes the second background color.

In accordance with some embodiments, a computer system configured to communicate with one or more display generation components and one or more input devices is described. The computer system includes: means for displaying, via the one or more display generation components, a time user interface that includes an expanded representation of time; means for detecting the occurrence of a condition; means for, in response to detecting the occurrence of the condition, displaying a time user interface that includes a condensed representation of time that is smaller than the expanded representation of time, including: in accordance with a determination that a foreground element of the expanded representation of time had a first foreground color, a corresponding foreground element of the condensed representation of time with an appearance that includes the first foreground color; in accordance with a determination that the foreground element of the expanded representation of time had a second foreground color different from the first foreground color, the corresponding foreground element of the condensed representation of time with an appearance that includes the second foreground color; in accordance with a determination that a background element of the expanded representation of time had a first background color, a corresponding background element of the condensed representation of time with an appearance that includes the first background color; and in accordance with a determination that the background element of the expanded representation of time had a second background color different from the first background color, the corresponding background element of the condensed representation of time with an appearance that includes the second background color.

In accordance with some embodiments, a computer program product, comprising one or more programs configured to be executed by one or more processors of a computer system that is in communication with one or more display generation component and one or more input devices is described. The one or more programs including instructions for: displaying, via the one or more display generation components, a time user interface that includes an expanded representation of time; detecting the occurrence of a condition; in response to detecting the occurrence of the condition, displaying a time user interface that includes a condensed representation of time that is smaller than the expanded representation of time, including: in accordance with a determination that a foreground element of the expanded representation of time had a first foreground color, a corresponding foreground element of the condensed representation of time with an appearance that includes the first foreground color; in accordance with a determination that the foreground element of the expanded representation of time had a second foreground color different from the first foreground color, the corresponding foreground element of the condensed representation of time with an appearance that includes the second foreground color; in accordance with a determination that a background element of the expanded representation of time had a first background color, a corresponding background element of the condensed representation of time with an appearance that includes the first background color; and in accordance with a determination that the background element of the expanded representation of time had a second background color different from the first background color, the corresponding background element of the condensed representation of time with an appearance that includes the second background color.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for monitoring ongoing activities and time, thereby increasing the effectiveness, efficiency, and user satisfaction with such devices. Such methods and interfaces may complement or replace other methods for monitoring ongoing activities and time.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AQ illustrate techniques for displaying a representation of time based on ongoing activities, in accordance with some embodiments.

FIG. 7 is a flow diagram illustrating a method for displaying a representation of time based on ongoing activities, in accordance with some embodiments.

FIGS. 8A-8S illustrate techniques for synchronizing a state of an ongoing activity across multiple computer systems, in accordance with some embodiments.

FIG. 9 is a flow diagram illustrating a method for synchronizing a state of an ongoing activity across multiple computer systems, in accordance with some embodiments.

FIGS. 10A-10V illustrate techniques for managing widgets for inclusion in a set of widgets, in accordance with some embodiments.

FIG. 11 is a flow diagram illustrating a method for managing widgets for inclusion in a set of widgets, in accordance with some embodiments.

FIGS. 12A-12M illustrate techniques for displaying corresponding representations of time, in accordance with some embodiments.

FIG. 13 is a flow diagram illustrating a method for displaying corresponding representations of time, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for monitoring ongoing activities and time. Such techniques can reduce the cognitive burden on a user who monitor ongoing activities and time, thereby enhancing productivity. Further, such techniques can reduce processor and battery power otherwise wasted on redundant user inputs.

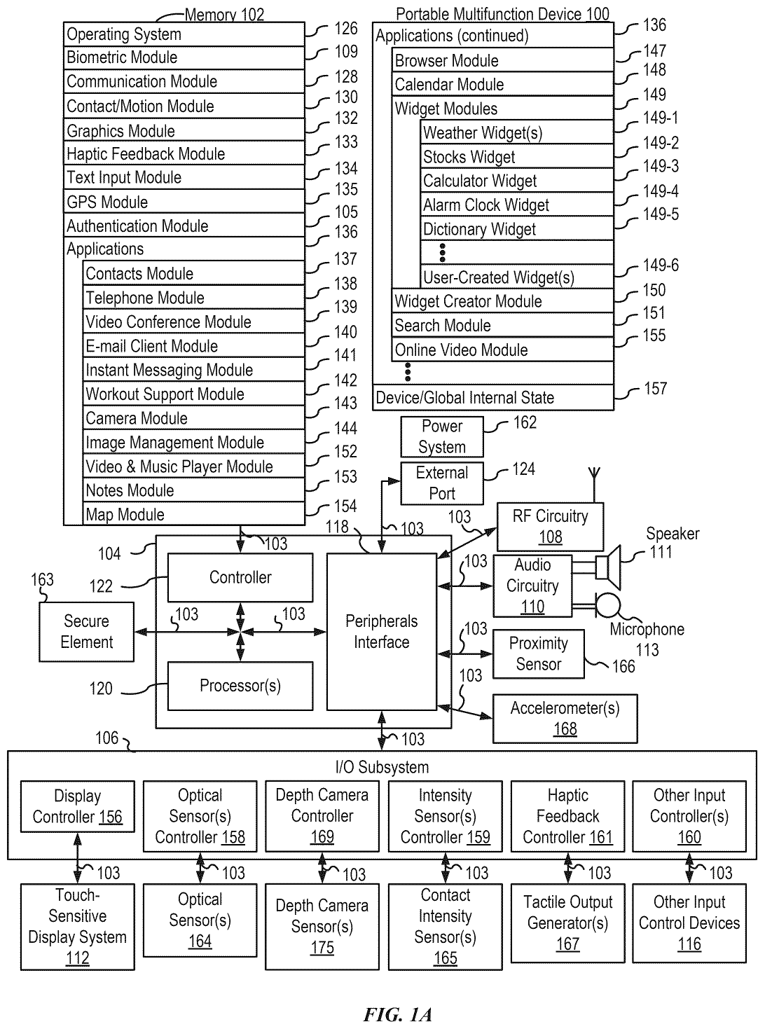

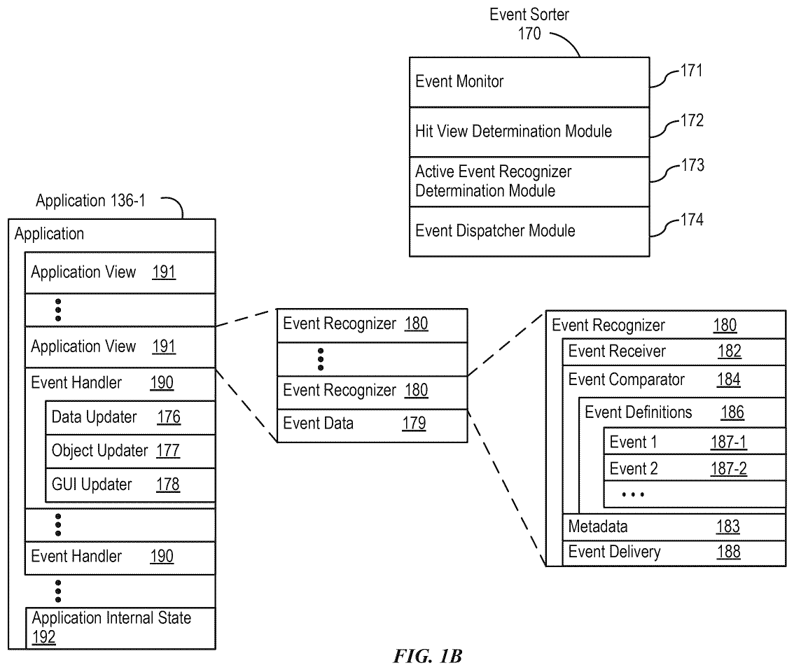

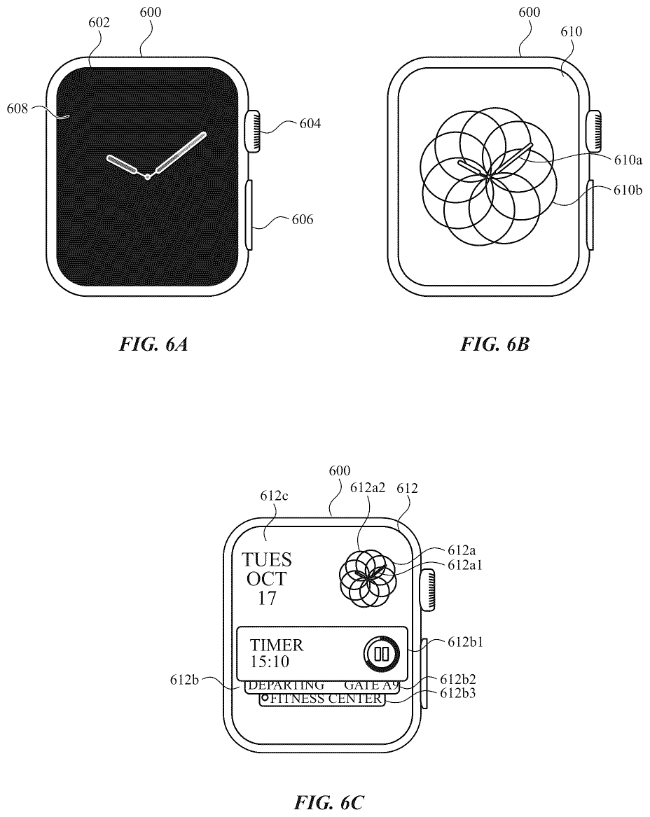

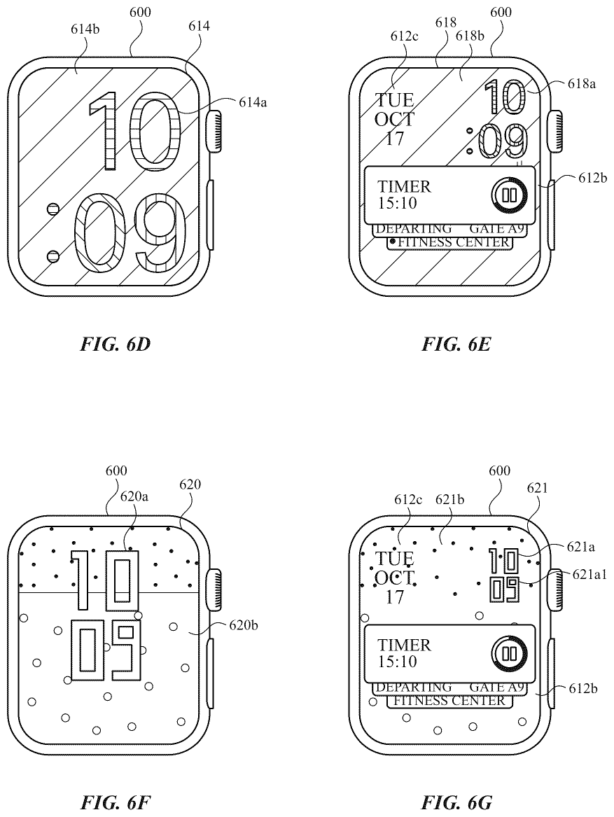

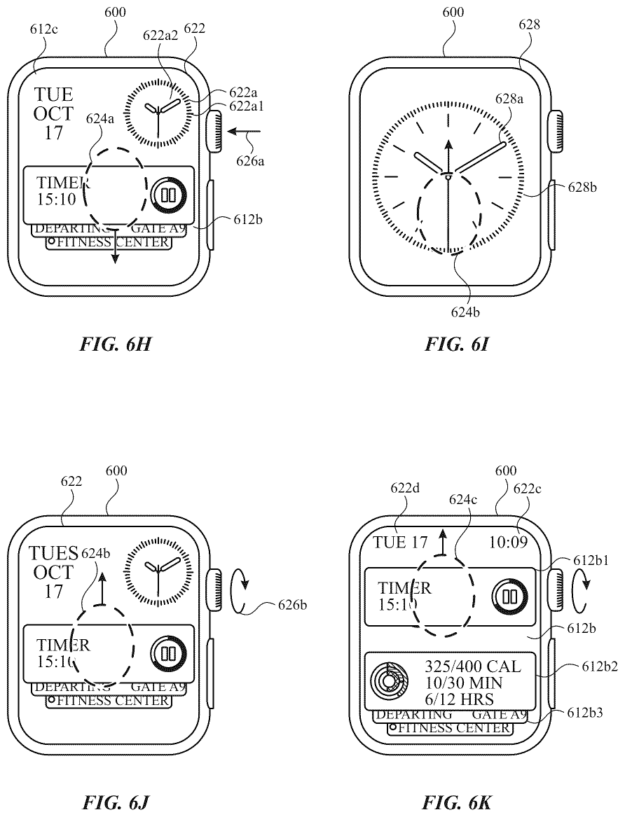

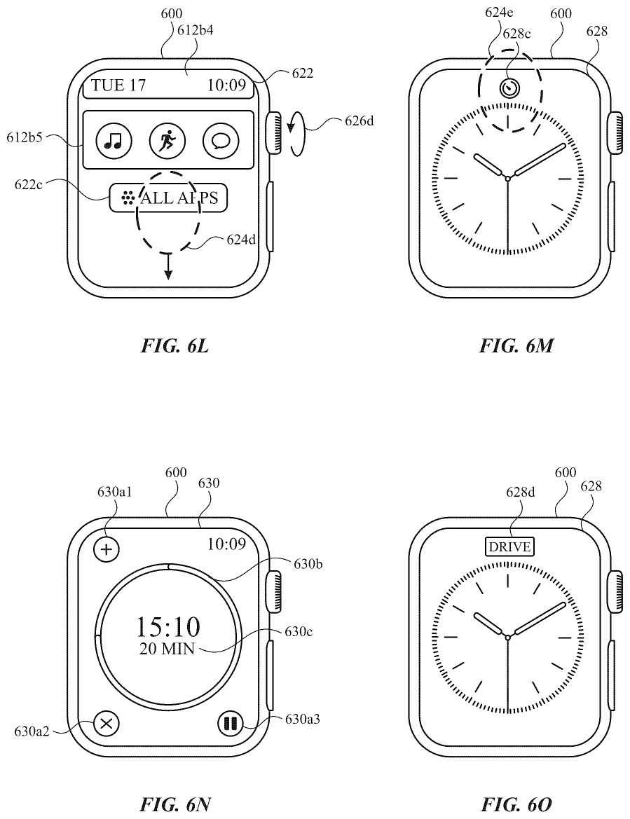

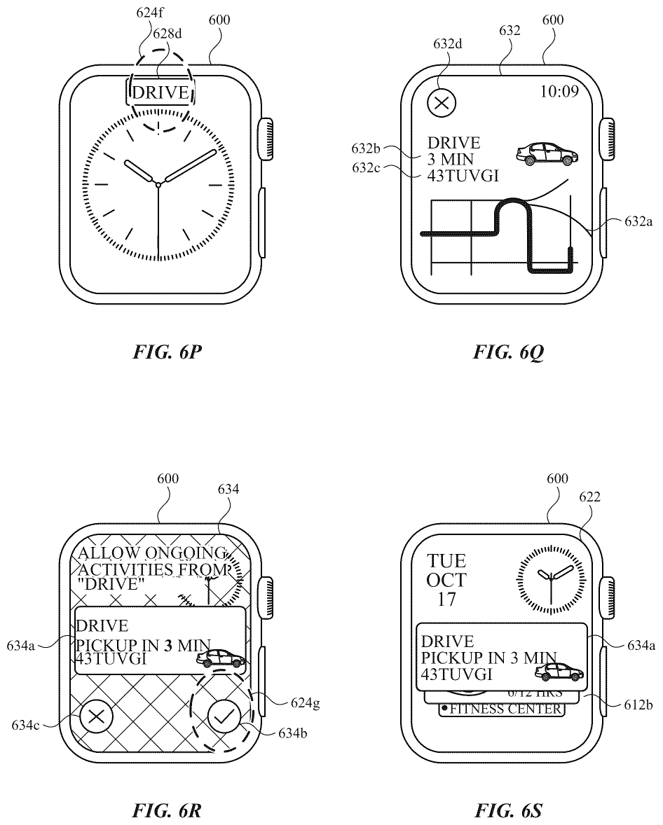

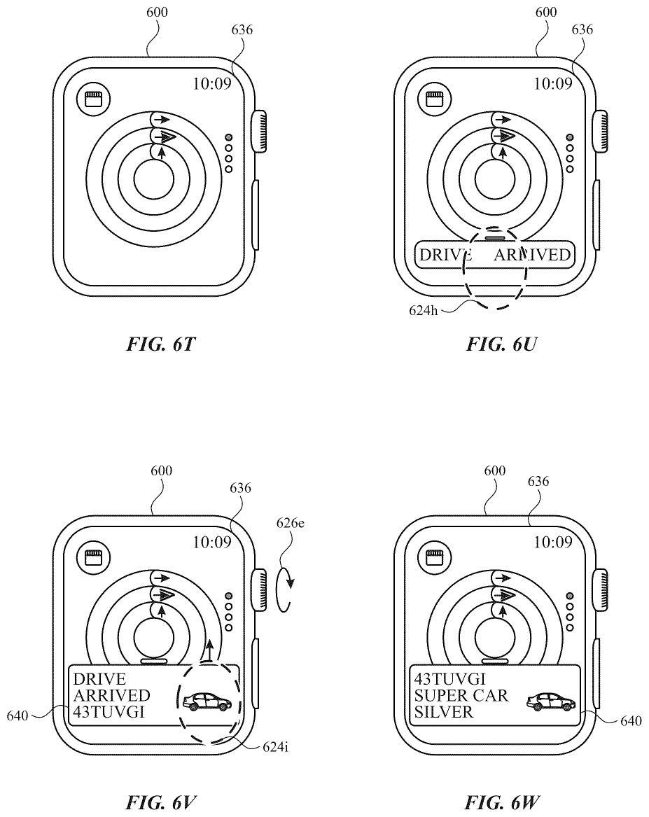

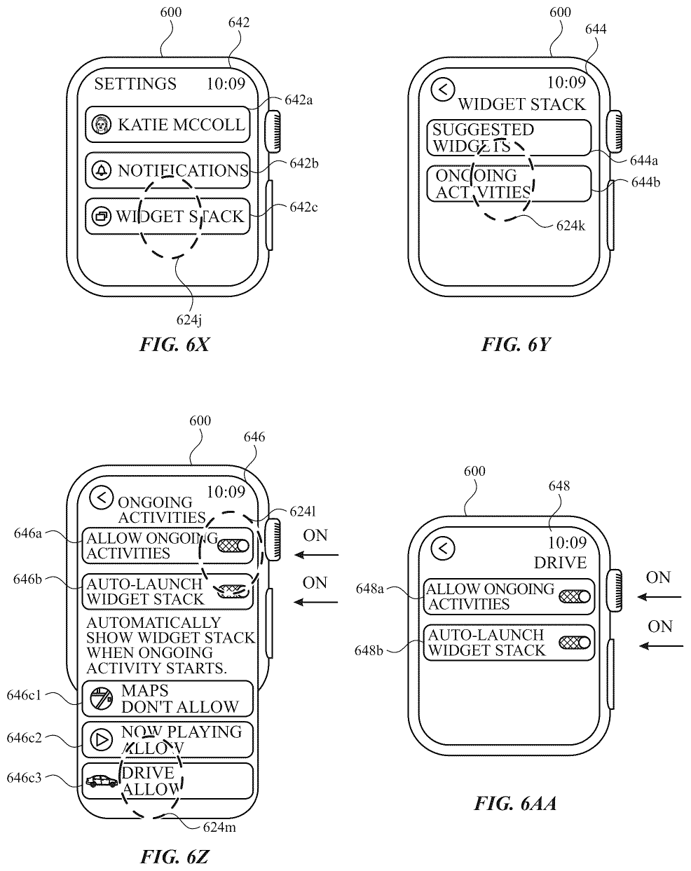

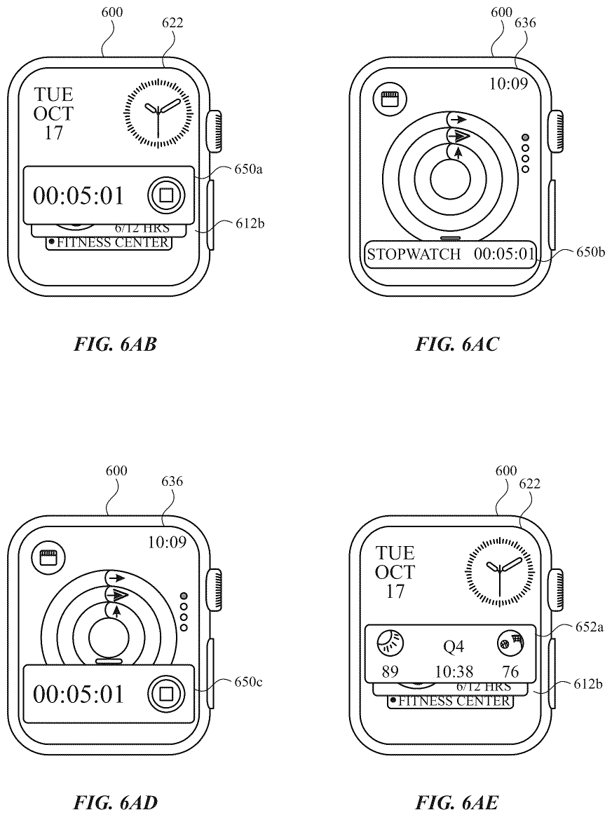

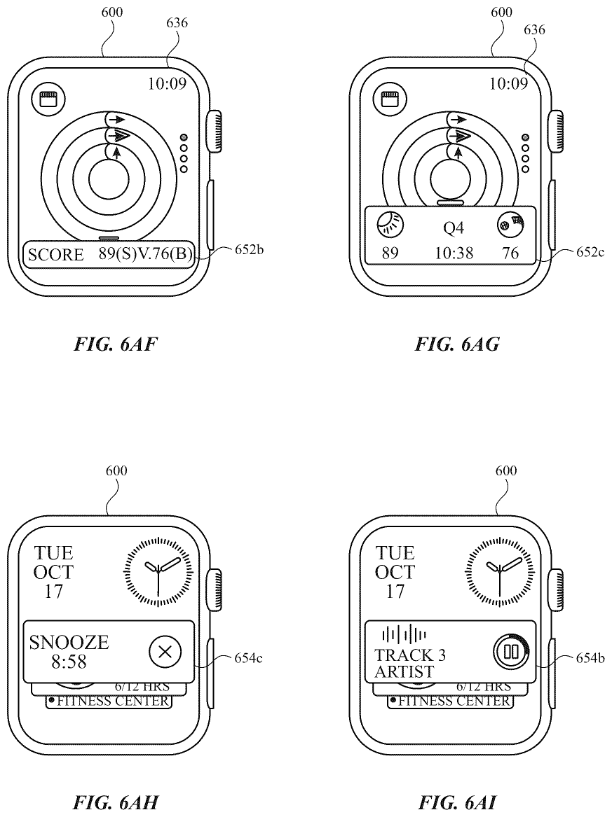

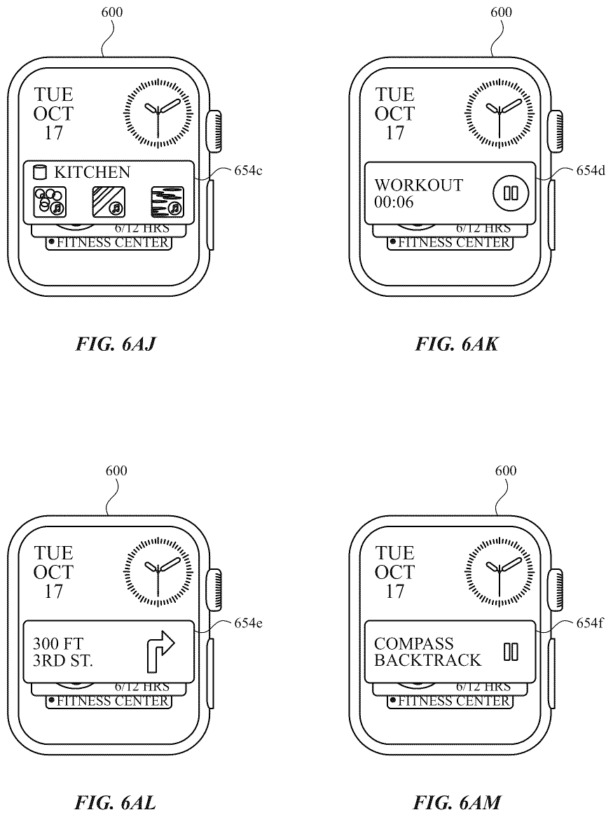

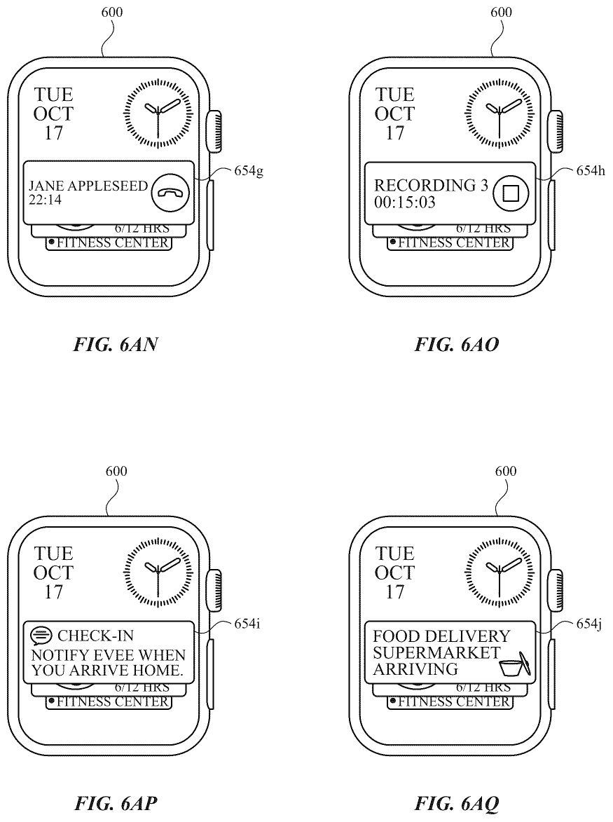

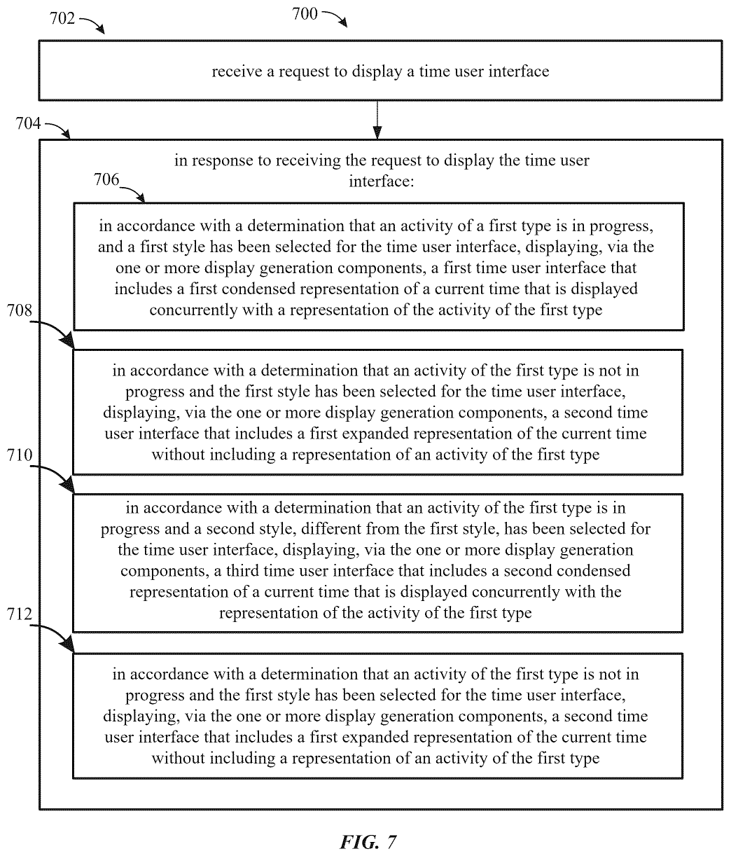

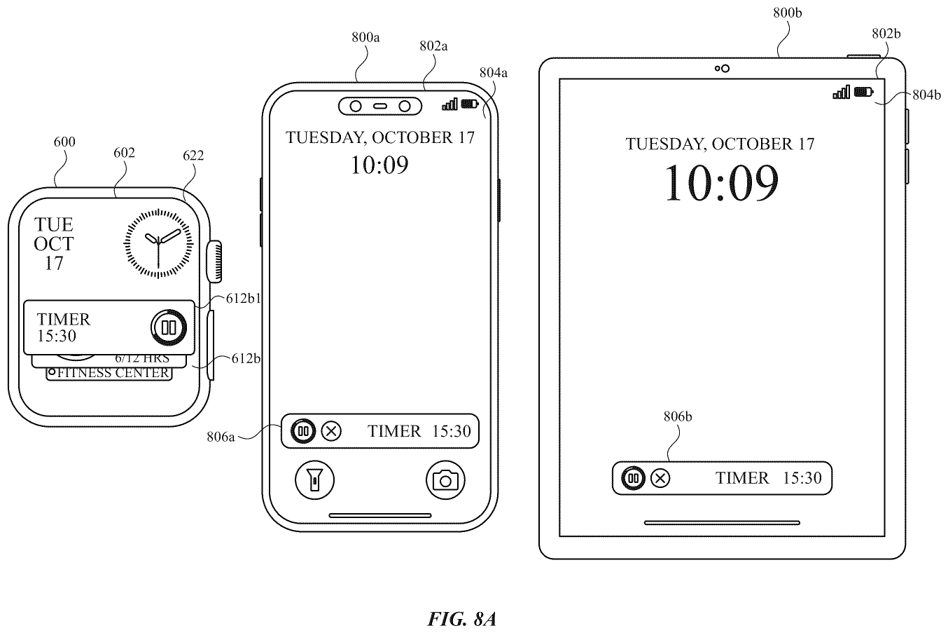

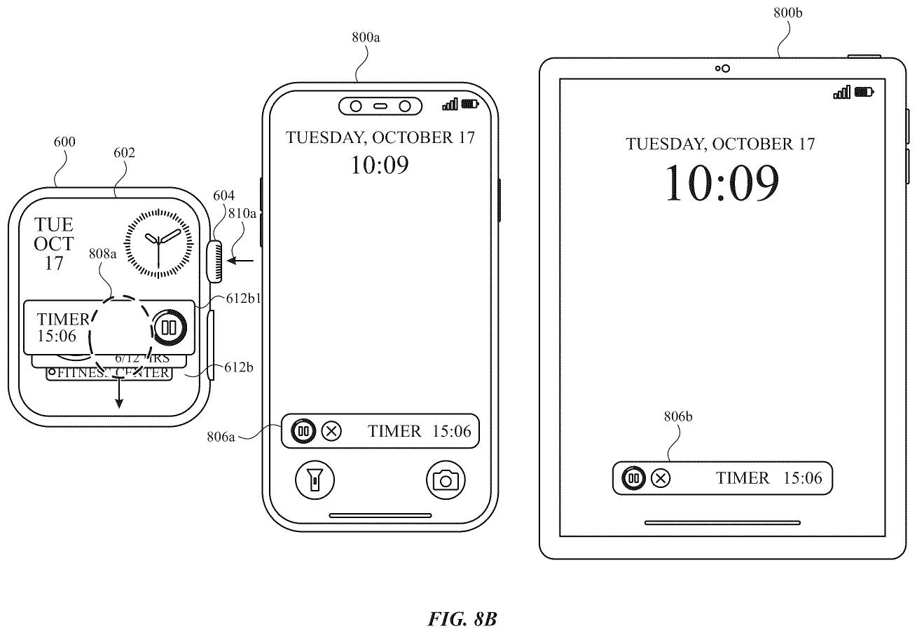

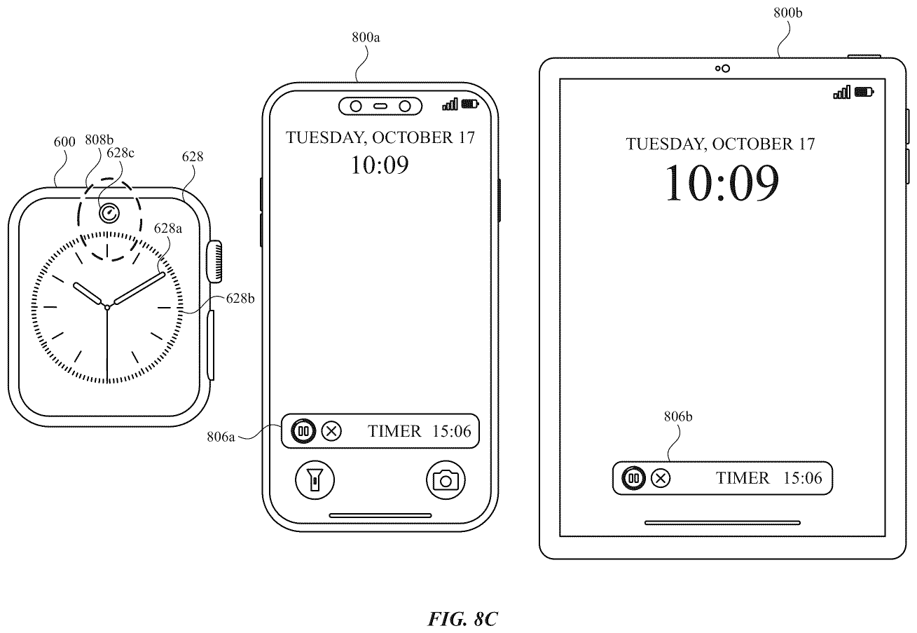

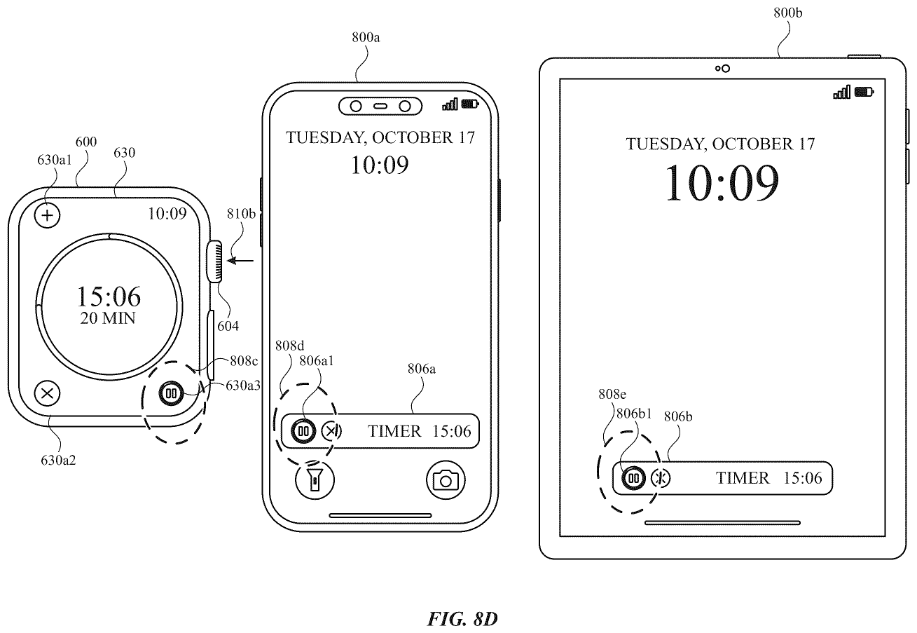

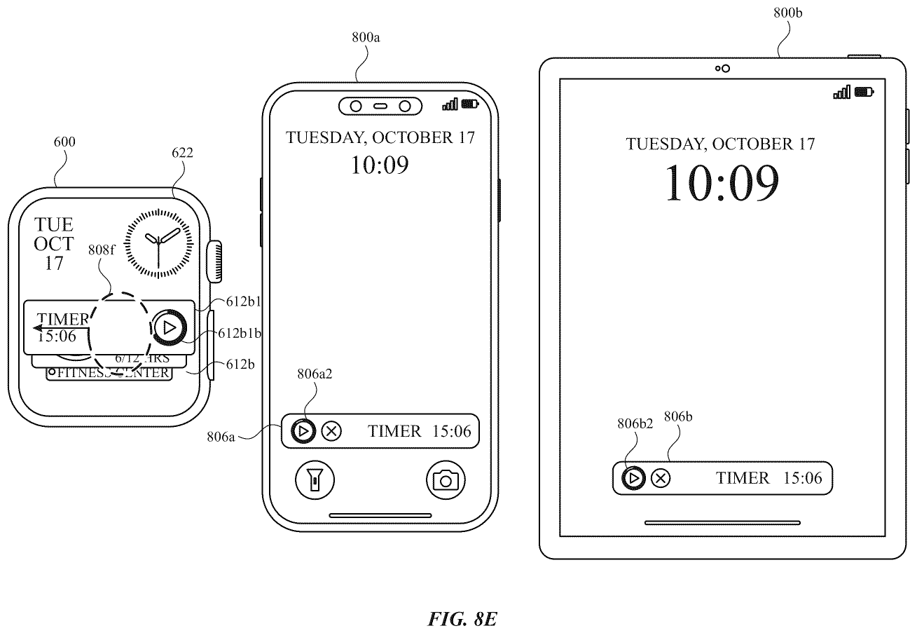

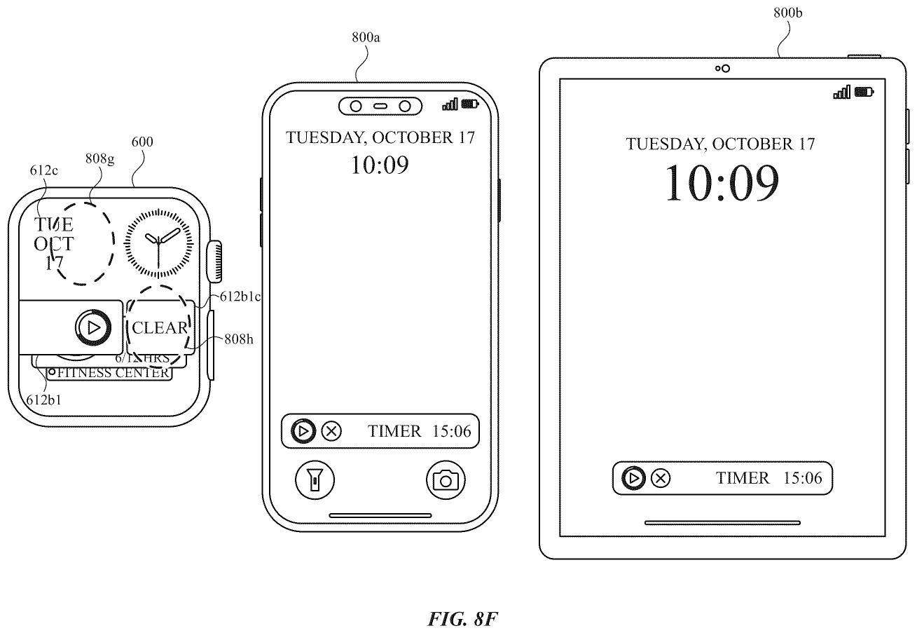

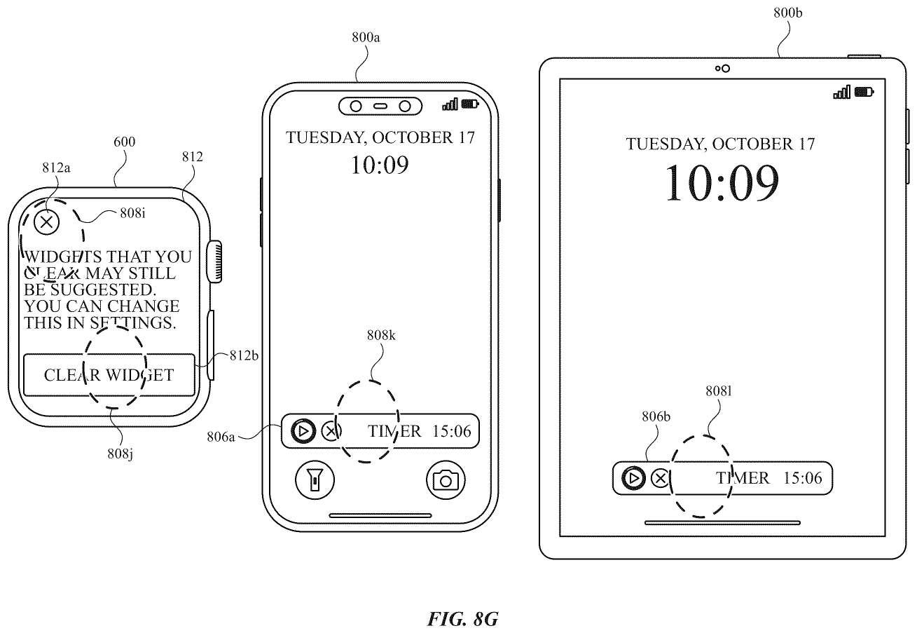

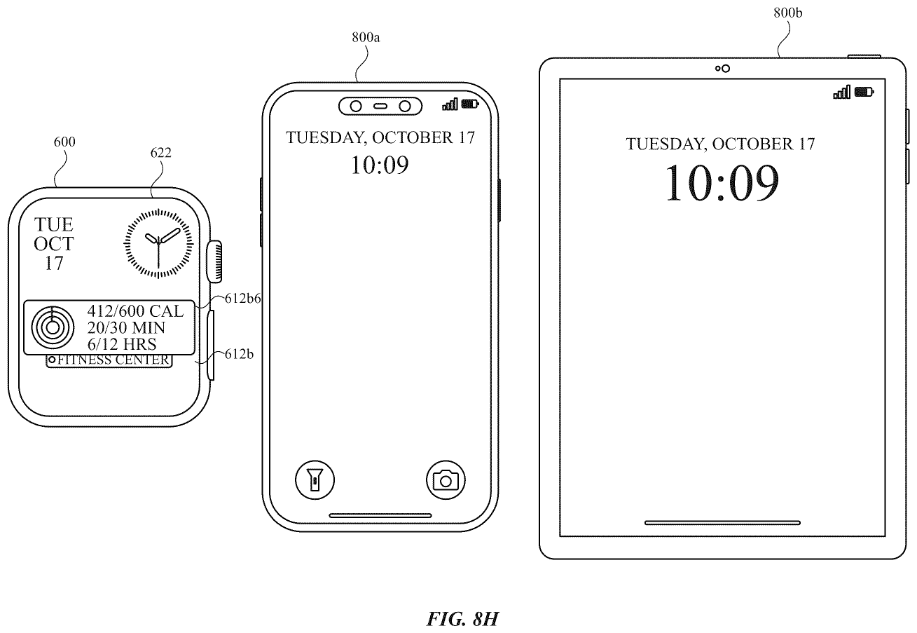

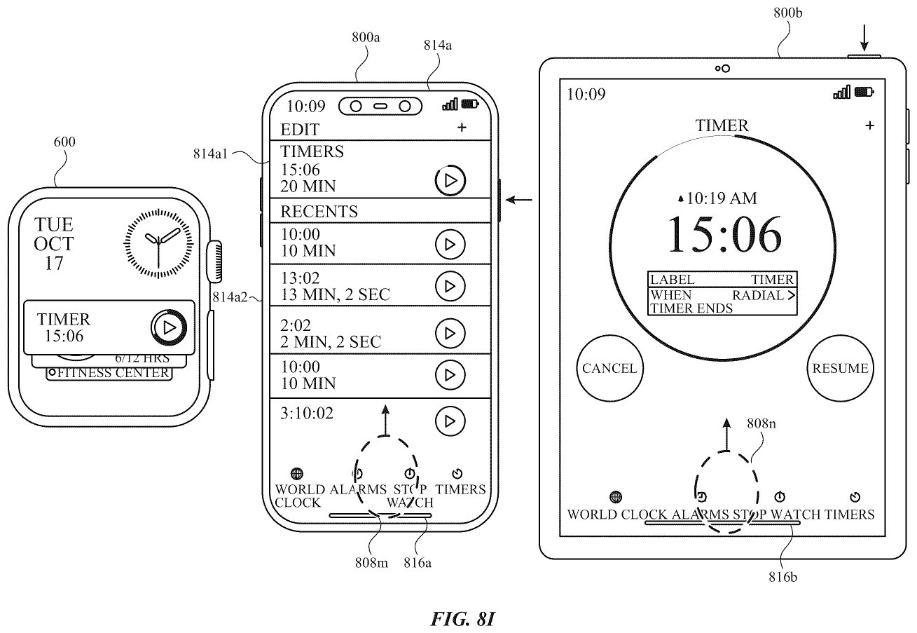

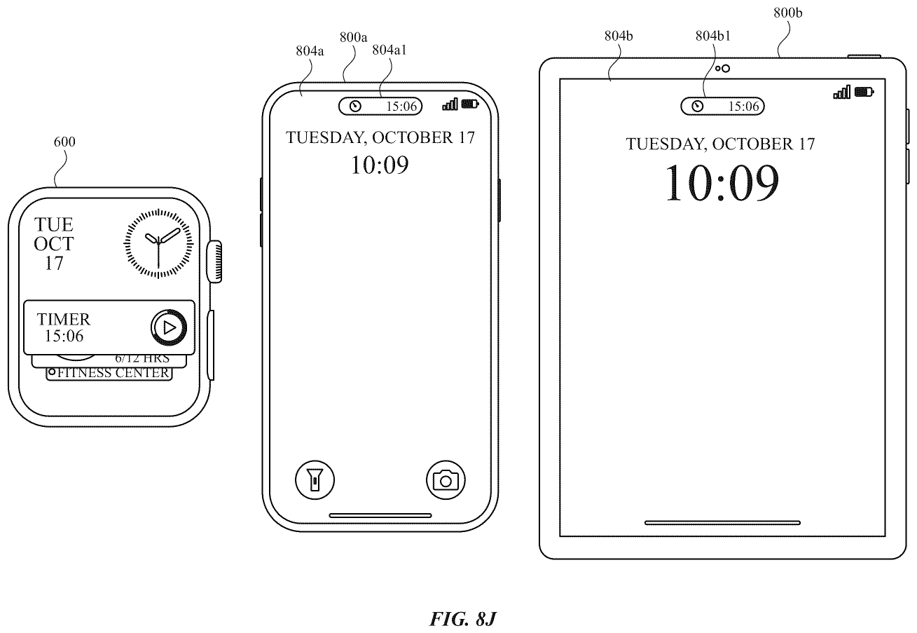

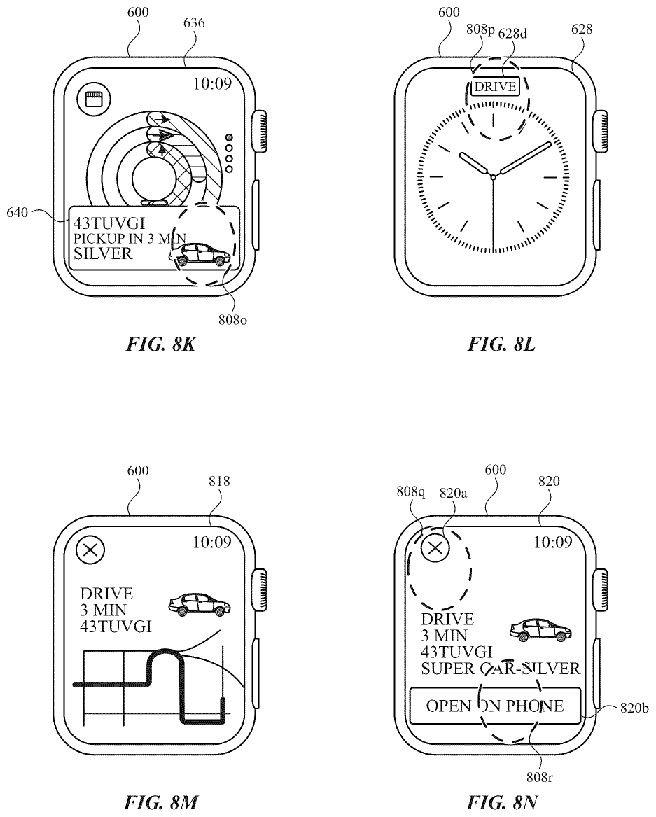

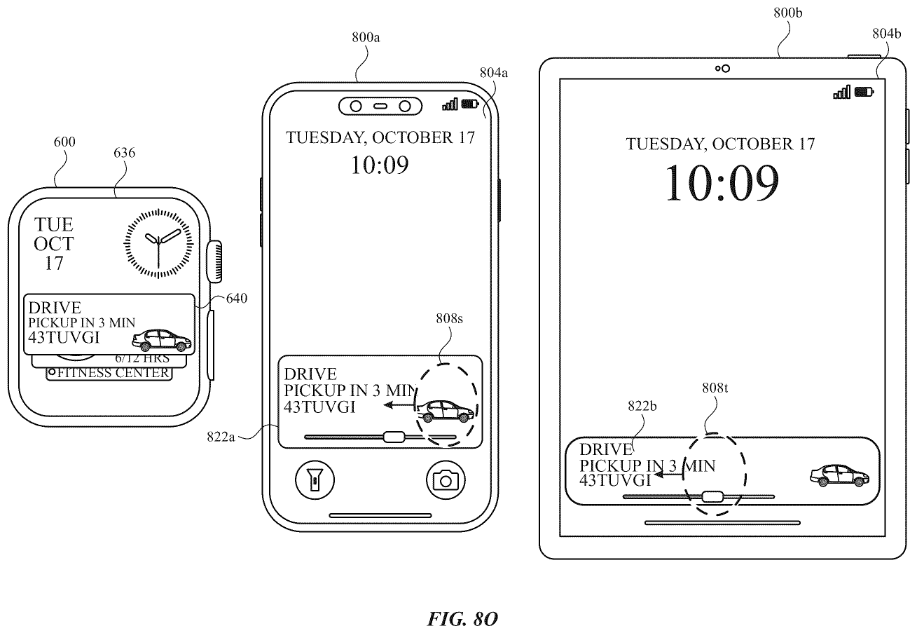

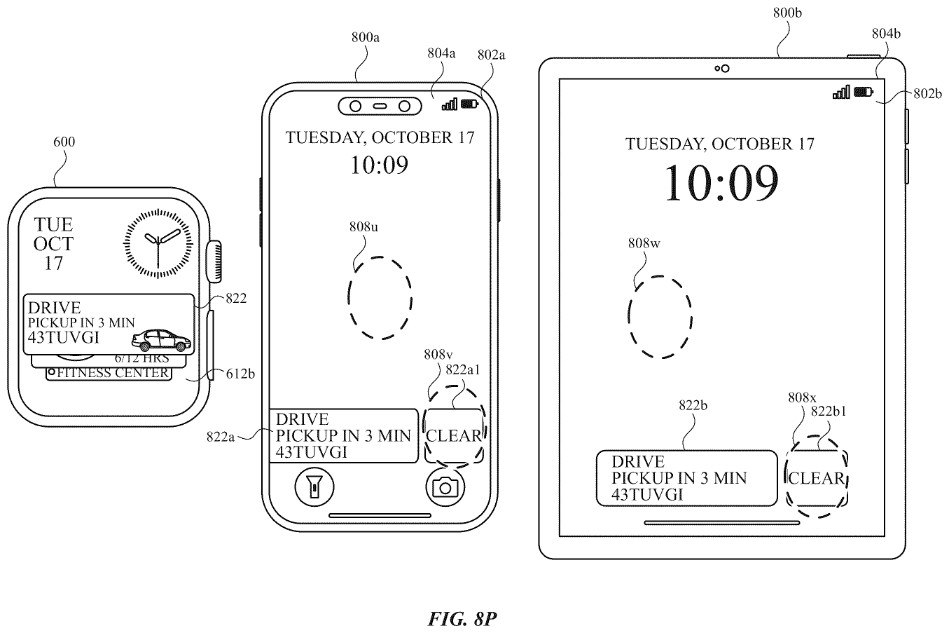

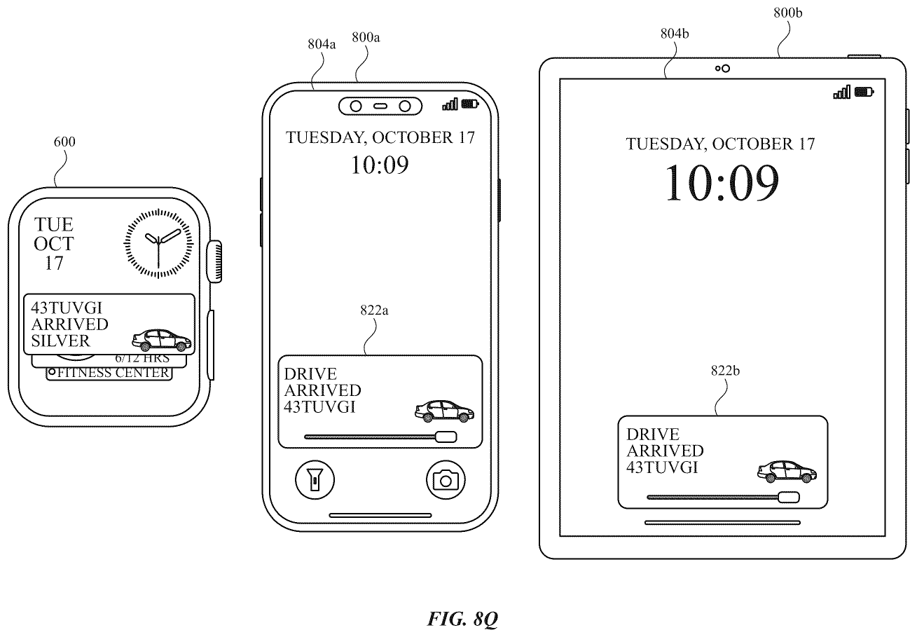

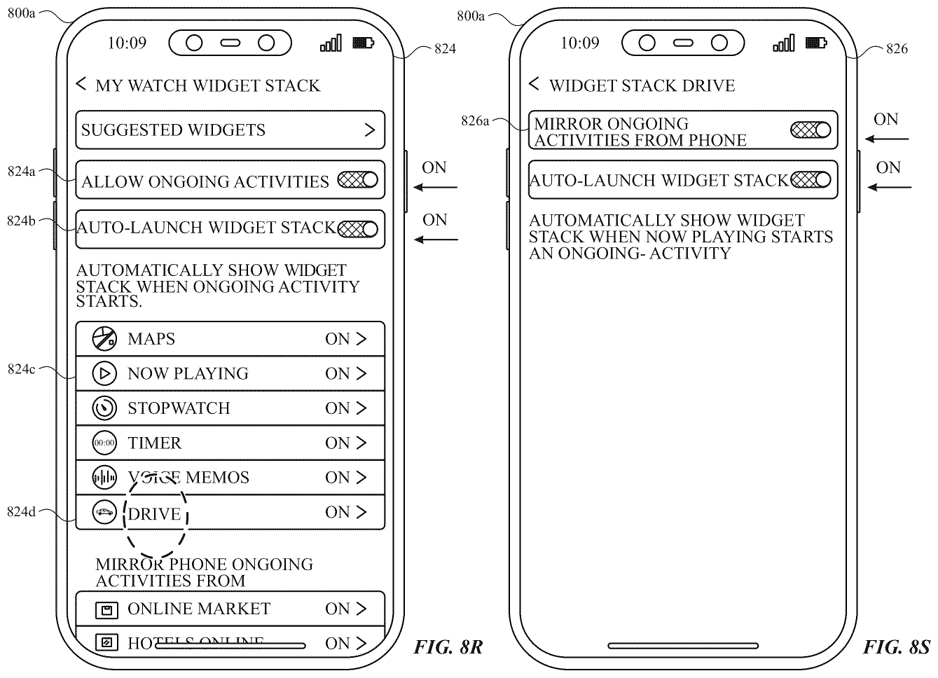

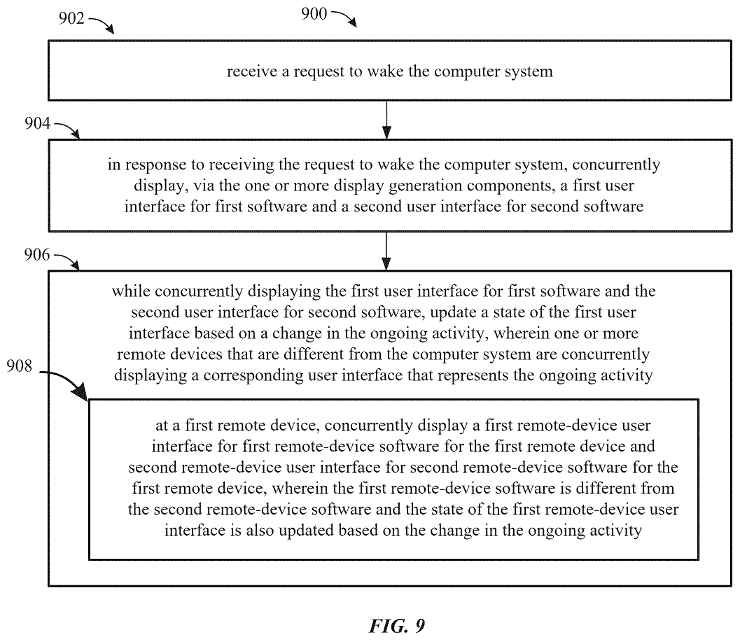

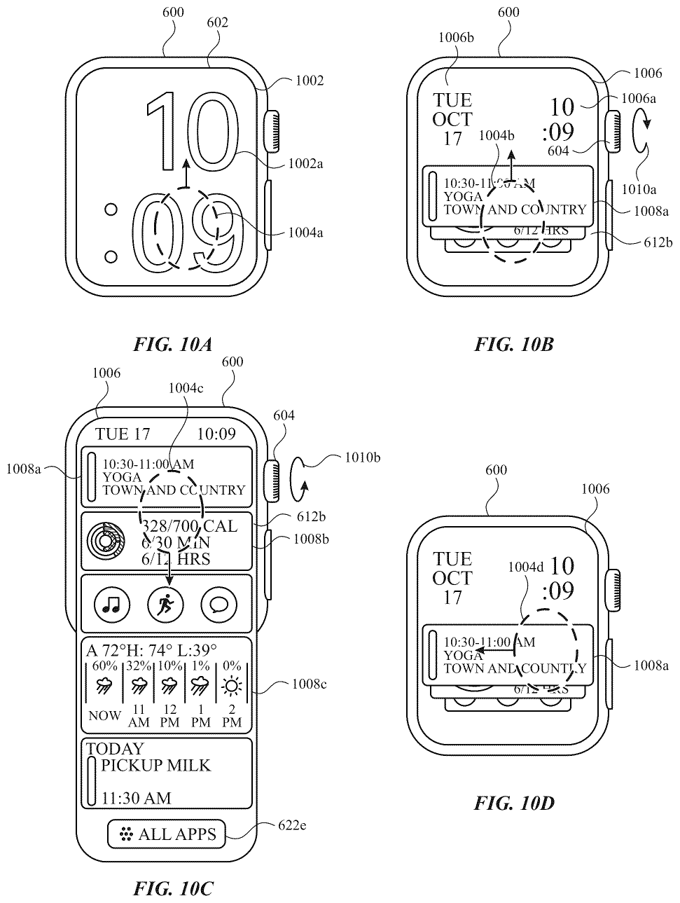

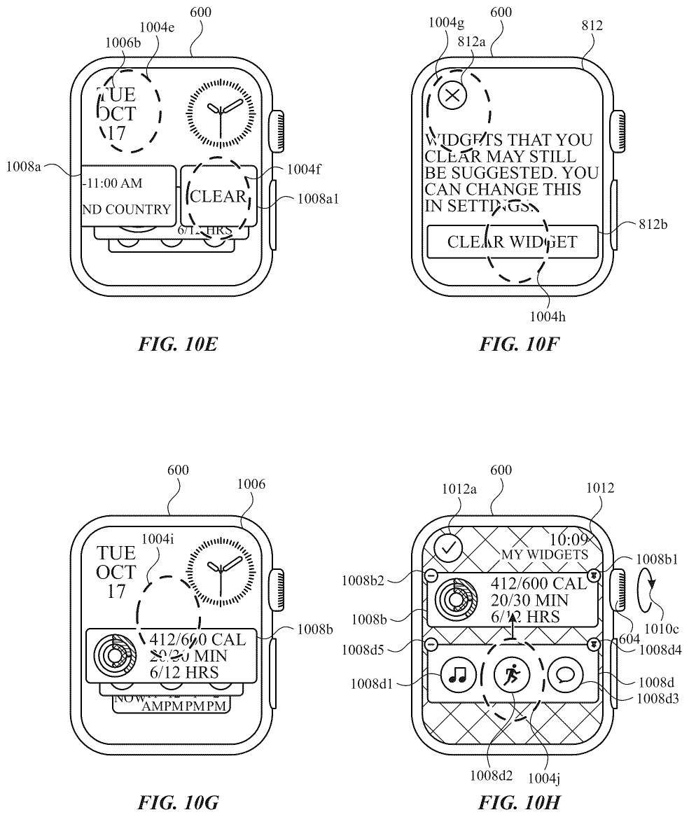

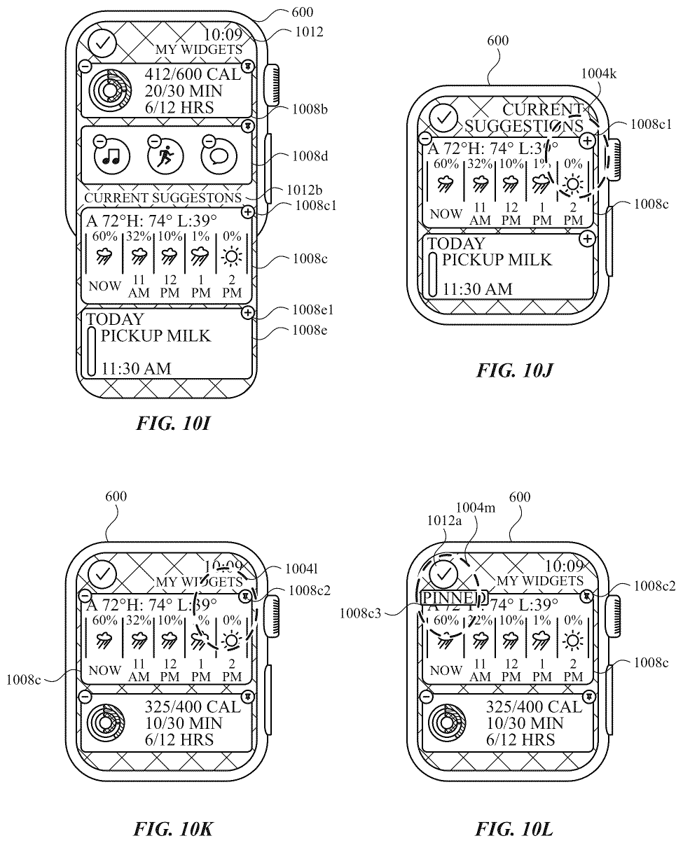

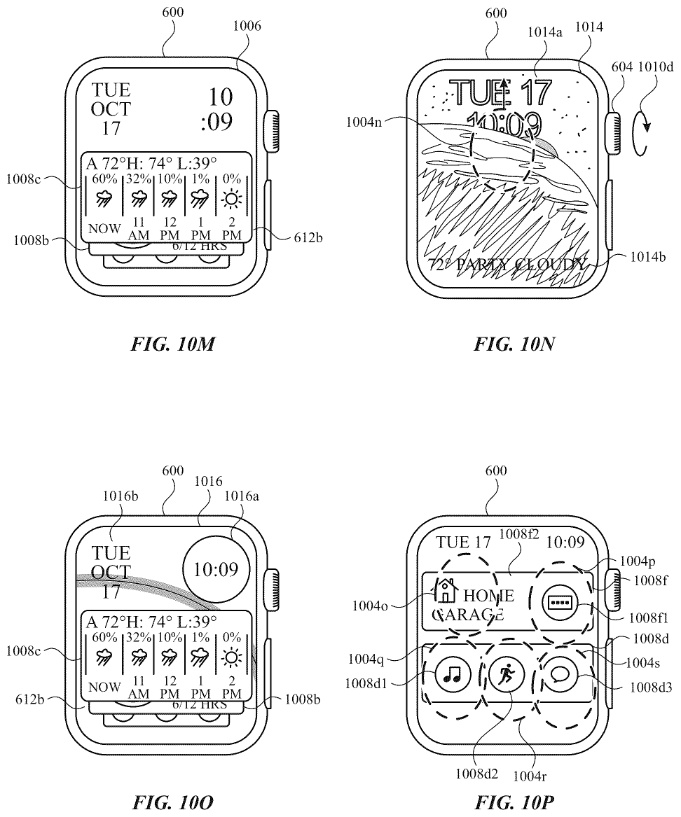

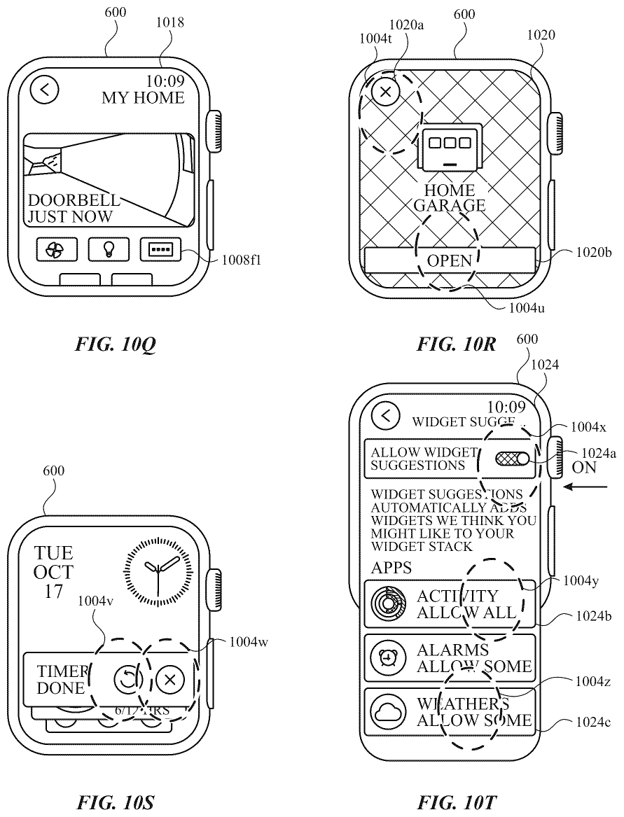

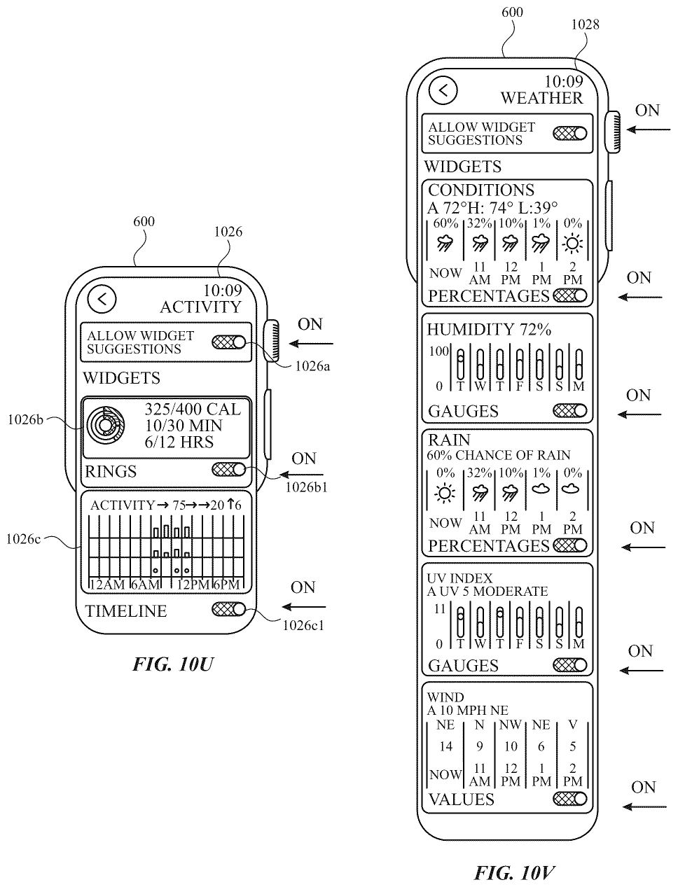

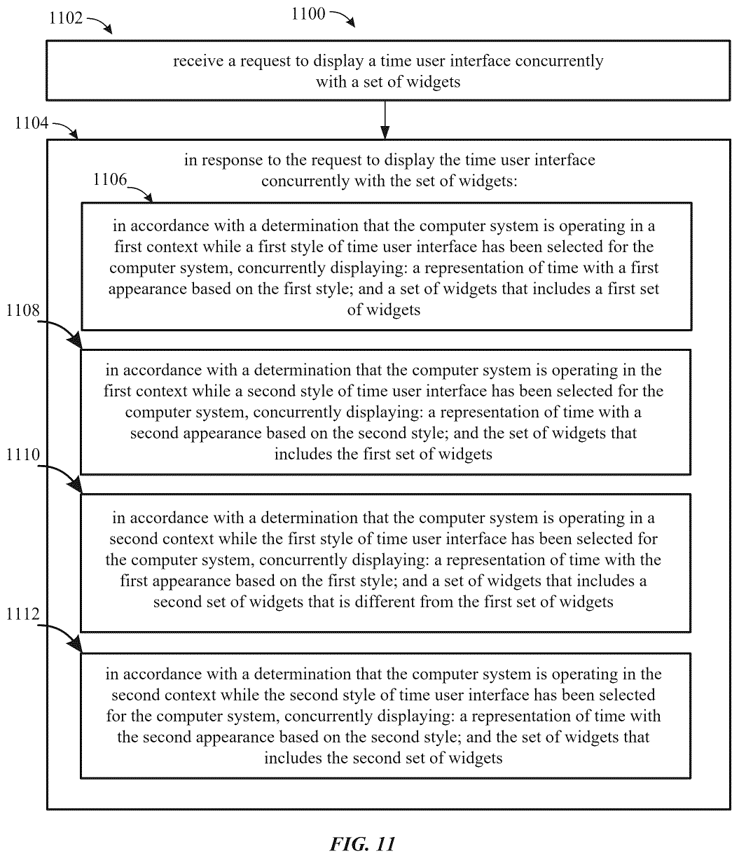

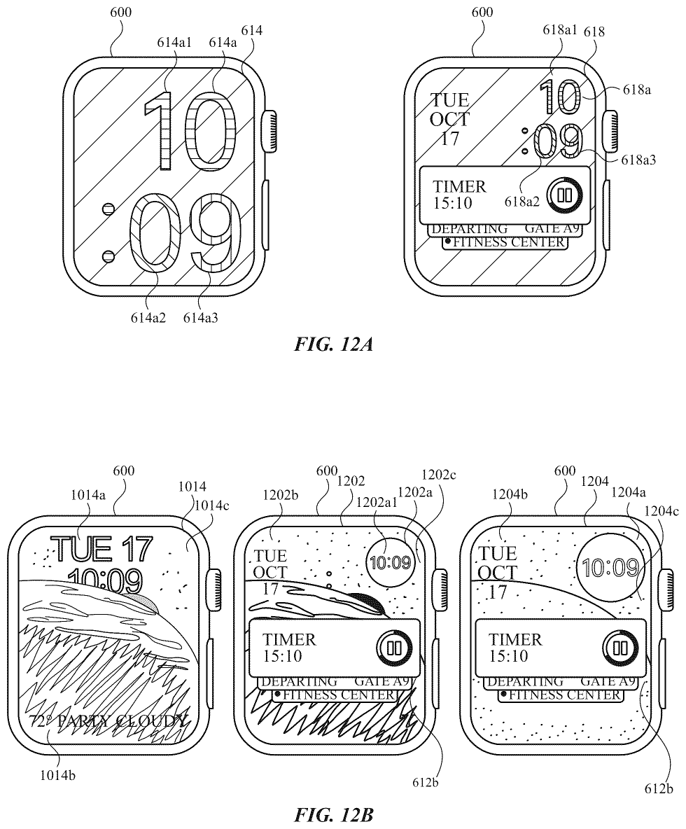

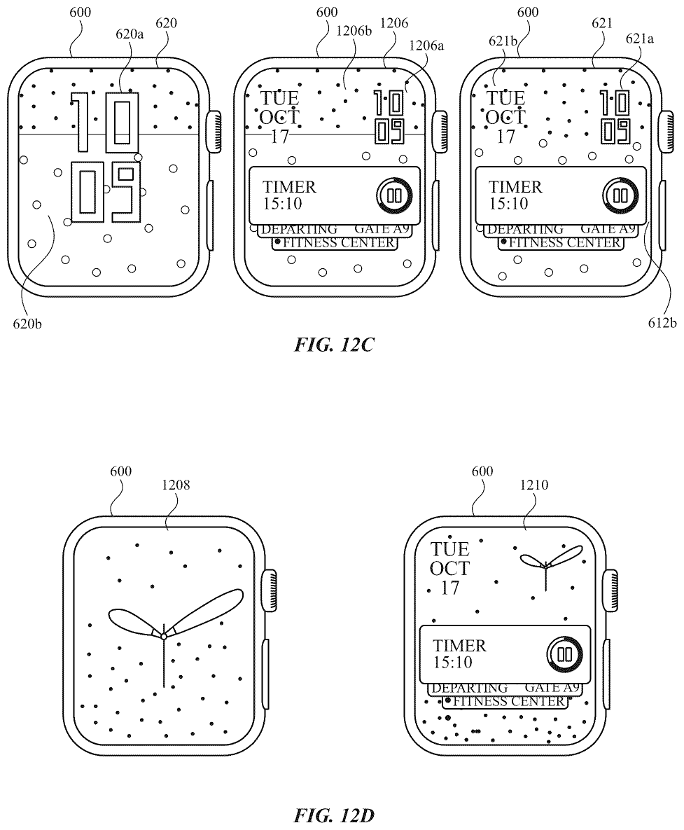

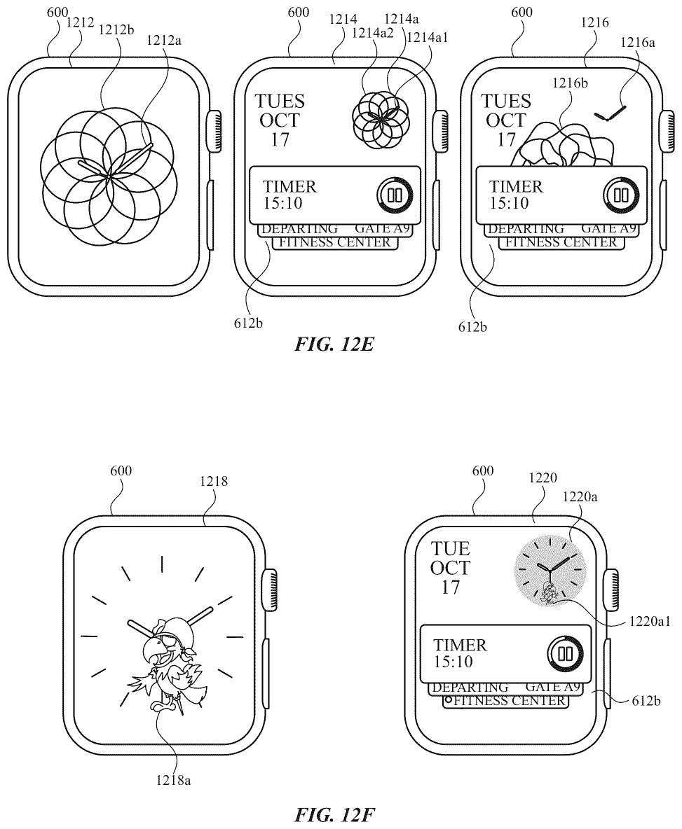

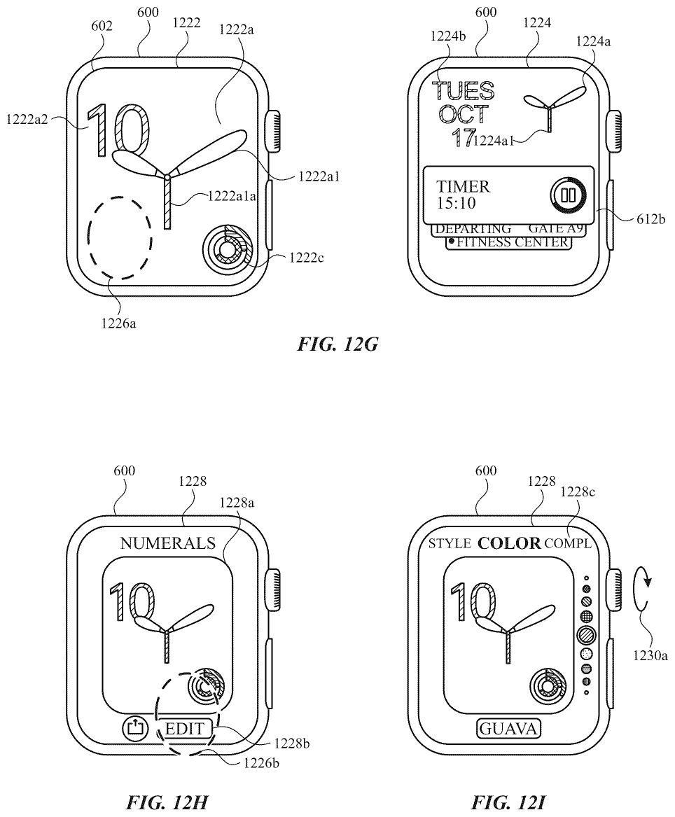

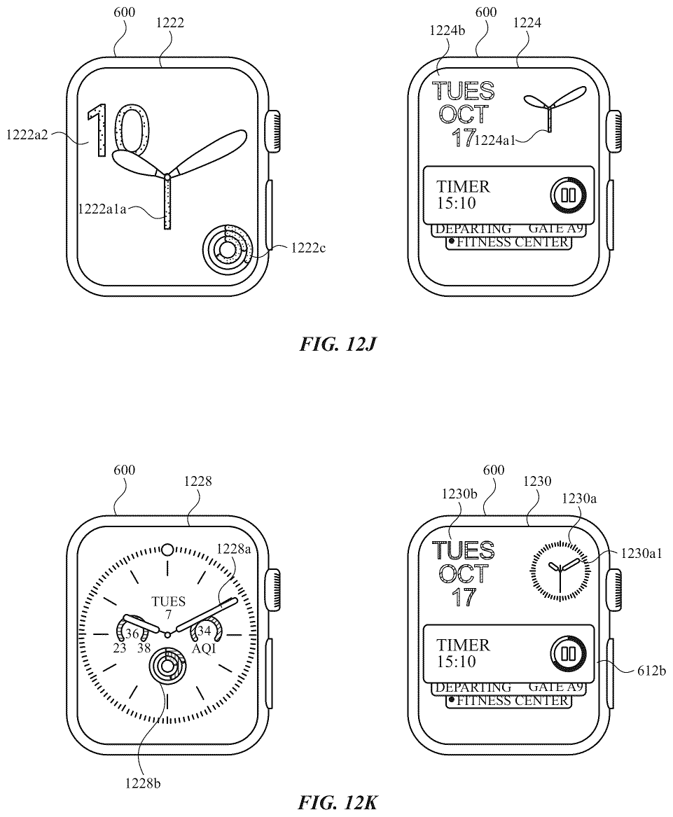

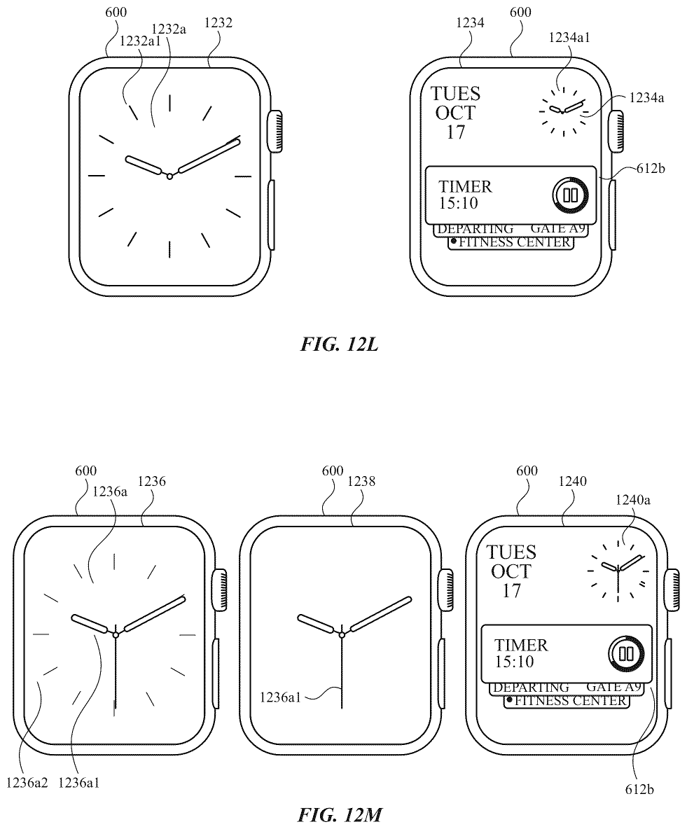

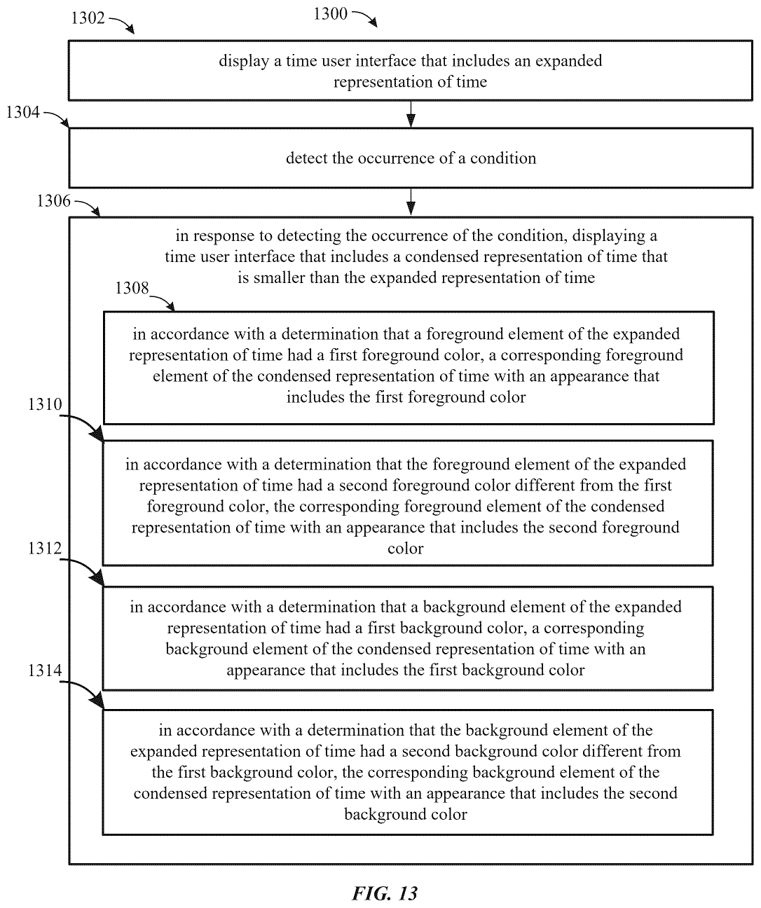

Below, FIGS. 1A-1B, 2, 3A, 4A-4B, and 5A-5B provide a description of exemplary devices for performing the techniques for managing event notifications. FIGS. 6A-6AQ illustrate exemplary techniques for displaying a representation of time based on ongoing activities. FIG. 7 is a flow diagram illustrating methods of displaying a representation of time based on ongoing activities in accordance with some embodiments. The user interfaces in FIGS. 6A-6AQ are used to illustrate the processes described below, including the processes in FIG. 7. FIGS. 8A-8S illustrate exemplary techniques for synchronizing a state of an ongoing activity across multiple computer systems. FIG. 9 is a flow diagram illustrating methods of synchronizing a state of an ongoing activity across multiple computer systems in accordance with some embodiments. The user interfaces in FIGS. 8A-8S are used to illustrate the processes described below, including the processes in FIG. 9. FIGS. 10A-10V illustrate exemplary techniques for managing widgets for inclusion in a set of widgets. FIG. 11 is a flow diagram illustrating methods of managing widgets for inclusion in a set of widgets in accordance with some embodiments. The user interfaces in FIGS. 10A-10V are used to illustrate the processes described below, including the processes in FIG. 11. FIGS. 12A-12M illustrate exemplary techniques for displaying corresponding representations of time. FIG. 13 is a flow diagram illustrating methods of displaying corresponding representations of time in accordance with some embodiments. The user interfaces in FIGS. 12A-12M are used to illustrate the processes described below, including the processes in FIG. 13.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

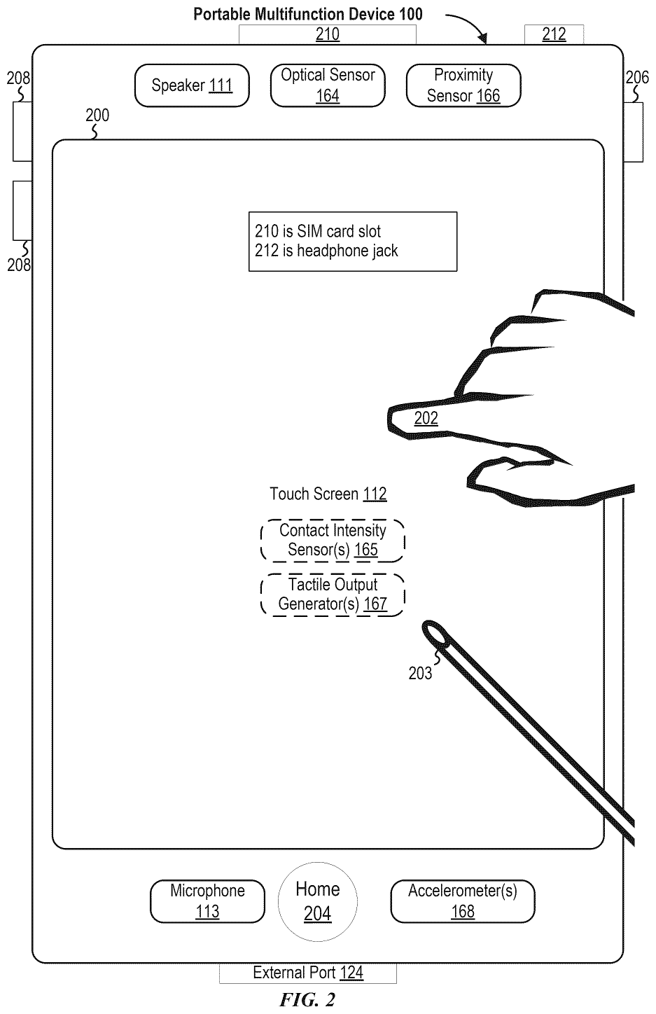

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

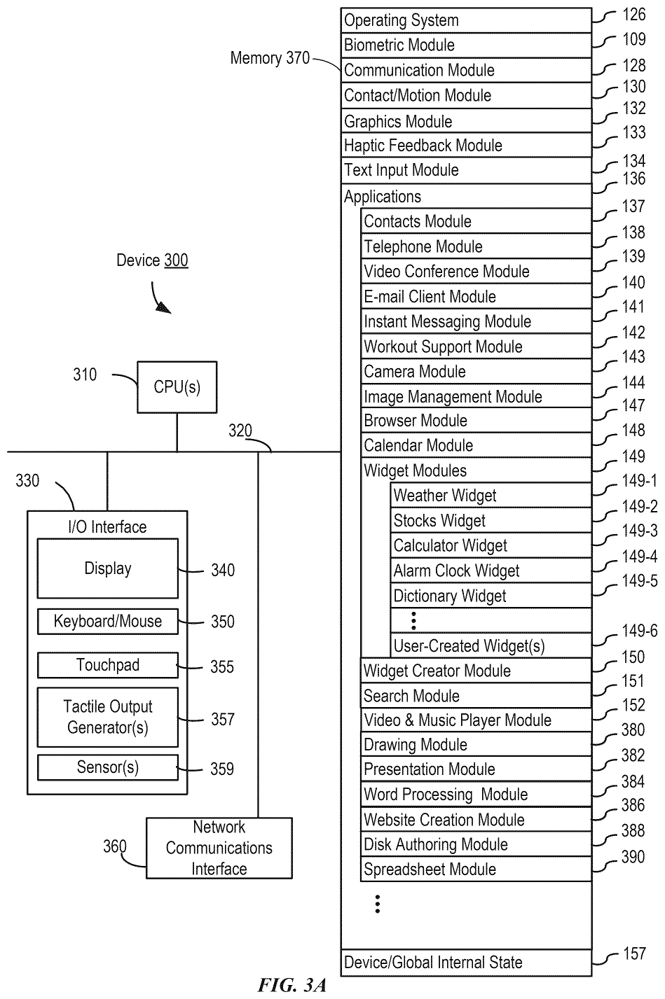

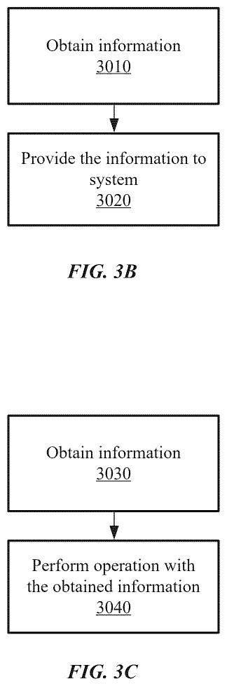

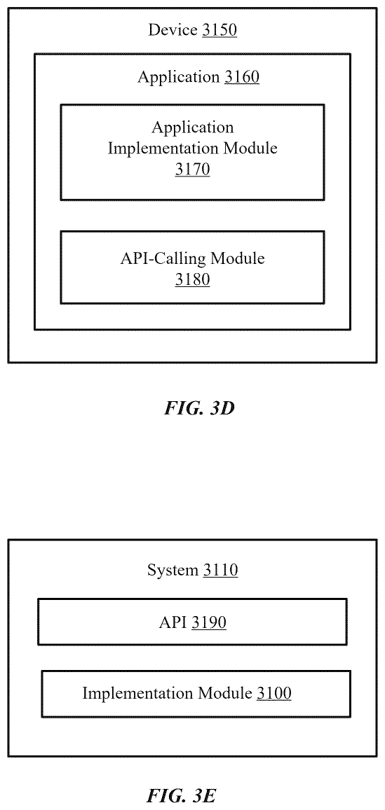

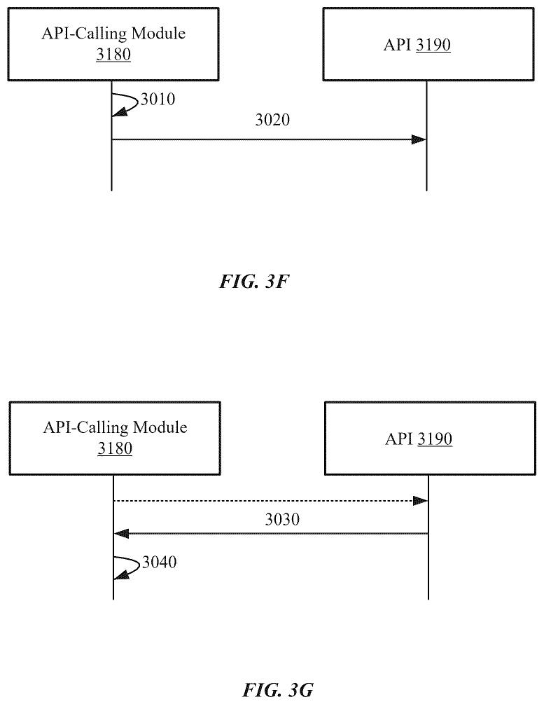

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript® file. In some embodiments, a widget includes an XML (Extensible Markup Language) file and a JavaScript® file (e.g., Yahoo!® Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, 1100, and/or 1300 (FIGS. 7, 9, 11, and/or 13) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

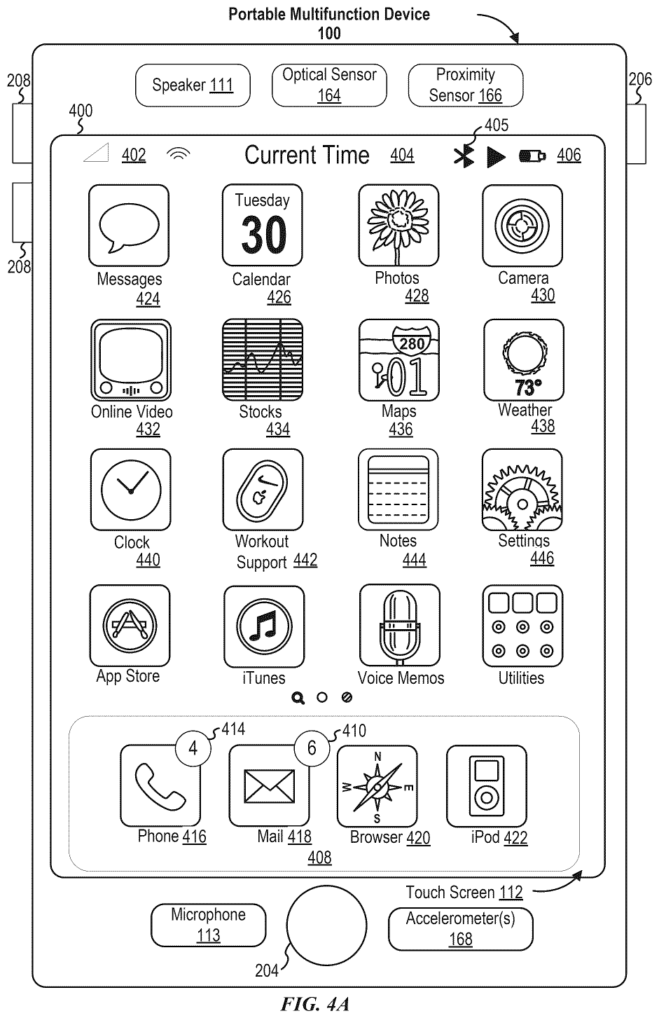

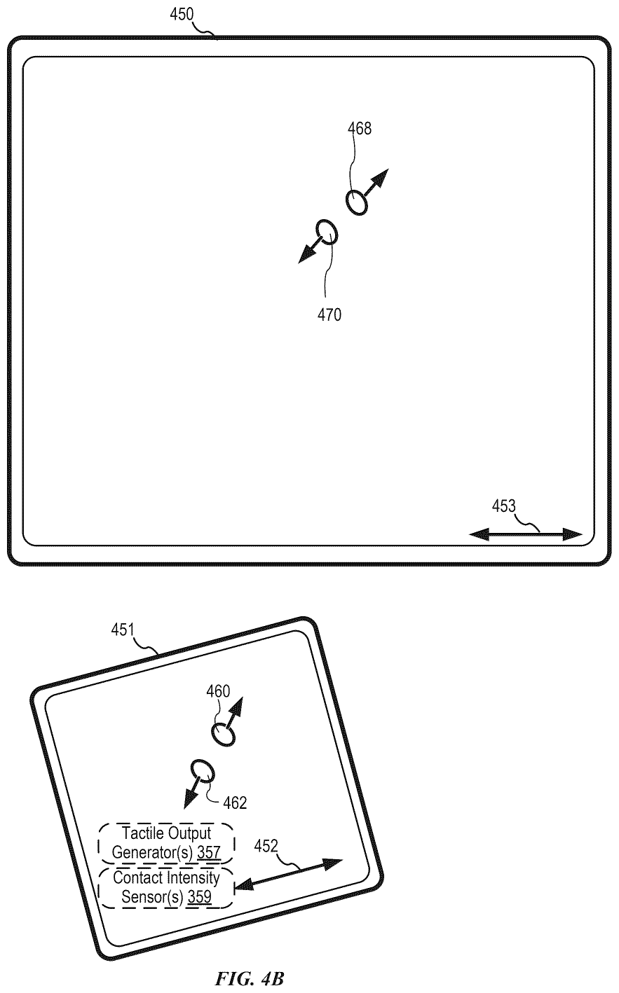

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., touch-sensitive surface 451 in FIG. 4B) has a primary axis (e.g., 452 in FIG. 4B) that corresponds to a primary axis (e.g., 453 in FIG. 4B) on the display (e.g., display 450). In accordance with these embodiments, the device detects contacts (e.g., contact 460 and contact 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., touch-sensitive surface 451 in FIG. 4B) are used by the device to manipulate the user interface on the display (e.g., display 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

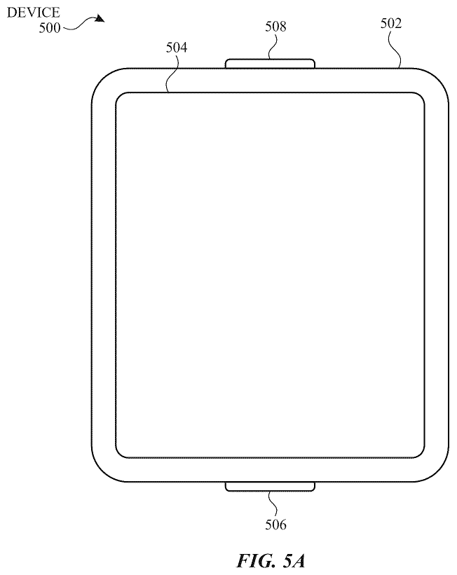

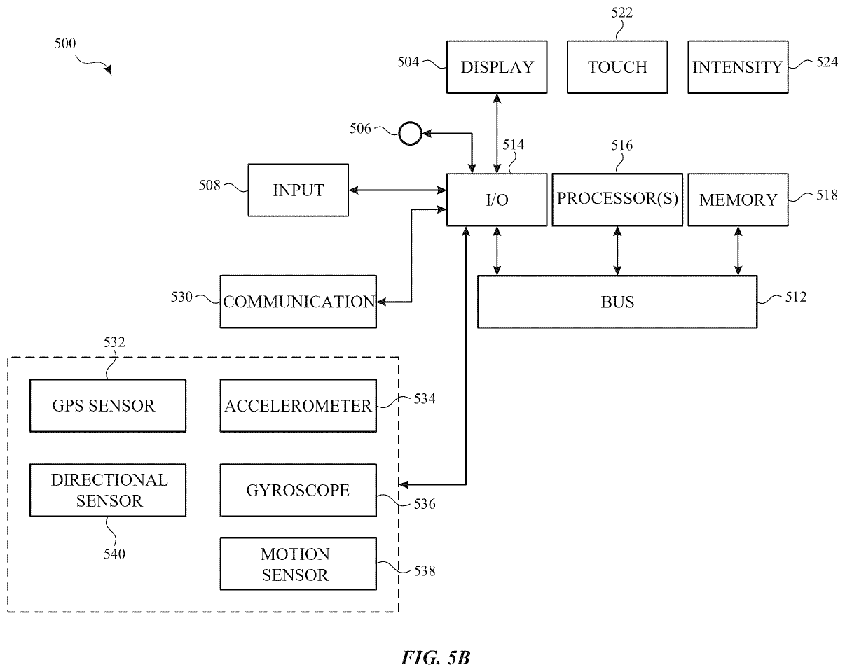

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage media, for storing computer-executable instructions, which, when executed by one or more computer processors 516, for example, can cause the computer processors to perform the techniques described below, including processes 700, 900, 1100, and 1300 (FIGS. 7, 9, 11, and 13, respectively). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray® technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

In some embodiments, the computer system is in a locked state or an unlocked state. In the locked state, the computer system is powered on and operational but is prevented from performing a predefined set of operations in response to user input. The predefined set of operations optionally includes navigation between user interfaces, activation or deactivation of a predefined set of functions, and activation or deactivation of certain applications. The locked state can be used to prevent unintentional or unauthorized use of some functionality of the computer system or activation or deactivation of some functions on the computer system. In some embodiments, in the unlocked state, the computer system is powered on and operational and is not prevented from performing at least a portion of the predefined set of operations that cannot be performed while in the locked state. When the computer system is in the locked state, the computer system is said to be locked. When the computer system is in the unlocked state, the computer is said to be unlocked. In some embodiments, the computer system in the locked state optionally responds to a limited set of user inputs, including input that corresponds to an attempt to transition the computer system to the unlocked state or input that corresponds to powering the computer system off.

Attention is now directed towards embodiments of user interfaces (“UI”) and associated processes that are implemented on an electronic device, such as portable multifunction device 100, device 300, or device 500.

FIG. 6A illustrates device 600, which includes display 602 (e.g., a touch-sensitive display), rotatable and depressible input mechanism 604, and button 606. In FIG. 6A, device 600 is a smartwatch (e.g., a computer system that operates as a wearable timekeeping device). In some embodiments, device 600 is a smartphone, a tablet computer, or a personal computer. In some embodiments, device 600 includes one or more features of device 100, 300, and/or 500.

At FIG. 6A, device 600 displays, on display 602, user interface 608. Interface 608 is a low power timekeeping user interface that is displayed by device 600 under certain conditions (e.g., when it is determined that the wearer of device 600 is not actively interacting with device 600). While displaying interface 608, device 600 detects that a set of wake criteria for transitioning into a higher power state is met. In some embodiments, the set of criteria includes a criterion that is met when a touch is detected on display 602, when data is received (e.g., data for an incoming message or other notification-causing data), and/or when a wrist raise gesture is detected (e.g., device 600 is moved in manner indicative of device 600 being raised into a view position). Upon transitioning into the higher power state, device 600 displays a user interface (e.g., a timekeeping user interface and/or a wake screen user interface) that is selected based on whether an ongoing activity is currently in progress. In some embodiments, an ongoing activity is a time-based activity, an activity with constant, periodic, and/or frequent updates, a task, a live event, an external event, an internal event, a user-initiated action, an action with updates at a predetermined frequency, an action with updates at regular intervals, and/or an action with updates at irregular intervals. Examples of ongoing activities can include timer activities, navigation activities, delivery and/or event tracking activities, and/or workout tracking activities. In some embodiments, an ongoing activity is an activity that includes frequent content and/or status updates. In some embodiments, an ongoing activity receives content and/or updates at a rate and/or of a volume that would be inefficient and/or ineffective to present via a push notification system (e.g., because doing so would generate too many notifications in a short span of time and/or because doing so would consume large amounts of system resources (e.g., battery power)). In some embodiments, an ongoing activity is referred to as an activity of a first type.

At FIG. 6B, in response to detecting that the set of wake criteria are met and based on a determination that an ongoing activity is not in progress, device 600 displays user interface 610, a wake screen and time interface (e.g., clock face) of a first style (e.g., an analog style) that is displayed when there are no currently active ongoing activities. User interface 610 includes clock hands 610a and background 610b, with both at a size that occupies a majority of display 602. In some embodiments, user interface 610 is a different watch face, such as those described further below. At FIG. 6B, user interface 610 does not include a widget corresponding to an ongoing activity, in contrast to user interface 612, described with reference to FIG. 6C.

At FIG. 6C, in response to detecting that the set of wake criteria are met and based on a determination that an ongoing activity (e.g., a timer activity) is in progress, device 600 displays user interface 612. User interface 612 is a wake screen and time interface that includes reduced-size analog clock face 612a, widget stack 612b, and day-and-date indication 612c. Reduced-size analog clock face 612a includes clock hands 612a1 and background 612a2 that are both smaller in size than clock hands 610a and background 610b of FIG. 6B, respectively. Widget stack 612b includes widget 612b1 that represents an ongoing timer activity that is in progress, widget 612b2 that represents an ongoing flight-tracking activity that is in progress, and widget 612b3 that represents a fitness center application that is not an ongoing activity. In some embodiments, the widgets of widget stack 612b are arranged in an ordered sequence that is ordered on one or more criteria including a) whether a widget represents an ongoing activity that is in progress, b) recency of an update to information for the widget, c) a current context of device 600 (e.g., a location, time, and/or local environmental condition such as weather and/or lighting) and/or d) user preference (e.g., a user pinning a widget). In some embodiments, widget stack 612b includes one or more widgets and/or features of the widgets described in U.S. patent application Ser. No. 18/373,186, filed Sep. 26, 2023, which is hereby incorporated by reference for all purposes, particularly with respect to the discussion of widgets.

In some embodiments, widget stack 612b includes more or less widgets than the three depicted in FIG. 6C. In some embodiments, a widget of widget stack 612b is associated with a local application operating on device 600. In some embodiments, a widget of widget stack 612b is associated with a remote application operating on an external device (e.g., another device that is associated with the user of device 600) that is in communication with device 600. In some embodiments, each widget of widget stack 612b corresponds to a different application (e.g., a remote or local application). In some embodiments, device 600 can clear/remove one or more widgets of widget stack 612b in response to an input, as described in more detail with reference to FIGS. 8E-8G and/or FIGS. 10D-10F.

At FIG. 6C, both widget 612b1 and widget 612b2 represent ongoing activities that are currently in progress. Widget 612b1 represents a countdown timer that is being maintained by a timer application (e.g., operating on device 600) that is being updated on a periodic basis (e.g., every second). Widget 612b1 includes affordance 612b1a for pausing the timer. Widget 612b2 represents a flight-tracking application (e.g., operating on device 600 or an external device) that is updated based on event changes, such as a gate change or the start of boarding or takeoff. Thus, FIGS. 6B and 6C depict alternative wakes screens with analog clock faces that can be displayed as device 600 transitions from the low power state depicted in FIG. 6A, depending on whether an ongoing activity is in progress. FIG. 6C, in particular, illustrates a wake screen that can be displayed when an ongoing activity is in progress so as to surface information regarding the ongoing activity, without the user having to provide additional inputs to display such information.

FIGS. 6D and 6E depict alternative wake screens with time interfaces (e.g., digital clock faces) that can be displayed as device 600 transitions from a low power state (e.g., as depicted in FIG. 6A) depending on whether an ongoing activity is in progress. At FIG. 6D in response to detecting that the set of wake criteria are met and based on a determination that an ongoing activity is not in progress, device 600 displays user interface 614, a wake screen and clock face of a second style (e.g., a digital style) that is displayed when there are no currently active ongoing activities. User interface 614 includes digits 614a, at a size that occupies a majority of display 602. User interface 614 also includes background 614b. At FIG. 6D, user interface 614 does not include a widget corresponding to an ongoing activity, in contrast to user interface 616, described with reference to FIG. 6E.

At FIG. 6E, in response to detecting that the set of wake criteria are met and based on a determination that an ongoing activity (e.g., a timer activity) is in progress, device 600 displays user interface 618. User interface 618 is a wake screen and time interface that includes reduced-size digital clock face 618a, widget stack 612b, and day-and-date indication 612c. Reduced-size digital clock face 618a includes digits that are smaller in size than digits 614a. Reduced-size digital clock face 618a also includes background 618b that matches background 614b of user interface 614. Widget stack 612b in FIG. 6E is the same as described with reference to FIG. 6C. Thus, FIGS. 6D and 6E depict alternative wakes screens with digital clock faces that can be displayed as device 600 transitions from the low power state depicted in FIG. 6A, depending on whether an ongoing activity is in progress.

FIGS. 6F and 6G depict alternative wake screens (e.g., time interfaces) with digital clock faces of a second digital style that can be displayed as device 600 transitions from a low power state (e.g., as depicted in FIG. 6A) depending on whether an ongoing activity is in progress. At FIG. 6F in response to detecting that the set of wake criteria are met and based on a determination that an ongoing activity is not in progress, device 600 displays user interface 620, a wake screen and clock face of a third style (e.g., a second digital style) that is displayed when there are no currently active ongoing activities. User interface 620 includes digits 620a, at a size that occupies a majority of display 602. User interface 620 also includes background 620b. At FIG. 6F, user interface 620 does not include a widget corresponding to an ongoing activity, in contrast to user interface 622, described with reference to FIG. 6G.

At FIG. 6G, in response to detecting that the set of wake criteria are met and based on a determination that an ongoing activity (e.g., a timer activity) is in progress, device 600 displays user interface 621. User interface 621 is a wake screen that includes reduced-size digital clock face 621a, widget stack 612b, and day-and-date indication 612c. User interface 621 also includes background 621b that has a pattern that matches, but is not identical to, background 620b of user interface 620. Reduced-size digital clock face 621a includes digits 621a1 that are smaller in size than digits 620a. Widget stack 612b in FIG. 6G is the same as described with reference to FIG. 6C. Thus, FIGS. 6F and 6G depict alternative wakes screens with digital clock faces that can be displayed as device 600 transitions from the low power state depicted in FIG. 6A, depending on whether an ongoing activity is in progress.

FIG. 6H depicts device 600 displaying user interface 622, a wake screen of a second analog style that is displayed when the set of wake criteria are met and based on a determination that an ongoing activity (e.g., a timer activity) is in progress. User interface 622 includes reduced-size analog clock face 622a, widget stack 612b, and day-and-date indication 612c. Reduced-size analog clock face 622a includes clock hands 622a1 and dial 622a2. Widget stack 612b in FIG. 6H is the same as described with reference to FIG. 6C.

At FIG. 6H, device 600 detects input 624a and/or input 626a. Input 624a is a downward swipe on display 602. Input 626a is a press of rotatable and depressible input mechanism 604. In some embodiments, input 624a, input 626a, and/or another input described herein is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 6I, in response to input 624a and/or input 626a, device 600 displays user interface 628, which includes analog clock hands 628a and dial 628b, with both at a size that occupies a majority of display 602. In some embodiments, displaying user interface 628 in response to input 624a and/or input 626a includes displaying an animation of widget stack 612b and day-and-date indication 612c transitioning off the display and reduced-size analog clock face 622a expanding into analog clock hands 628a and dial 628b. In some embodiments, user interface 628 is a clock screen that is displayed in response to detecting that the set of wake criteria are met while displaying a low power interface (e.g., as seen in FIG. 6A) and based on a determination that an ongoing activity is not in progress. In some embodiments, receiving input 624a and/or input 626a while displaying user interface 612 of FIG. 6C, user interface 618 of FIG. 6E, or user interface 622 of FIG. 6G causes device 600 to display user interface 610 of FIG. 6B, user interface 614 of FIG. 6D, or user interface 620 of FIG. 6F, respectively.

At FIG. 6I, device 600 detects input 624b, an upward swipe on display 602. In response to input 624b, device 600 displays user interface 622 of FIG. 6H. In some embodiments, receiving input 624b while displaying user interface 610 of FIG. 6B, user interface 614 of FIG. 6D, or user interface 620 of FIG. 6F causes device 600 to display user interface 612 of FIG. 6C, user interface 618 of FIG. 6E, or user interface 622 of FIG. 6G, respectively. Thus, device 600 can transition between a user interface having a large representation time, without widgets, or a user interface with a small representation of time and a stack of widgets (e.g., including widget(s) corresponding to an in-progress ongoing activity) by providing an appropriate input.

At FIG. 6J, while displaying user interface 622 (described above), device 600 detects input 624b and/or input 626b. Input 624b is an upward swipe on display 602. Input 626b is a clockwise rotation of rotatable and depressible input mechanism 604. In some embodiments, input 624b and/or input 626b is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 6K, in response to input 624b and/or input 626b, device 600 displays an animation of widget stack 612b translating upwards on display 602, including widget 612b1 moving up to replace/displace reduced-size analog clock face 612 and day-and-date indication 612c and widget 612b2 becoming fully visible. Interface 622 now also includes time indication 622c and date indication 622d. At FIG. 6K, device 600 detects input 624c and/or input 626c. Input 624c is an additional upward swipe on display 602. Input 626c is an additional clockwise rotation of rotatable and depressible input mechanism 604 (in some embodiments, further continued rotation of input 626b). In some embodiments, input 624c and/or input 626c is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 6L, in response to input 624c and/or input 626c, device 600 displays an end of widget stack 612b that includes a portion of penultimate widget 612b4 and last widget 612b5. Last widget 61265 includes affordance 612b5a, affordance 612b5b, and affordance 612b5c that can be used to access a music application, a workout application, and a messaging application, respectively. At FIG. 6L, user interface 622 now also includes affordance 622e for accessing a springboard user interface that includes affordances for all applications that are installed on device 600.

At FIG. 6L, device 600 detects input 624d and/or input 626d. Input 624d is a downward swipe on display 602. Input 626d is a counterclockwise rotation of rotatable and depressible input mechanism 604. In some embodiments, input 624d and/or input 626d is another type of touch input (e.g., a tap, a double tap, or a two-finger swipe), a hardware input (e.g., a button press, rotatable input mechanism rotation, and/or mouse movement), an air gesture, and/or a gaze-based input. In response to input 624d and/or input 626d, device first transitions back through the widgets of widget stack 612b and returns widget stack 612b to the state shown in FIG. 6J. As device 600 continues to detect input 624d and/or input 626d, device 600 ceases to display widget stack 612b (e.g., as described with reference to FIGS. 6H-6I) and displays user interface 628 in the state shown in FIG. 6M. Thus, while widget stack 612b is displayed, a user can use various inputs to navigate through the widgets of widget stack 612b or to dismiss widget stack 612b.

At FIG. 6M, device 600 displays user interface 628 that now includes affordance 628c. Affordance 628c indicates that a timer (e.g., an ongoing activity) is currently in progress. In some embodiments, the appearance of affordance 628c varies depending on the type of ongoing activity. In some embodiments, device 600 displays additional affordances to represent multiple in progress ongoing activities. In some embodiments where multiple ongoing activities are in progress, the appearance of affordance 628c reflects the most recently updated and/or the most recent ongoing activity with which the user interacted. In some embodiments, affordance 628c is displayed at a location at which other types of indicators (e.g., indicators that represent recent notifications, alerts, and/or updates) are displayed. At FIG. 6M, device 600 detects input 624e, which is a tap on affordance 628c. In some embodiments, input 624e is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 6N, in response to input 624e, device 600 displays user interface 630, which is an interface of a timer application that is maintaining the ongoing timer activity (e.g., the timer activity corresponding to widget 612b1). User interface 630 includes timer control affordances 630a1, 630a2, and 630a3 for adding an additional timer, cancelling the current timer, and pausing the current timer, respectively. User interface 630 also includes a graphical indication 630b that illustrates the state of the current timer and numerical indication 630c that also illustrates the same.

At FIG. 6O, device 600 is again displaying user interface 628, which now includes affordance 628d. Affordance 628d indicates that a ridesharing activity that corresponds to a ridesharing application is currently in progress. The ridesharing application that corresponds to affordance 628d is not installed on device 600. Rather, the application is installed at an external device (e.g., a smartphone) that is in communication with device 600. Device 600 displays affordance with a visual style (e.g., with a rectangular shape) that indicates that the associated application is remote. In some embodiments, the visual style that indicates a remote application is a color, size, or animated appearance that differs from that used for a locally-installed application (e.g., the timer application that corresponds to circular-shaped affordance 628c of FIG. 6M).

At FIG. 6P, device 600 detects an update for the ongoing ridesharing activity that corresponds to affordance 628d and modifies the visual appearance of affordance 628d to indicate the update. Specifically, device 600 increases the size of affordance 628d. In some embodiments, device 600 modifies the color, shape, and/or animates affordance 628d to indicate the update. At FIG. 6P, device 600 detects input 624f, which is a tap on affordance 628d. In some embodiments, input 624f is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 6Q, device 600 displays representation user interface 632, which is generated by the operating system of device 600, because the ridesharing application that corresponds to affordance 628d is not installed on device 600. Representation user interface 632 includes information provided by the remote ridesharing application, including route-and-location indicator 632a, estimated-time-of-arrival indicator 632b (e.g., indicating that the car is expected to arrive in 3 minutes), and car information 632c (e.g., indicating the license plate number of the car). Representation user interface 632 also includes affordance 632d for dismissing the interface. Notably, representation user interface 632 does not include affordances for controlling functions of the ongoing ridesharing activity (e.g., because the application is not locally-installed).

At FIG. 6R, device 600 displays user interface 634 (e.g., an interface similar to interface 622) with widget 634a that corresponds to an ongoing ridesharing activity. At FIG. 6R, widget 634a is the first ongoing activity widget that is being displayed on device 600 (e.g., since device 600 was first activated or since device 600 last received an operating system update). User interface 634 concurrently includes, along with widget 634a, accept affordance 634b and reject affordance 634c. Accept affordance 634b, when selected, enables device 600 to display (e.g., automatically display) widgets corresponding to ongoing activities (e.g., the ridesharing activity and/or the timer activity) that are in progress in a widget stack (e.g., widget stack 612b). Reject affordance 634c, when selected, causes device 600 to not display (e.g., not automatically display) widgets corresponding to ongoing activities that are in progress in the widget stack (e.g., unless a user manual selects the widget to be displayed). At FIG. 6R, device 600 detects input 624g, which is a tap on accept affordance 634b. In some embodiments, input 624g is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 6S, in response to input 624g, device 600 enables the display (e.g., automatic display) of widget(s) corresponding to ongoing activities that are in progress in widget stack 612b. Widget 634a corresponding to the ongoing ridesharing activity is now displayed in widget stack 612b.

At FIG. 6T, device 600 displays application user interface 636. Application user interface 636 is a user interface for a daily physical activity tracking application that is locally-installed on device 600. While displaying application user interface 636, device 600 receives an update corresponding to an ongoing ridesharing activity that is in progress.

At FIG. 6U, in response to receiving the update corresponding to an ongoing ridesharing activity that is in progress, device 600 displays miniature widget 638 that is displayed on top of application user interface 636. Miniature widget 638 includes first information (“DRIVE ARRIVED”) summarizing the update to the ongoing ridesharing activity that is in progress. In some embodiments, miniature widget 638 is updated to reflect additional information/updates, as they are received. At FIG. 6U, device 600 detects input 624h, which is a tap on miniature widget 638. In some embodiments, input 624h is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 6V, in response to input 624h, device 600 displays expanded widget 640 that corresponds to the ongoing ridesharing activity that is in progress. In FIG. 6V, expanded widget 640 is overlayed on application user interface 636 and is displayed at a location on display 602 that corresponds to where widgets of widget stack 612b would be displayed (e.g., displayed on wake screen user interface 622). Expanded widget 640 includes additional information about the ongoing ridesharing activity. At FIG. 6V, device 600 detects input 624i and/or input 626e. Input 624i is an upward swipe on display 602 that corresponds to expanded widget 640. Input 626e is a clockwise rotation of rotatable and depressible input mechanism 604. In some embodiments, input 624i and/or input 626e is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 6W, in response to input 624i and/or input 626e, device 600 scrolls the information in expanded widget 640 to display further information about the ongoing ridesharing activity (e.g., further information on the car for the ridesharing activity).

At FIG. 6X, device 600 displays settings user interface 642 that includes various affordances for modifying settings of device 600. Settings user interface 642 includes affordance 642a for modifying settings of user account of device 600, affordance 642b for modifying notifications of device 600, and affordance 642c for modifying settings of a widget stack (e.g., widget stack 612b) of device 600. At FIG. 6X, device 600 detects input 624j, which is a tap on affordance 642c. In some embodiments, input 624j is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 6Y, in response to input 624j, device 600 displays widget stack setting interface 644, which includes affordance 644a for managing suggested widgets and affordance 644b for managing the behavior of widgets corresponding to ongoing activities that are in progress. At FIG. 6Y, device 600 detects input 624k, which is a tap on affordance 644b. In some embodiments, input 624k is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 6Z, in response to input 624k, device 600 displays ongoing activity settings user interface 646. User interface 646 includes various options for controlling the behavior of ongoing activity widgets, including affordance 646a for modifying whether ongoing activity widgets are displayed in the widget stack (e.g., widget stack 612b), affordance 646b for modifying whether the widget stack is displayed when an ongoing activity starts, and affordances 646c1-646c3 for modifying whether specific ongoing activities are allowed or not allowed in the widget stack. At FIG. 6Z, device 600 detects input 624l and input 624m. Input 624l is a tap on affordance 646a. Input 624m is a tap on affordance 646c3. In some embodiments, input 624l and/or input 624m is another type of touch input (e.g., a swipe, a double tap, or a two-finger swipe), a hardware input (e.g., a button press, rotatable input mechanism rotation, and/or mouse movement), an air gesture, and/or a gaze-based input. In response to input 624l, device 600 toggles the setting (e.g., from enabled to disabled or vice versa) for allowing ongoing activity widgets to be displayed in the widget stack.

At FIG. 6AA, in response to input 624m, device 600 displays drive ongoing activity setting user interface 648. User interface 648 includes affordance 648a for modifying whether a widget corresponding to the drive/ridesharing ongoing activity is allowed in the widget stack and affordance 648b for controlling whether the start of the drive/ridesharing ongoing activity will cause the widget stack (e.g., widget stack 622) to be automatically displayed. Taken together, FIGS. 6X-6AA illustrate how settings for widgets of the widget stack, including widgets that correspond to ongoing activities can be managed at the group level or at the individual level, both for inclusion in the widget stack and whether a start of a respective ongoing activity causes the widgets stack to be automatically displayed. In some embodiments, one or more of the settings shown in FIGS. 6X-6AA can be configured using an application of an external electronic device (e.g., a smart phone) that is paired with device 600.

FIGS. 6AB-6AD illustrate various widgets associated with an ongoing timer activity. FIG. 6AB illustrates widget 650a of the timer ongoing activity, as displayed in widget stack 612b of user interface 622. FIG. 6AC illustrates miniature widget 650b of the timer ongoing activity, as displayed in application user interface 622. FIG. 6AD illustrates expanded widget 650c of the timer ongoing activity, as displayed in application user interface 622.

FIGS. 6AE-6AG illustrate various widgets associated with an ongoing sports-event-tracking activity. FIG. 6AE illustrates widget 652a of the sports-event-tracking ongoing activity, as displayed in widget stack 612b of user interface 622. FIG. 6AF illustrates miniature widget 652b of the sports-event-tracking ongoing activity, as displayed in application user interface 622. FIG. 6AG illustrates expanded widget 652c of the sports-event-tracking ongoing activity, as displayed in application user interface 622. The various widgets of the ongoing sports-event-tracking activity including information such as scores of a sporting event, time remaining, and current period of the event.

FIGS. 6AH-6AQ illustrate various widgets, as displayed in smart stack 622, for various different types of ongoing activities that are in progress. Each of these different types of ongoing activities can, in addition to having a widget that can be displayed in smart stack 622, can have miniature and expanded widget forms that can be displayed with application user interfaces (e.g., in a manner similar to those discussed for the timer and sports-event-tracking ongoing activities). At FIG. 6AH, device 600 displays widget 654a that includes information and a control for an alarm ongoing activity. At FIG. 6AI, device 600 displays widget 654b that includes information and a control for currently playing media ongoing activity. At FIG. 6AJ, device 600 displays widget 654c that includes information and multiple controls for a media recommendation ongoing activity that corresponds to ongoing media playback at an external device (e.g., kitchen smart speaker). At FIG. 6AK, device 600 displays widget 654d that includes information and a control for a physical workout ongoing activity. At FIG. 6AL, device 600 displays widget 654a that includes information (e.g., turn directions) for a navigation ongoing activity. At FIG. 6AM, device 600 displays widget 654f that includes information and a control for directional guidance (e.g., compass and route backtracking) ongoing activity. At FIG. 6AN, device 600 displays widget 654g that includes information and a control for a phone ongoing activity. At FIG. 6AO, device 600 displays widget 654h that includes information and a control for voice memo/recording ongoing activity. At FIG. 6AP, device 600 displays widget 654i that includes information for a notification (e.g., a notification with reminder to contact a contactable user) ongoing activity. At FIG. 6AQ, device 600 displays widget 654a that includes information for a food delivery ongoing activity. In some embodiments, the widgets shown in FIGS. 6AH-6AQ can be interacted with to provide additional information, provide additional controls, and/or to launch corresponding applications.

FIG. 7 is a flow diagram illustrating a method for displaying a representation of time based on ongoing activities using a computer system in accordance with some embodiments. Method 700 is performed at a computer system (e.g., 100, 300, 500, 600, 800a, and/or 800b) (e.g., a smartwatch, a smartphone, a tablet computer, a laptop computer, and/or a desktop computer) that is in communication with one or more display generation components (e.g., a display controller, a display, a touch-sensitive display system, a touchscreen, a head-mounted display, and/or a monitor) and one or more input devices (e.g., a touch-sensitive surface, a touchscreen display, a button, a keyboard, a mouse, a joystick, a camera sensor, and/or a microphone). Some operations in method 700 are, optionally, combined, the orders of some operations are, optionally, changed, and some operations are, optionally, omitted.

As described below, method 700 provides an intuitive way for displaying a representation of time based on ongoing activities. The method reduces the cognitive burden on a user for displaying a representation of time based on ongoing activities, thereby creating a more efficient human-machine interface. For battery-operated computing devices, enabling a user to display a representation of time based on ongoing activities faster and more efficiently conserves power and increases the time between battery charges.

The computer system (e.g., 100, 300, 500, and/or 600) receives (702), via the one or more input devices (e.g., 602, 604), a request (e.g., an input, a raise or rotation gesture, a tap gesture (e.g., on a touch-sensitive surface), a voice command, a button press, and/or a rotation of a rotatable input mechanism) to display a time user interface (e.g., a watch face and/or a wake screen) (e.g., 610, 612).

In response to receiving the request to display the time user interface (704) and in accordance with a determination (706) (e.g., as described with reference to FIG. 6C) that an activity of a first type (e.g., a time-based activity, an activity with constant, periodic, and/or frequent updates, a task, a live event, an external event, an internal event, a user-initiated action, an action with updates at a predetermined frequency, an action with updates at regular intervals, and/or an action with updates at irregular intervals) is in progress (e.g., a timer is counting down, an alarm has been snoozed, music is playing, a recommendation has been suggested, a workout is in progress, navigation is in progress, tracking with a compass is in progress, a phone call is in progress, a voice memo is in progress, tracking a sporting event is in progress, and/or tracking progress toward a destination is in progress), and a first style (e.g., the style described with reference to FIGS. 6B and 6C) has been selected for the time user interface, the computer system displays (704), via the one or more display generation components (e.g., 602), a first time user interface (e.g., 612) (e.g., a watch face and/or a user interface that includes an indication of time) that includes a first condensed representation of a current time (e.g., 512a) that is displayed concurrently with a representation of (e.g., a widget, a notification, and/or an icon that represents) the activity of the first type (e.g., 612b1). In some embodiments, the representation of the activity of the first type includes important, useful, and/or time-sensitive information regarding the activity of the first type. In some embodiments, an activity of a first type can include, but is not limited to, timer activities, navigation/map direction activities, media playback activities, phone or videoconference activities, ride-sharing activities, and/or delivery (e.g., of food) activities. In some embodiments, an activity of a first type is an activity that includes frequent content and/or status updates. In some embodiments, an activity of a first type receives content and/or updates at a rate and/or of a volume that would be inefficient and/or ineffective to present via a push notification system (e.g., because doing so would generate too many notifications in a short span of time and/or because doing so would consume large amounts of system resources (e.g., battery power)). In some embodiments, an activity of a first type is referred to as an ongoing activity.

In response to receiving the request to display the time user interface and in accordance with a determination (708) that an activity of the first type is not in progress (e.g., as described with reference to FIG. 6B) and the first style (e.g., the style described with reference to FIGS. 6B and 6C) has been selected for the time user interface, displaying, via the one or more display generation components, a second time user interface (e.g., 610) (e.g., a watch face) that includes a first expanded representation of the current time (e.g., 610a) without including a representation of an activity of the first type (e.g., without including 612b1). The first condensed representation of the current time on the first-time user interface is smaller than the first expanded representation of the current time on the second user interface. Both the first condensed representation of the current time and the first expanded representation of the current time are displayed with an appearance that is based on the first style. In some embodiments, the first time user interface includes an indication of time that is displayed at a smaller size than the indication of time that is displayed in the second time user interface.

In response to receiving the request to display the time user interface and in accordance with a determination (710) that an activity of the first type is in progress and a second style (e.g., the style described with reference to FIGS. 6D and 6E), different from the first style, has been selected for the time user interface, displaying, via the one or more display generation components, a third time user interface (e.g., 618) that includes a second condensed representation of a current time (e.g., 618a) that is displayed concurrently with the representation of the activity of the first type (e.g., 612b1).

In response to receiving the request to display the time user interface and in accordance with a determination (712) that an activity of the first type is not in progress and the second style (e.g., the style described with reference to FIGS. 6D and 6E) has been selected for the time user interface, displaying, via the one or more display generation components, a fourth time user interface (e.g., 614) that includes a second expanded representation of the current time (e.g., 614a) without including a representation of an activity of the first type (e.g., without including 612b1). The second condensed representation of the current time on the third time user interface is smaller than the second expanded representation of the current time on the fourth time user interface. Both the second condensed representation of the current time and the second expanded representation of the current time are displayed with an appearance that is based on the second style. The first expanded representation of the current time has a different appearance than the second expanded representation of the current time. The first condensed representation of the current time has a different appearance than the second condensed representation of the current time. Conditionally displaying a condensed or expanded representation of a current time based on whether an activity of a first type is in progress or not in progress controls the type of representation of current time that is displayed when a set of conditions have been met without requiring further user input and also provides improved visual feedback as to whether an activity of the first type is in progress. Doing so also optimizes display-area real-estate based on whether a representation of the activity of the first type is being displayed or not displayed. Performing an operation when a set of conditions has been met without requiring further user input, providing improved visual feedback to the user, and optimizing the use of display-area-real-estate enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently. Conditionally displaying different time user interfaces based on whether different styles have been selected performs an operation (e.g., the display of the different time user interfaces) when a set of conditions has been met without requiring further user input. Doing so enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, the activity of the first type is an activity (e.g., the timer activity of 612b1) that has a state (e.g., the state of the timer of 612b1) that is updated over time (in some embodiments, updated at a regular interval over time (e.g., every second or every minute)) (in some embodiments, updated based on a detected event or change (e.g., a change in location, a change in weather, a navigation event, a score of a sporting event, and/or a stock price change event)). The computer system detects a change in the state of the activity of the first type from a first state to a second state; and in response to detecting the change in the state of the activity of the first type, the computer system updates the representation of the activity of the first type (e.g., 612b1) based on the second state of the activity of the first type. In some embodiments, an appearance of the representation of the activity of the first type changes based on ongoing state changes in the activity of the first type. Updating the representation of the activity of the first type based on changing state of the activity provides improved visual feedback as to state of a dynamic activity.

In some embodiments, the first condensed representation of the current time (e.g., 612a) includes date information (e.g., 612c) (e.g., a current date and/or current day). In some embodiments, the second condensed representation of the current time includes date information.

In some embodiments, the representation of the activity of the first type (e.g., 612b1) is a user-selectable graphical user interface object that is displayed as part of a plurality of user-selectable graphical user interface objects (e.g., 612b) (e.g., a plurality and/or a stack of widgets) (in some embodiments, widgets that display information from one or more applications). In some embodiments, the plurality of user-selectable graphical user interface objects are arranged in an ordered sequence (e.g., a scrollable ordered stack) (in some embodiments, the plurality of user-selectable graphical user interface objects includes other representations of activities of the first type). In some embodiments, the plurality of user-selectable graphical user interface objects are displayed as a three-dimensional stack of objects (e.g., with objects receding into the background as seen in FIGS. 6H-6K). Displaying the representation of the activity of the first type as part of a plurality of user-selectable graphical user interface objects provides the user with access to other selectable objects (e.g., objects for related functions and/or related activities), which reduces the number of inputs needed to access other operations.

In some embodiments, the plurality of user-selectable graphical user interface objects (e.g., 612b) includes: a first user-selectable graphical user interface object that corresponds to a first application (e.g., 612b1) (e.g., a weather application, a stock application, or a timer application); and a second user-selectable graphical user interface object that corresponds to a second application (e.g., 612b2), different from the first application. In some embodiments, the plurality of the plurality of user-selectable graphical user interface objects includes only one plurality of user-selectable graphical user interface object that corresponds to any given application.

In some embodiments, while the plurality of user-selectable graphical user interface objects (e.g., 612b) is displayed, the computer system detects, via the one or more input devices, a first user input (e.g., 624b, 626b, 612b1) (e.g., rotation of rotatable input mechanism and/or a movement gesture such as a swipe on a touch-sensitive surface or an air gesture); and in response to detecting the first user input, updating (in some embodiments, navigating through and/or scrolling) the plurality of user-selectable graphical user interface objects to include a third user-selectable graphical object (e.g., 612b3 as seen in FIG. 6K) (e.g., an object that was not displayed or partially displayed prior to detecting the first user input). In some embodiments, the plurality of user-selectable graphical user interface objects are arranged as a stack of widgets and updating the plurality of user-selectable graphical user interface objects includes navigating through the stack to reveal/display the third user-selectable graphical object. In some embodiments, the direction of navigation depends on a direction of the first user input (e.g., a direction of swipe input or a direction of rotational input). In some embodiments, the amount of navigation is based on a magnitude of the input (e.g., magnitude of a swipe or amount of rotation). Updating the plurality of user-selectable graphical user interface objects in response to input provides additional control options when needed without cluttering the UI with additional displayed controls at other times.

In some embodiments, the representation of the activity of the first type (e.g., 640 in FIG. 6V) includes a first set of information corresponding to the activity of the first type. While the representation of the activity of the first type is displayed, the computer system detects, via the one or more input devices, a second user input (e.g., 626e) (e.g., actuation of a button and/or a rotatable input mechanism, an input on a touch-sensitive surface) (in some embodiments, an input that is a request to minimize the representation of the activity of the first type and/or the plurality of plurality of user-selectable graphical user interface objects). In response to detecting the second user input, the computer system ceases to display the representation of the activity of the first type; and displays an indicator of the activity of the first type (e.g., 640 in FIG. 6W) that includes a second set of information corresponding to the activity of the first type, wherein the first set of information corresponding to the activity of the first type includes first information that is not included in the second set of information corresponding to the activity of the first type (in some embodiments, the second set of information corresponding to the activity of the first type is a subset of the first set of information corresponding to the activity of the first type). Providing the user with a control option to display an indicator that includes a portion of the information included in the representation of the activity of the first type provides additional information when needed without cluttering the UI with the additional information at other times.

In some embodiments, displaying the indicator of the activity of the first type includes: in accordance with a determination that the activity of the first type corresponds to an electronic device of a first type (in some embodiments, an application of a first type), displaying the indicator of the activity of the first type with a first visual appearance (e.g., a first shape (e.g., a round shape), a first color, a first pattern) (e.g., 628d as seen in FIG. 6P); and in accordance with a determination that the activity of the first type corresponds to an electronic device of a second type (in some embodiments, an application of a second type), different from the first type, displaying the indicator of the activity of the first type with a second visual appearance (e.g., a second shape (e.g., a square shape), a second color, a second pattern), different from the first visual appearance (e.g., 628d as seen in FIG. 8L). Displaying the indicator with different visual appearances based on the type of electronic device that the activity corresponds with provides improved visual feedback as to the correspondence of the activity.

In some embodiments, displaying the indicator of the activity of the first type (e.g., 612b1, 806a) includes: in accordance with a determination that the activity of the first type is in a first state (e.g., an ongoing state, an in progress state, and/or an active state), displaying the indicator of the activity of the first type with a first animated effect (e.g., an animation of the size of the indicator changing and/or an animation of the indicator glowing); and in accordance with a determination that the activity of the first type is in a second state (e.g., an inactive state, a paused state, and/or a suspended state) different from the first state, displaying the indicator of the activity of the first type without the first animated effect (in some embodiments, without any animated effect; in some embodiments, with a second animated effect different from the first animated effect). Animating the indicator based on the state of the associated activity of the first type provides improved visual feedback as to the state of the activity.

In some embodiments, the indicator of the activity of the first type (e.g., 628c, 628d), when displayed, is displayed at a first location (e.g., along an upper edge of display 602 and/or a location at which other notification are displayed on display 602) of the one or more display generation components (e.g., a first location on a display). The computer system receives data (e.g., from an external device and/or from an application of the computer system) corresponding to a notification event; and in response to receiving the data corresponding to the notification event, the computer system displays, at the first location, a notification indicator (e.g., and indicator that has an appearance different from the appearance of the indicator of the activity of the first type). In some embodiments, the indicator of the activity of the first type is displayed in a notification region of the computer system that also is used to display notifications. Displaying the indicator at the same location that other notifications are displayed reduces the cognitive burden on the user, provides improved visual feedback as to the nature of the indicator, and also promotes improved user-interaction with the computer system.

In some embodiments, the activity of the first type corresponds to a respective application (e.g., an application that controls and/or generates the activity of the first type) (in some embodiments, an application installed on the computer system; in some embodiments, an application installed on an external computer system that is in communication with the computer system). The computer system detects, via the one or more input devices, a user input (e.g., 624f) (e.g., a tap or a swipe on a touch-sensitive surface or an air gesture) corresponding to (e.g., directed to or on) the indicator of the activity of the first type; and in response to detecting the user input corresponding to the indicator of the activity of the first type: in accordance with a determination that the respective application is available on (e.g., installed on) the computer system, displaying a user interface of the respective application; and in accordance with a determination that the respective application is not available on (e.g., not installed on) the computer system, displaying information corresponding to the activity of the first type without displaying the respective application (e.g., as seen in FIG. 8N) (e.g., an indication that the respective application is not available, information regarding the respective application (e.g., information about the computer system on which the respective application is available), and/or information about how to obtain the respective application).

In some embodiments, the computer system receives data (e.g., from an external device and/or from an application of the computer system) corresponding to an event associated with the activity of the first type (e.g., a change in state of the activity). In some embodiments, the data is received while the representation of the activity of the first type is not displayed. In response to receiving the data corresponding to the event associated with the activity of the first type, the computer system displays a notification corresponding to the activity of the first type (e.g., 628d changing in size in FIGS. 6O-6P or 654j in FIG. 6AQ) (e.g., an alert) (in some embodiments, the notification includes information that is also included in the representation of the activity of the first type). Displaying a notification corresponding to the activity of the first type when data corresponding to an event associated with the activity of the first type provides improved visual feedback as to the occurrence of the event.

In some embodiments, displaying the notification corresponding to the activity of the first type includes: in accordance with a determination that the notification corresponding to the activity of the first type is being displayed concurrently with a respective application user interface (e.g., 636) (in some embodiments, a determination that the respective application user interface is being displayed when the data corresponding to an event associated with the activity of the first type is received), displaying the notification corresponding to the activity of the first type at a first size (e.g., 650b) (e.g., a smaller size); and in accordance with a determination that the notification corresponding to the activity of the first type is being displayed concurrently with a respective user interface (e.g., 612) (in some embodiments, a determination that the respective user interface is being displayed when the data corresponding to an event associated with the activity of the first type is received), wherein the respective user interface is different from the respective application user interface (in some embodiments, the respective user interface includes the first expanded representation of the current time; in some embodiments, the respective user interface is a system user interface), displaying the notification corresponding to the activity of the first type at a second size (e.g., a larger size), that is different from the first size (e.g., 612b1). Displaying the notification at different sizes based on what content is concurrently being displayed optimizes use of display-area-real estate and performs an operation when a set of conditions has been met without requiring further user input that reduces the risk that content relevant to the user is obscured or displaced by the notification.

In some embodiments, the computer system detects, via the one or more input devices, a user input (e.g., 624h) (e.g., a tap or a swipe on a touch-sensitive surface or an air gesture) corresponding to (e.g., directed to or on) the notification corresponding to the activity of the first type. In response to detecting the user input corresponding to the notification corresponding to the activity of the first type, the computer system displays information (e.g., 640 in FIG. 6V) corresponding to the activity of the first type (e.g., a current status of the activity and/or information corresponding to one or more electronic devices associated with the activity) (in some embodiments, the information includes information that is included in the representation of the activity of the first type, optionally along with additional information that was not included in the representation of the activity of the first type).

In some embodiments, detecting the user input corresponding to the notification corresponding to the activity of the first type includes detecting a first portion of a respective input (e.g., an ongoing input) and wherein displaying information corresponding to the activity of the first type includes displaying a first set of information (e.g., 640 in FIG. 6V) corresponding to the activity of the first type. After displaying the first set of information corresponding to the activity of the first type, the computer system detects a second portion of the respective input (e.g., 624i, 626e) (e.g., progression of a swipe input (e.g., on a touch-sensitive surface or an air swipe)). In response to detecting the second portion of the respective input, the computer system displays a second set of information (e.g., 640 in FIG. 6W) corresponding to the activity of the first type that includes information not included in the first set of information corresponding to the activity of the first type. Progressively displaying additional information corresponding to the activity of the first type based on the user interface conserves display-area real-estate when the information is not required while providing the user with additional control options for accessing the information when required.

In some embodiments, after displaying the second set of information (e.g., 650 in FIG. 6W), in accordance with a determination that a characteristic (e.g., a duration, a magnitude of movement, a velocity of movement) of the second portion of the respective input (e.g., 624i, 626e) meets a threshold (e.g., threshold amount of movement, a threshold amount of duration, a threshold velocity), the computer system continues to display at least the second set of information (in some embodiments, and displaying additional information corresponding to the activity of the first type); and in accordance with a determination that the characteristic of the second portion of the respective input does not meet the threshold, the computer system ceases to display the second set of information (in some embodiments, redisplaying the notification corresponding to the activity of the first type in the state in which it was displayed prior to receiving the user input corresponding to the notification corresponding to the activity of the first type). Controlling the display of information based on whether the input meets a threshold provides the user with improved control options for display of the information and performs an operation (e.g., maintaining display of the information) when a set of conditions has been met without requiring further user input (e.g., without requiring continuing the input) enhances the operability of the computer system.

In some embodiments, the notification corresponding to the activity of the first type has a visual appearance that is the same as the visual appearance of the representation of the activity of the first type (e.g., compare 612b1 and 630 of FIG. 6N) (in some embodiments, includes the same information that is included in the representation of the activity of the first type). In some embodiments, the notification corresponding to the activity of the first type is a part of a plurality of user-selectable graphical user interface objects (e.g., a plurality of widgets) (in some embodiments, widgets that display information from one or more applications). In some embodiments, the notification corresponding to the activity of the first type is displayed without displaying it as a part of a plurality of user-selectable graphical user interface objects. Displaying the notification with the same visual appearance as the representation of the activity of the first type reduces the cognitive burden on the user for associating both with the same activity and also provides improved visual feedback as to the common association.

In some embodiments, the notification corresponding to the activity of the first type (e.g., notification in FIG. 6U) is displayed at a location of the one or more display generation components that is a same location of the one or more display generation components at which the representation of the activity of the first type (e.g., location of 612b1 in FIG. 6C) is displayed, when the representation of the activity of the first type is displayed. Displaying the notification at the same location at which the representation of the activity of the first type would be displayed reduces the cognitive burden on the user for associating both with the same activity and also provides improved visual feedback as to the common association.

In some embodiments, the computer system detects that a first activity of the first type (e.g., a time-based activity, an activity with constant, periodic, and/or frequent updates, a task, a live event, an external event, an internal event, a user-initiated action, an action with updates at a predetermined frequency, an action with updates at regular intervals, and/or an action with updates at irregular intervals) has been initiated (e.g., initiated at an external electronic device that is in communication with the computer system). In response to detecting that the first activity of the first type has been initiated and in accordance with a determination that a first set of criteria is met (in some embodiments, the first set of criteria includes a criterion is met when a first user-selectable option is selected), the computer system displays a representation of the first activity of the first type (e.g., 612b1) (in some embodiments, that is the same as the representation of the activity of the first type) as part of a second plurality of user-selectable graphical user interface objects (e.g., 612b) (e.g., a plurality of widgets) (in some embodiments, widgets that display information from one or more applications) that are arranged in an order, wherein the first representation of the first activity of the first type is displayed at a predetermined position (e.g., at a front and/or top position within the order) within the order (e.g., at the front/top as seen in FIG. 6C). In some embodiments, in response to detecting that the activity of the first type has been initiated and in accordance with a determination that the first set of criteria are not met, forgoing displaying the first representation of the activity of the first type. In some embodiments, also continuing to display an existing user interface (e.g., a time user interface, without displaying the second plurality of user-selectable graphical user interface objects or displaying the second plurality of user-selectable graphical user interface objects with a representation of information that does not correspond to an activity of a first type (e.g., calendar information, previous workout information, and/or weather information)). Displaying the representation of the first activity of the first type at predetermined position within the order of the second plurality of user-selectable objects provides improved visual feedback as to the nature of the representation and promotes further user-interaction with the representation and the computer system.

In some embodiments, the first set of criteria includes a criterion that is met when a first user-selectable option (e.g., 646a) is currently selected (e.g., enabled and/or set) and wherein the first activity of the first type corresponds to a first respective application (e.g., is generated and/or managed by the first respective application). The computer system detects that a second activity of the first type has been initiated, wherein the second activity of the first type corresponds to a second respective application (e.g., the drive application as seen in FIG. 6Z) different from the first respective application; and in response to detecting that the second activity of the first type has been initiated: in accordance with a determination that a second set of criteria is met, wherein the second set of criteria includes a criterion that is met when the first user-selectable option is currently selected, displaying a representation of the second activity of the first type (e.g., 640) (in some embodiments, as part of a plurality of user-selectable graphical user interface objects). In some embodiments, the same first user-selectable option affects whether a representation is displayed when an activity is started for multiple different applications (in some embodiments, for all such applications) and in accordance with a determination that the second set of criteria are not met, forgoing displaying the representation of the second activity of the first type (e.g., maintaining display of content that was being displayed when the computer system detected that the second activity of the first type was initiated). In some embodiments, the method further includes detecting that a third activity of the first type has been initiated (e.g., after detecting that the second activity of the first type has been initiated), wherein the third activity of the first type corresponds to a third respective application different from the second respective application (e.g., and different from the first respective application); and in response to detecting that the third activity of the first type has been initiated: in accordance with a determination that the second set of criteria is met, wherein the second set of criteria includes a criterion that is met when the first user-selectable option is currently selected, displaying a representation of the third activity of the first type (in some embodiments, as part of a plurality of user-selectable graphical user interface objects) (in some embodiments, the same first user-selectable option affects whether a representation is displayed when an activity is started for multiple different applications (in some embodiments, for all such applications)); in accordance with a determination that the second set of criteria are not met, forgoing displaying the representation of the third activity of the first type (e.g., maintaining display of content that was being displayed when the computer system detected that the third activity of the first type was initiated). Displaying the representation of the second activity of the first type at predetermined position within the order of the second plurality of user-selectable objects based on whether the first user-selectable option is currently selected allows control over whether an operation is performed automatically when a set of conditions are met, without requiring additional user input.

In some embodiments, the first set of criteria includes a criterion that is met when a first user-selectable option (e.g., 646c3) is currently selected (e.g., enabled and/or set) and wherein the activity of the first type corresponds to a first respective application (e.g., is generated and/or managed by the first respective application). The computer system detects that a second activity of the first type has been initiated, wherein the second activity of the first type corresponds to a second respective application (e.g., the maps application as seen in FIG. 6Z) different from the first respective application (e.g., the drive application seen in FIG. 6Z); and in response to detecting that the second activity of the first type has been initiated: in accordance with a determination that a second set of criteria is met, wherein the second set of criteria includes a criterion that is met when a second user-selectable option (e.g., 646c1) is currently selected, displaying a representation of the second activity of the first type (in some embodiments, as part of a plurality of user-selectable graphical user interface objects), wherein the second user-selectable option is different from the first user-selectable option; and in accordance with a determination that the second set of criteria are not met, forgoing displaying the representation of the second activity of the first type (in some embodiments, as part of a plurality of user-selectable graphical user interface objects) (e.g., maintaining display of content that was being displayed when the computer system detected that the second activity of the first type was initiated). In some embodiments, separate applications correspond to separate (e.g., individual) options that control whether a representation is displayed when an activity is started for the respective application. In some embodiments, the method further includes detecting that a third activity of the first type has been initiated (e.g., after detecting that the second activity of the first type has been initiated), wherein the third activity of the first type corresponds to a third respective application different from the second respective application (e.g., and different from the first respective application); and in response to detecting that the third activity of the first type has been initiated: in accordance with a determination that a third set of criteria is met, wherein the third set of criteria includes a criterion that is met when a third user-selectable option is currently selected, displaying a representation of the third activity of the first type, wherein the third user-selectable option is different from the second user-selectable option; and in accordance with a determination that the third set of criteria are not met, forgoing displaying the representation of the third activity of the first type (e.g., maintaining display of content that was being displayed when the computer system detected that the third activity of the first type was initiated). Displaying the representation of the third activity of the first type at predetermined position within the order of the second plurality of user-selectable objects based on whether the third user-selectable option is currently selected automatically performs an operation when a set of conditions are met without requiring further user input and provides the user with precise control over whether an operation is performed automatically when a set of conditions are met for a specific application, without requiring additional user input.

In some embodiments, the computer system detects that a fourth activity of the first type has been initiated (e.g., initiated at an external electronic device that is in communication with the computer system) (e.g., as seen FIG. 6R). In response to detecting that the fourth activity of the first type has been initiated: the computer system displays a representation of the fourth activity of the first type (e.g., 634a) (in some embodiments, that is the same as the representation of the activity of the first type); and In some embodiments, the representation is displayed as part of a second plurality of user-selectable graphical user interface objects (e.g., a plurality of widgets) (in some embodiments, widgets that display information from one or more applications) that are arranged in an order. in accordance with a determination that a set of option display criteria is met (in some embodiments, the set of option display criteria includes a criterion that is met when the representation of the fourth activity of the first type is displayed for first time (e.g., when any representation of activity of the first type is displayed for the first time)), displaying an options user interface (e.g., 634) (e.g., a user interface that occupies a portion of the one or more display generation components) that includes one or more of: a first user-selectable interface object (e.g., 643b) that, when selected, configures the computer system to display representations of activity of the first type for subsequently initiated activity of the first type; and a second user selectable interface object (e.g., 634c) that, when selected, configures the computer to suppress (e.g., prevent) display of representations of activity of the first type for subsequently initiated activity of the first type; and in accordance with a determination that the set of option display criteria are not met, forgoing displaying the options user interface (e.g., maintaining display of the representation of the fourth activity of the first type without providing the options user interface). Conditionally displaying an options user interface when a set of option display criteria is met provides additional control options without cluttering the UI with additional displayed controls, and performs an operation when a set of conditions has been met without requiring further user input.

In some embodiments, the activity of the first type is selected from the group consisting of: a timer activity (e.g., 612b1), an alarm activity, a stopwatch activity, a media-playback activity, a media recommendation activity, a physical-activity-tracking activity (e.g., fitness and/or workout activity), a navigation (e.g., a map and/or compass) activity, a phone-call activity, a voice-memorandum activity, a sporting-event-tracking activity, a reservation (e.g., a flight, movie, or restaurant reservation and/or check-in activity) activity, a third-party application (e.g., an application developed and/or provided by a party other than the developer and/or provider of the operating system of the computer system) activity, and a combination thereof.

Note that details of the processes described above with respect to method 700 (e.g., FIG. 7) are also applicable in an analogous manner to the methods described below. For example, the representation of the activity of the first type of method 700 can be included in a set of widgets managed according to method 1100. In another example, the representation of the activity of the first type of method 700 can be synchronized across devices per method 900. For brevity, these details are not repeated below.

FIGS. 8A-8S illustrate exemplary user interfaces for monitoring an ongoing activity via multiple devices, in accordance with some embodiments. The user interfaces in these figures are used to illustrate the processes described below, including the processes in FIG. 9.

FIG. 8A illustrates a set of 3 devices: device 600 (e.g., a smart watch), device 800a (e.g., a smart phone), and device 800b (e.g., a tablet computer). In the embodiment of FIGS. 8A-8S, all three devices are associated with the same user (e.g., the same user account is logged on to all three devices) and are in communication with each other (e.g., directly and/or through one or more servers). Device 600 is as described above (e.g., as described with reference to FIGS. 6A-6AQ). Device 800a includes display 802a (e.g., a touch-sensitive display). In some embodiments, device 800a includes one or more features of device 100, 300, and/or 500. Device 800b includes display 802b (e.g., a touch-sensitive display). In some embodiments, device 800a includes one or more features of device 100, 300, and/or 500.

At FIG. 8A, device 600 displays, on display 602, user interface 622 that is a wake screen that includes reduced-size digital clock face 622a, widget stack 612b, and day-and-date indication 612c. Widget stack 612b includes widget 612b1 that corresponds to an ongoing timer activity that is currently in progress. Widget 612b1 shows that 15 minutes and 30 seconds remain in the currently active timer. Device 800a displays, on display 802a, user interface 804a that is a wake screen user interface. User interface 804a includes widget 806a that corresponds to the same ongoing timer activity as widget 612b1 of device 600. Accordingly, widget 806a also shows the timer with 19 minutes and 50 seconds remaining. Device 800b displays, on display 802b, user interface 804b that is also a wake screen user interface. User interface 804b includes widget 806b that corresponds to the same ongoing timer activity as widget 612b1 of device 600 and widget 806a of device 800a. In some embodiments, the ongoing timer activity was started on device 600 and is managed by a timer application installed on device 600. In some embodiments, the ongoing timer activity was started on device 800a and is managed by a timer application installed on device 800a. In some embodiments, the ongoing timer activity was started on device 800b and is managed by a timer application installed on device 800b. Thus, FIG. 8A depicts an ongoing activity that is in progress being synchronized across a set of devices. In some embodiments the set of devices includes more or less devices than depicted in FIG. 8A (e.g., the set of devices also includes a desktop computer, a laptop computer, a digital media player, and/or a head-mounted display device). In some embodiments, the ongoing activity is ongoing activity other than a timer, such as one of the ongoing activities depicted in FIGS. 6AB-6AQ.

FIG. 8B depicts the same set of devices as FIG. 8A, after a period of time (24 seconds) has passed. Widgets 612b1, 800a, and 800b all reflect the new value for the synchronized ongoing timer activity that has 15 minutes and 6 seconds remaining. At FIG. 8B, device 600 detects input 808a and/or input 810a. Input 808a is a downward swipe on display 602. Input 810a is a press of rotatable and depressible input mechanism 604. In some embodiments, input 624a and/or input 626a is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 8C, in response to input 808a and/or input 810a, device 600 displays user interface 628, which includes analog clock hands 628a and dial 628b, with both at a size that occupies a majority of display 602. At FIG. 8C, user interface 628 includes affordance 628c (e.g., as described with respect to FIG. 6M) that indicates that the ongoing timer activity remains in progress. Device 800a continues to display widget 806a and device 800b continues to display widget 806b. At FIG. 8C, device 600 detects input 808b, which is a tap on affordance 628c. In some embodiments, input 808b is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 8D, in response to input 808b, device 600 displays user interface 630 which is an interface of a timer application that is maintaining the ongoing timer activity (e.g., the timer activity corresponding to widget 612b1). User interface 630 includes timer control affordances 630a1, 630a2, and 630a3 for adding an additional timer, cancelling the current timer, and pausing the current timer, respectively. At FIG. 8D, the set of devices detects one or more of input 808c, input 808d, and/or input 808e, which are inputs for pausing the ongoing timer activity by selecting pause affordance 630a3, pause affordance 806a1, or pause affordance 806b1, respectively. Device 600 also detects input 810b, which is a press of rotatable and depressible input mechanism 604. In some embodiments, inputs 808c, 808d, 808e, and/or 810b is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 8E, in response to input 810b, device 600 displays user interface 622 with widget stack 612b that includes widget 612b1. At FIG. 8E, in response to any one of inputs 808c, 808d, and/or 808e, the timer of the timer ongoing activity has been paused, because the timer ongoing activity is synchronized across the set of devices. Because the timer has been paused, pause affordance 806a1 and pause affordance 806b1 have been replaced by resume affordance 806a2 and resume affordance 806b2, respectively. Similarly, widget 612b1 on device 600 now includes resume affordance 612b1b. At FIG. 8E, device 600 detects input 808f, which is a swipe (e.g., swipe that moves less than a certain distance) on widget 612b1. In some embodiments, input 808f is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 8F, in response to input 808f, device 600 displays remove affordance 612b1c of widget 612b1, which is an affordance for removing (e.g., clearing) widget 612b1 from widget stack 612b. Devices 800a and 800b remain in the same state as shown in FIG. 8E. At FIG. 8F, device 600 detects input 808g, which is a tap input on a portion of the display outside of widget 612b1 (e.g., the tap is on day-and-date indication 612c). In response to input 808g, device 600 ceases to display remove affordance 612b1c and returns widget 612b1 to the appearance shown in FIG. 8E. At FIG. 8F, device 600 detects input 808h, which is a tap on remove affordance 612b1c. In some embodiments, input 808g and/or input 808h is another type of touch input (e.g., a swipe, a double tap, or a two-finger swipe), a hardware input (e.g., a button press, rotatable input mechanism rotation, and/or mouse movement), an air gesture, and/or a gaze-based input. In some embodiments, input 808h is a swipe on widget 612b1 as shown in FIG. 8E that moves further than swipe 808f.

At FIG. 8G, in response to input 808h, device 600 displays notification interface 812 that notifies the user that, even if the selected widget (e.g., widget 612b1) is removed (e.g., cleared), it may still be suggested for inclusion in widget stack 612b and that this behavior can be modified in a settings menu (e.g., as shown in FIGS. 6Y-6AB). Notification interface 812 also includes dismissal affordance 812a for dismissing notification interface 812 and remove affordance 812b for removing widget 612b1 from widget stack 612b. In some embodiments, notification interface 812 is only displayed on selection of remove affordance 612b1c when a user first attempts (e.g., after using device 600 and/or after an operating system of device 600 is updated) to remove a widget from widget stack 612b. At FIG. 8G, device 600 detects input 808i, which is a tap on dismissal affordance 812a and, in response, redisplays user interface 622 as shown in FIG. 8E. At FIG. 8G, device 600 detects input 808j, which is a tap on remove affordance 812b. At FIG. 8G, device 800a detects input 808k, which is a tap on widget 806a. At FIG. 8G, device 800b detects input 808l, which is a tap on widget 806b. In some embodiments, input 808i, 808j, 808k, and/or input 808l is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 8H, in response to input 808j, which was a tap on remove affordance 812b, device 600 displays user interface 622, after removing widget 612b1 from widget stack 612b. Because widget 612b1 has been removed, widget 612b6 (e.g., a widget of a daily physical activity tracking application) is now in the top position of widget stack 612b. Also, in response to input 808j, device 800a ceases to display widget 806a and device 800b ceases to display widget 806b. In some embodiments, if remove affordance 612b1c of FIG. 8F is selected after having previously cleared one or more other widgets (e.g., this is not the first time a widget is being removed), that selected would cause the same result as input 808j (e.g., removal of widget 612b1 from widget stack 612b). Note that while widget 612b1 has been removed, the timer ongoing activity continues to operate, as shown in FIG. 8I, discussed below.

At FIG. 8I, in response to input 808i (see FIG. 8G), device 600 displays user interface 622 with widget 612b1 showing the paused ongoing timer activity with 15 minutes and 6 seconds remaining and paused. In response to input 808k (see FIG. 8G), device 800a displays timer application user interface 814a that includes timer region 814a1 that corresponds to the currently paused timer of widget 612b1, as well as recent timers region 814a2 that includes a plurality of previously created timers that are currently not in progress. In response to input 808l (see FIG. 8G), device 800b displays timer application user interface 814b that includes indication 814b1 that corresponds to the currently-paused timer of widget 612b1. Timer application user interface 814b also includes various controls for accessing other time-related functions. At FIG. 8I, device 800a detects input 808m, which is an upwards swipe on bar 816a (e.g., a swipe near the bottom edge of display 802a). Similarly, device 800b detects input 808n, which is an upwards swipe on bar 816b (e.g., a swipe near the bottom edge of display 802a). In some embodiments, input 808m and/or input 808n is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 8J, in response to input 808m, device 800a re-displays wake screen user interface 804a. User interface 804a now includes dynamic notification region 804a1 that includes information corresponding to the currently-paused ongoing timer activity that corresponds to widget 612b1. Dynamic notification region 804a1 indicates that the currently-paused timer has 15 minutes and 6 seconds remaining. At FIG. 8J, in response to input 808n, device 800b re-displays wake screen user interface 804b. User interface 804b now includes dynamic notification region 804b1 that includes information corresponding to the currently-paused ongoing timer activity that corresponds to widget 612b1. Dynamic notification region 804b1 indicates that the currently-paused timer has 15 minutes and 6 seconds remaining. FIG. 8J illustrates that a wake screen can be displayed with information about an ongoing activity available in a dynamic notification region, even after a widget corresponding to the activity has been removed/dismissed.

At FIG. 8K, device 600 displays application user interface 636, which is a user interface for a daily physical activity tracking application that is locally-installed on device 600, as previously described with reference to FIG. 6U-6X. At FIG. 8K, widget 640 is overlaid on user interface 636. Widget 640 corresponds to an ongoing ridesharing activity that is in progress. At FIG. 8K, device 600 detects input 8080, which is tap on widget 640. In some embodiments, input 8080 is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 8L, device 600 displays wake screen user interface 628 (e.g., as previously shown in FIG. 6P) that includes affordance 628d that corresponds the ongoing ridesharing activity that is in progress. In some embodiments, wake screen user interface 628 of FIG. 8L is displayed in response to a downwards swipe on widget stack 612b while the stack includes a widget corresponding to the ongoing ridesharing activity that is in progress (e.g., in a manner similar to that discussed for FIGS. 6H, 6I, and 6P). At FIG. 8L, device 600 detects input 808p, which is tap on affordance 628d. In some embodiments, input 808p is another type of touch input (e.g., a swipe, a double tap, or a two-finger swipe), a hardware input (e.g., a button press, rotatable input mechanism rotation, and/or mouse movement), an air gesture, and/or a gaze-based input.

FIG. 8M illustrates one embodiment of device 600 responding to input 8080 and/or input 808p. At FIG. 8K, device 600 displays user interface 818, which provides additional information regarding the ongoing ridesharing activity that is in progress. In some embodiments, interface 818 is an application user interface of a ridesharing application installed on device 600. In some embodiments, user interface 818 is generated by the operating system of device 600, because the ridesharing application that corresponds to affordance 628d is not installed on device 600 (e.g., the application is installed on device 800a, and/or 800b).

FIG. 8N illustrates another embodiment of device 600 responding to input 8080 and/or input 808p. At FIG. 8N, device 600 displays user interface 820 which provides additional information regarding the ongoing ridesharing activity that is in progress. User interface 820 is generated by the operating system of device 600, because the ridesharing application that corresponds to affordance 628d is not installed on device 600 (e.g., the application is installed on device 800a, and/or 800b). User interface 820 includes affordance 820a for dismissing the user interface when selected (e.g., in response to detecting input 808q) and returning to user interface 622 (e.g., with a widget for the ongoing ridesharing activity that is in progress in widget stack 612b). User interface 820 also includes affordance 820b for opening the ridesharing application on device 800a. At FIG. 8N, device 600 detects input 808q, which is a tap on affordance 820a. In response to input 808q, device 800a dismisses user interface 820 (in some embodiments, redisplaying user interface 628). At FIG. 8N, device 600 detects input 808r, which is a tap on affordance 820b. In some embodiments, in response to input 808r, device 800a opens (e.g., device 600 causes device 800a to open) a ridesharing application that corresponds to the ongoing ridesharing activity and that is installed on device 800a. In some embodiments, input 808q and/or input 808r is another type of touch input (e.g., a swipe, a double tap, or a two-finger swipe), a hardware input (e.g., a button press, rotatable input mechanism rotation, and/or mouse movement), an air gesture, and/or a gaze-based input.

FIG. 8O shows the set of devices displaying widgets corresponding to the ongoing ridesharing activity that is in progress. Device 600 displays user interface 622 with widget 822 that includes information about the ongoing ridesharing activity in widget stack 612b. Device 800a displays user interface 804a with widget 822a that includes information about the ongoing ridesharing activity. Device 800b displays user interface 804b with widget 822b that includes information about the ongoing ridesharing activity. Device 800a detects input 808s that is a swipe on widget 822a. Device 800b detects input 808t that is a swipe on widget 822b.

At FIG. 8P, in response to input 808s, device 800a displays widget 822a with remove affordance 822a1 for removing (e.g., clearing) widget 822a. At FIG. 8P, in response to input 808t, device 800b displays widget 822b with remove affordance 822b1 for removing widget 822b. At FIG. 8P, device 800a detects user input 808u, which is a tap on a part of display 802a outside of widget 822a. In response to input 808u, device 800a displays user interface 804a in the state shown in FIG. 8O. At FIG. 8P, device 800b detects user input 808w, which is a tap on a part of display 802b outside of widget 822a. In response to input 808w, device 800b displays user interface 804b in the state shown in FIG. 8O. At FIG. 8P, device 800a detects user input 808v, which is a tap on remove affordance 822a1. In response to input 808v, device 800a displays user interface 804a in the state shown in FIG. 8H (e.g., widget 822a is removed and/or cleared). At FIG. 8P, device 800b detects user input 808x, which is a tap on remove affordance 822a1. In response to input 808x, device 800b displays user interface 804b in the state shown in FIG. 8H (e.g., widget 822b is removed). In some embodiments, in response to input 808v and/or input 808x, device 600 ceases to display widget 822 in widget stack 612b because the widgets are synchronized across the set of devices.

FIG. 8Q illustrates widgets corresponding to the ongoing ridesharing activity that is in progress being redisplayed due to an update to ongoing ridesharing activity (e.g., the rideshare having arrived), after the widgets were dismissed in response to input 808v and/or input 808x. At FIG. 8Q, device 600 redisplays widget 822 in widgets stack 612b with an indication that the rideshare car has arrived. Similarly, device 800a redisplays widget 822a on user interface 804a with the “arrived” information. Device 800a similarly redisplays widget 822b on user interface 804b with the “arrived” information.

At FIG. 8R, device 800a displays ongoing activity settings user interface 824 (e.g., an interface analogous to user interface 646 of FIG. 6AA). User interface 824 includes various options for controlling the behavior of ongoing activity widgets on device 600, including affordance 824a for modifying whether ongoing activity widgets are displayed in the widget stack (e.g., widget stack 612b), affordance 824b for modifying whether the widget stack is displayed when an ongoing activity starts, and affordance region 824c for modifying whether specific ongoing activities are allowed or not allowed in the widget stack. At FIG. 8R, device 800a detects input 808y, which is a tap on affordance 824d that corresponds to the ridesharing ongoing activity type. In some embodiments, input 808y is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 8S, device 800a displays drive ongoing activity setting user interface 826 (e.g., an interface analogous to user interface 648 of FIG. 6AB). User interface 826 includes affordance 826a that controls whether the ridesharing ongoing active type, when started on device 800a, is synchronized to other devices (e.g., device 600 and/or device 800b). In some embodiments, if affordance 826a is toggled off, updates to the ridesharing ongoing active type are only displayed on device 800a but are not shown on devices 600 and/or 800b.

FIG. 9 is a flow illustrating a method for synchronizing a state of an ongoing activity across multiple computer systems, in accordance with some embodiments. Method 900 is performed at a computer system (e.g., 100, 300, 500, 600, 800a, and/or 800b) (e.g., a smartwatch, a smartphone, a tablet computer, a laptop computer, and/or a desktop computer) that is in communication with one or more display generation components (e.g., a display controller, a display, a touch-sensitive display system, a touchscreen, a head-mounted display, and/or a monitor). Some operations in method 900 are, optionally, combined, the orders of some operations are, optionally, changed, and some operations are, optionally, omitted.

As described below, method 900 provides an intuitive way for synchronizing a state of an ongoing activity across multiple computer systems. The method reduces the cognitive burden on a user for synchronizing a state of an ongoing activity across multiple computer systems, thereby creating a more efficient human-machine interface. For battery-operated computing devices, enabling a user to synchronize a state of an ongoing activity across multiple computer systems faster and more efficiently conserves power and increases the time between battery charges.

The computer system (e.g., 600, 800a, 800b) receives (902) a request to wake the computer system (e.g., from a less active state to a more active state; in some embodiments, the one or more display generation components are inactive while in the less active state). In some embodiments, the one or more display generation components are in a lower power and/or lower brightness state in the less active state and transitions to a higher power and/or higher brightness state when the computer system wakes to the more active state.

In response to receiving the request to wake the computer system, the computer system concurrently displays (904), via the one or more display generation components, a first user interface (e.g., 612b1, 806a, 806b) for first software (e.g., an operating system or a first application) and a second user interface for second software (e.g., 602 or the home screen interfaces of 800a and 800b, as shown in FIG. 8A) (e.g., a second application or an operating system). The first software is different from the second software. In some embodiments, the first software is an operating system and the second software is an application. In some embodiments, the first software is a first application and the second software is a second application that is different from the first application. In some embodiments, the first software is an application and the second software is an operating system. The first user interface represents an ongoing activity (e.g., the active timer represented by 612b1, 806a, 806b) (e.g., a time-based activity, an activity with constant, periodic, and/or frequent updates, a task, a live event, an external event, an internal event, a user-initiated action, an action with updates at a predetermined frequency, an action with updates at regular intervals, and/or an action with updates at irregular intervals). In some embodiments, the second user interface does not represent an ongoing activity (e.g., is associated with a suspended or inactive application). In some embodiments, an ongoing activity is an activity of a first type, as described with reference to FIGS. 6A-AR.

While concurrently displaying the first user interface for first software and the second user interface for second software, the computer system updates (906) a state (e.g., a status, a representation, and/or an appearance) of the first user interface based on a change in the ongoing activity, wherein one or more remote devices (e.g., 800a and/or 800b when the computer system is 600) that are different from the computer system are concurrently displaying a corresponding user interface that represents the ongoing activity (e.g., 806a, 806b), including: at a first remote device (e.g., 806a, 806b) (e.g., a smartwatch, a smartphone, a tablet computer, a laptop computer, and/or a desktop computer) (e.g., 800a, 800b), concurrently displaying (908) a first remote-device user interface (e.g., 806a, 806b) for first remote-device software (e.g., an operating system or a first application) for the first remote device and second remote-device user interface (e.g., the home screen interfaces of 800a and 800b, as shown in FIG. 8A) for second remote-device software for the first remote device (e.g., a second application or an operating system). The first remote-device software is different from the second remote-device software. In some embodiments, the first remote-device software is an operating system for the first remote device and the second remote-device software is an application. In some embodiments, the first software is a first remote-device application and the second remote-device software is a second remote-device application that is different from the first remote-device application. In some embodiments, the first remote-device software is an application and the second remote-device software is an operating system for the first remote device. The state of the first remote-device user interface is also updated based on the change in the ongoing activity. Updating the states of both a first user interface and a first remote-device user interface based on changes of the same ongoing activity allows both interfaces to reflect the ongoing activity without requiring further user input and also provides improved visual feedback as to ongoing activity. Moreover, displaying the interfaces that are updated based on the ongoing activity together with separate interfaces on the respective devices provides user(s) the ability to view the states of multiple different types of software, simultaneously, which provides improved visual feedback.

In some embodiments, the second software is an operating system of the computer system. In some embodiments, the second software is first party software (e.g., software that is provided by and/or developed by the provider of the operating system and/or the hardware of the computer system).

In some embodiments, the second software is an application installed on the computer system (e.g., that is separate from an operating system or other system software on the computer system) and wherein the second user interface is an application user interface of the application installed on the computer system (e.g., 636). In some embodiments, the second software is first party software. In some embodiments, the second software is third party software (e.g., that is not provided by and/or developed by the provider of the operating system and/or the hardware of the computer system).

In some embodiments, the ongoing activity is an activity maintained by the first remote-device software (e.g., the ongoing activity is a process of the first remote-device software and/or is controlled the first remote-device software) (e.g., the first remote-device software is the drive application installed on 800a). In some embodiments, the computer system detects (e.g., via an input device of the computer system) an input (e.g., 8080) (e.g., a selection input such as a tap, double tap, swipe, mouse click, key press, and/or air gesture) corresponding to (e.g., directed to or on) the first user interface; and in response to detecting the input (e.g., the selection input) corresponding to the first user interface, the computer system displays information received from the first remote-device software of the first remote device (e.g., information shown in 818 at FIG. 8M). Displaying information received from software of a remote device in response to an input at the computer system provides the user with the ability to retrieve remote information without having to directly access the remote device and also provides improved visual feedback as to the state of software on the remote device. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the computer system displays, via the one or more display generation components, a visual indicator (e.g., 625d) corresponding to the ongoing activity (e.g., a notification icon and/or text) (in some embodiments, an indicator that is distinct from the first user interface) (in some embodiments, the visual indicator is the first user interface). The computer system detects (e.g., via an input device of the computer system) an input (e.g., 808p) (e.g., a tap, double tap, swipe, mouse click, key press, and/or air gesture) corresponding to (e.g., directed to or on) the visual indicator. In response to detecting the input corresponding to the visual indicator and in accordance with a determination that the ongoing activity is an activity that is associated with (e.g., is maintained by or originates from) a local application (e.g., an application installed on the computer system) of the computer system (e.g., the ongoing activity is a process of an application of the computer system and/or is controlled by an application of the computer system), the computer system displays, via the one or more display generation components, an application user interface of the local application (in some embodiments, the application user interface includes information regarding the ongoing activity and/or one or more controls for controlling the ongoing activity). In response to detecting the input corresponding to the visual indicator and in accordance with a determination that the ongoing activity is an activity that is associated with (e.g., is maintained by or originates from) an application of the remote device, the computer system displays a prompt to access the remote device (e.g., 820b) (e.g., a prompt to access the remote device for further information regarding the ongoing activity (e.g., “open application on remote device”)). Conditionally displaying an application user interface or a prompt to access a remote device in response to selecting a visual indicator of an ongoing activity based on whether the activity corresponds to a local application control that is displayed when a set of conditions are met, without requiring further input and provides improved visual feedback as to whether the activity is local or remote.

In some embodiments, the prompt to access the remote device includes first information (e.g., status information for the activity, info regarding the application and/or the remote device) regarding the ongoing activity (e.g., includes some or all of the information shown in 820 of FIG. 8N). In some embodiments, the first information is not included in the visual indicator. In some embodiments, the first information is received from the remote device (e.g., from the first remote-device software). Displaying information regarding the ongoing activity on selection of the indicator provides the user with improved visual feedback as to the state of the ongoing activity.

In some embodiments, displaying the prompt to access the remote device includes: prior to displaying the prompt to access the remote device, displaying a plurality of user-selectable graphical user interface objects (e.g., 620b) (in some embodiments, a stack of widgets that are arranged in sequence) that includes a first user-selectable graphical user interface object (e.g., 640) that corresponds to the ongoing activity (e.g., a widget for the ongoing activity) and a second user-selectable graphical object that corresponds to third software (e.g., 612b1, 612b2, 612b3), different from the first software (e.g., a widget for an application that does not correspond to the ongoing activity). In some embodiments, the plurality of user-selectable graphical user interface objects is displayed for a predetermined period of time (e.g., 1 second, 2 second, or 5 seconds) before displaying the prompt to access the remote device. In some embodiments, displaying the application user interface of the local application occurs without displaying the plurality of user-selectable graphical user interface objects first. Displaying the plurality of user-selectable graphical user interface objects prior to displaying the prompt to access the remote device provides the user with improved visual feedback as to various activities and/or applications, separate from the ongoing activity.

In some embodiments, the computer system displays, via the one or more display generation components, a visual indicator (e.g., 612b1, 628c) corresponding to the ongoing activity (e.g., a notification icon and/or text) (in some embodiments, an indicator that is distinct from the first user interface) (in some embodiments, the visual indicator is the first user interface). The computer system detects (e.g., via an input device of the computer system) an input (e.g., 808b) (e.g., a tap, double tap, swipe, mouse click, key press, and/or air gesture) corresponding to the visual indicator. In response to detecting the input corresponding to the visual indicator and in accordance with a determination that the ongoing activity is an activity maintained by a local application (e.g., an application installed on the computer system) of the computer system (e.g., the ongoing activity is a process of an application of the computer system and/or is controlled by an application of the computer system), the computer system displays, via the one or more display generation components, an application user interface (e.g., 630) of the local application. In response to detecting the input corresponding to the visual indicator and in accordance with a determination that the ongoing activity is an activity maintained by an application of the remote device, displaying first information (e.g., information in 820 of FIG. 8N) (e.g., status information for the activity, info regarding the application and/or the remote device) regarding the ongoing activity without displaying an application user interface of a corresponding application (e.g., without displaying an application user interface of the application of the remote device that maintains the ongoing activity). In some embodiments, the first information is not included in the visual indicator. In some embodiments, the first information is received from the remote device (e.g., from the first remote-device software). Conditionally displaying an application user interface or first information regarding the ongoing activity based on whether the activity corresponds to a local application control that is displayed when a set of conditions are met, without requiring further input and provides improved visual feedback as to whether the activity is local or remote.

In some embodiments, the one or more remote devices includes a second remote device (e.g., 800b), different from the computer system and the first remote device; and a state of a third remote-device user interface (e.g., 806b) of the second remote device is also updated based on the change in the ongoing activity. In some embodiments, when a change in the ongoing activity occurs, all devices that are associated with a user account that is common to all of the devices (e.g., the account is logged on at all the devices) are updated to reflect the change. Updating multiple devices based on a change in an ongoing activity provides for improved device synchronization which provides improved (e.g., more accurate) feedback as to the state of the ongoing activity, without the user having to access any singular device, which reduces the risk that the user will not be made aware of the change.

In some embodiments, the computer system detects dismissal (e.g., termination and/or completion) of the ongoing activity (e.g., in response to input 808v and/or 808x) (in some embodiments, the dismissal occurs in response to a user input at the computer system; in some embodiments, the dismissal is caused by input at a remote device of the one or more remote devices); and in response to detecting the dismissal of the ongoing activity, indicating that the ongoing activity has been dismissed (in some embodiments, ceasing to display the first user interface; in some embodiments, displaying an indication that the activity has been dismissed), wherein the remote device also indicates that the ongoing activity has been dismissed (e.g., as discussed with reference to FIG. 8P). In some embodiments, when the ongoing activity is dismissed, one or more other devices (e.g., one other device, multiple other devices, or all other devices) that are associated with a user account that is common to the computer system and the one or more other the devices (e.g., the account is logged on at the computer system and all of the one or more devices) are updated to indicate that the ongoing activity has been dismissed. Indicating on multiple devices that the ongoing activity has been dismissed provides for improved device synchronization which provides improved (e.g., more accurate) feedback as to the dismissal of the ongoing activity, without the user having to access any singular device, which reduces the risk that the user will not be made aware of the change. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, detecting dismissal of the ongoing activity includes detecting (e.g., via one or more input devices in communication with the computer system) a set of one or more inputs corresponding to (e.g., directed to or on) the first user interface (e.g., 808s, 808t, 808v, 808x) (e.g., a movement input such as a swipe directed to or on the first user interface (in some embodiments, a swipe followed by confirmation via a subsequent input directed to or on a confirmation user interface element)).

In some embodiments, the ongoing activity is an activity maintained by a first local application (e.g., an application installed on the computer system) of the computer system. After updating the state of the first user interface based on the change in the ongoing activity, the computer system detects a second change in the state of the ongoing activity. In response to detecting the second change in the state of the ongoing activity and in accordance with a determination that a user-configurable setting (e.g., 826a toggled on in FIG. 8S) (e.g., a setting that can be changed/toggled in a settings user interface of the computer system) has a first setting (e.g., a setting enabling multi-device-synchronization for the ongoing activity), the computer system updates the state of the first user interface based on the second change in the state of the ongoing activity and causing the first remote device to update the state of the first remote-device user interface based on the second change in the ongoing activity. In some embodiments, synchronization between devices can be selected on a device-by-device basis or as a set for all relevant devices. In response to detecting the change in the state of the ongoing activity and in accordance with a determination that a user-configurable setting has a second setting (e.g., 826a toggled off), the computer system updates the state of the first user interface based on the second change in the state of the ongoing activity without causing the first remote device to update the state of the first remote-device user interface based on the second change in the ongoing activity. In some embodiments, the user can enable or disabled synchronization of status updates for the ongoing activity across multiple devices. In some embodiments, the user-configurable setting affects the behavior of multiple different types of ongoing activities (e.g., ongoing activities being managed by different applications). For example, the user-configurable setting can affect the behavior of a timer activity managed by a clock application and a navigation activity managed by a map application. In some embodiments, different types of ongoing activity are managed via a separate setting that affects the corresponding type of activity without affecting other types of ongoing activity. Enabling or disabling synchronization of status updates for the ongoing activity across multiple devices performs an operation when a condition is met (e.g., when the setting is enabled) without requiring additional user input. Allowing a user to control such synchronization provides the user with greater control over this function.

Note that details of the processes described above with respect to method 900 (e.g., FIG. 9) are also applicable in an analogous manner to the methods described above and below. For example, ongoing activities that are synchronized according to method 900 can be displayed as widgets that are managed for inclusion in a set of widgets in accordance with method 1100. In another example, ongoing activities that are displayed with representations of time according to method 700 can be synchronized across devices according to method 900. For brevity, these details are not repeated below.

FIG. 10A illustrates device 600 displaying user interface 1002 on display 602. User interface 1002 is a wake screen with a time interface (e.g., a digital clock face) that includes digits 1002a, indicating the current time. At FIG. 10A, device 600 detects input 1000a, which is an upwards swipe on display 602. In some embodiments, input 1002a is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 10B, in response to input 1002a, device 600 displays user interface 1006, a wake screen and time interface that include reduced-size clock face 1006a and day-and-date indication 1006b. In some embodiment, user interface 1006 includes one or more properties of user interface 618 (FIG. 6E). User interface 1006 also include widget stack 612b. At FIG. 10B, widget stack 612b includes topmost widget 1008a that corresponds to a calendar application, which is not an ongoing activity that is in progress. In some embodiments, widget stack 612b includes one or more widgets that correspond to an ongoing activity that is in progress and user interface 1006 is displayed as a wake screen when a set of wake criteria are met as device 600 transitions from a low power state, as described with reference to FIGS. 6A-6C. Note that the visual design of the digital clock face of user interface 1002 and reduced-size clock face 1006a are similar and/or are based on the same template, as discussed in more detail with reference to FIGS. 12A-12M, discussed below. At FIG. 10B, device 600 detects input 1004b, which is an upwards swipe on widget stack 612b, and also detects input 1010a, which is a clockwise rotation of rotatable and depressible input mechanism 604. In some embodiments, input 1004b and/or input 1010a is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 10C, in response to input 1004b and/or input 1010a, device 600 scrolls through the widgets (e.g., passing through physical activity widget 1008b and weather widget 1008c) in widget stack 612b, including displaying affordance 622e for accessing a springboard user interface that includes affordances for all applications that are installed on device 600 (FIG. 6L). At FIG. 10C, device 600 detects device input 1004c, which is a downwards swipe on widget stack 612b, and also detects input 1010b, which is a counterclockwise rotation of rotatable and depressible input mechanism 604. In some embodiments, input 1004c and/or input 1010b is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 10D, in response to input 1004c and/or input 1010b, device 600 scrolls back to the top of widget stack 612b, returning user interface 1006 to the same state shown in FIG. 10B. Thus, FIGS. 10C and 10D illustrate how a user can use directional swipes and/or rotations of rotatable and depressible input mechanism 604 to navigate through the various widgets of widgets stack 612b. At FIG. 10D, device 600 detects input 1004d, which is a leftwards swipe on widget 1008a. In some embodiments, input 1004d is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 10E, in response to input 1004d, device 600 displays remove affordance 1008a1 of widget 1008a, which is an affordance for removing (e.g., clearing) widget 1008a from widget stack 612b. In some embodiments, widget 1008a can be removed without requiring input on remove affordance 1008a1 via a longer swipe input (e.g., a swipe that moves more than a threshold distance), as discussed with reference to FIGS. 8E-8H. At FIG. 10E, device 600 detects input 1004e, which is a tap input on a portion of the display outside of widget 1008a (e.g., the tap is on day-and-date indication 1006b). In response to input 1004e device 600 ceases to display remove affordance 1008a1 and returns widget 1008a to the appearance shown in FIG. 10D. Also, at FIG. 10E, device 600 detects input 1004f, which is a tap on remove affordance 1008a1. In some embodiments, input 1004e and/or 1004f is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10F, in response to input 1004f, device 600 displays notification interface 812 that notifies the user that, even if the selected widget (e.g., widget 1008a) is removed, it and other removed widgets may still be suggested for inclusion in widget stack 612b and that this behavior can be modified in a settings menu (e.g., as shown in FIGS. 6Y-6AB). Notification interface 812 also includes dismissal affordance 812a for dismissing notification interface 812 and clear affordance 812b for removing widget 1008a from widget stack 612b. In some embodiments, notification interface 812 is only displayed on selection of remove affordance 1008a1 when a user first attempts (e.g., after using device 600 and/or after an operating system of device 600 is updated) to remove a widget from widget stack 612b. At FIG. 10F, device 600 detects input 1004g, which is a tap on dismissal affordance 812a and, in response, redisplays user interface 1008 as shown in FIG. 10D. At FIG. 10F, device 600 detects input 1004h, which is a tap on remove affordance 812b. In some embodiments, input 1004g and/or input 1004h is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10G, in response to input 1004h, which was a tap on remove affordance 812b, device 600 displays user interface 1006, after removing widget 1008a from widget stack 612b. Because widget 1008a has been removed, widget 1008b (e.g., a widget of a daily physical activity tracking application) is now in the top position of widget stack 612b. At FIG. 10G, device 600 detects input 1004i, which is a long-press on widget stack 612b. In some embodiments, input 1004i can be on any portion of display 602, while widget stack 612b is displayed. In some embodiments, input 1004i is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10H, device 600 displays user interface 1012, which is an editing interface for managing widget stack 612b. In FIG. 10H, user interface 1012 overlays user interface 1006, which is now blurred. User interface 1012 includes affordance 1012a for exiting the widget stack editing mode and returning to user interface 1006, as shown in FIG. 10G. User interface 1012 includes widgets 1008b and widget 1008d, which is shortcut widget with affordance 1008d1, affordance 1008d2, and affordance 1008d3 that can be used to access a music application, a workout application, and a messaging application, respectively, when widget stack 612b is displayed outside of the editing mode of user interface 1012. Widget 1008b includes pinning affordance 1008b1 and widget 1008d includes corresponding pinning affordance 1008d4 that can be used to toggle whether the respective widget is “pinned” to the top of widget stack 612b, such that the respective widget is always displayed at a predetermined position (e.g., at the top or immediately below widgets of a certain type, such as widgets for ongoing activities that are in progress) within the order of widget stack 612b (e.g., until it is unpinned), when widget stack 612b is displayed. In FIG. 10H, pinning affordances 1008b1 and 1008d4 visually indicate that both widget 1008b and widget 1008d are currently not pinned. As such, while widgets 1008b and 1008d will be included in widget stack 612b when widget stack 612b is displayed, they may not necessarily be displayed in predetermined position within the order of widgets of widget stack 612b. In FIG. 10H, widgets 1008b and 1008d are widgets that have been manually/explicitly added to widget stack 612b and are referred to as “MY WIDGETS.” Widget 1008b includes remove affordance 1008b2 and widget 1008d includes corresponding remove affordance 1008d5 that can be used to remove the respective widget from widget stack 612b. In some embodiments, removing a widget also unpins the widget. At FIG. 10H, device 600 detects input 1004j, an upwards swipe on display 602, and input 1010c, a clockwise rotation of rotatable and depressible input mechanism 604. In some embodiments, input 1004j and/or input 1010c is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 10I, in response to input 1004j and/or input 1010c, device 600 scrolls user interface 1012 to display other widgets of widgets stack 612b in the editing mode. Scrolled user interface 1012 includes region 1012b that displays currently suggested widgets, which are widgets that are dynamically included in widgets stack 612b, based on a set of suggestion criteria. In some embodiments, the suggestion criteria includes a current context of device 600 and/or information available to device 600, such as current time and/or date, location of device 600, whether other devices (e.g., headphones) are connected, weather conditions, and/or a current level of physical activity of the user. In such embodiments, device 600 dynamically includes widgets in widget stack 612b that are determined to be of potential relevance to the user of device 600 (e.g., under the current device context). In some embodiments, the set of suggestion criteria, along with the corresponding application and widget, include one or more of the rows shown in Table 1, below. For example, a moon phase widget of an astronomy application can be suggested and/or included in widget stack 612b when a moon-related event (e.g., a new moon or a full moon) occurs. Similarly, an alarm widget that corresponds to an alarm application can be suggested and/or included in widget stack 612b as the user's bedtime approaches. In some embodiments, the criteria affect the order in which widgets are presented as well as the composition of widgets in widget stack 612b.

TABLE 1

| Application | Widget | Criteria for Adding Widget to Widget Stack |
|---|---|---|
| astronomy | moon phase | the occurrence of a new moon, full moon, and/or blood moon |
| activity | widget 1008b | the occurrence of a mid-afternoon and/or after workout ends |
| | (activity) | |
| alarm | alarm | the occurrence of a bedtime (e.g., a specific time of day |
| | | designated as a bedtime optionally based on user input) |
| audiobooks | audiobooks | wired or wireless connection of headphones to the device |
| | (suggestions) | detected and recently listened to an audiobook |
| calendar | widget 1008e | the occurrence of upcoming event in the calendar |
| | (up next) | |
| compass | compass, | the start of a hiking workout detected (e.g., based on automatic |
| | (backtrack, | detection of the start of a workout based on one or more sensor |
| | waypoint) | measurements and/or based on a user instruction to start tracking |
| | | a hiking workout) |
| heart rate | heart rate | workout completed (e.g., the end of a workout detected) |
| medications | medication | the detection of medication setup completed, medication |
| | | upcoming, and/or medication not completed |
| mindfulness | mindfulness | the detection of the occurrence of a time for which a mindful |
| | | moment has been scheduled (e.g., automatically or based on |
| | | prior user input) |
| music | music | the detection of wired or wireless connection of headphones to |
| | (suggestions) | the device |
| news | news | the occurrence of a time that is associated with morning, |
| | | afternoon, evening and/or the detection of an unread news story, |
| | | and/or breaking news story |
| noise | noise | loud sound detected by one or more sensors in communication |
| | | with the device |
| now playing | now playing | the detection of a nearby smart speaker and/or media playback |
| | (suggestions) | device that is near the device |
| podcasts | podcast | the detection of a wired or wireless connection of the device to |
| | (suggestions) | headphones and recently listened to podcasts (e.g., one or more |
| | | podcasts that were listened to within a threshold amount of time |
| | | of when the detection of connection of the headphones to the |
| | | device was detected) |
| reminders | reminders | the detection of an upcoming time associated with a reminder |
| | | that has not been marked as completed and/or the detection that |
| | | the device is near a location that is associated with a reminder |
| | | that has not been marked as completed |
| shortcuts | shortcut, run | the detection of a device context (e.g., location, time of day, day |
| | scene | of the week and/or other contextual information) that indicates |
| | | that a particular shortcut is part of a user's routine |
| sleep | sleep stage, | the detection (e.g., based on one or more sensors of the device |
| | schedule | and/or other signals) that the user has woken up after sleeping |
| stocks | last viewed | the detection of a current time corresponding to morning and stock |
| | stock | information has been recently viewed, and/or the detection of a |
| | | time associated with market close for one or more stock markets |
| timers | widget 612b1 | detection that criteria associated with a routine timer event has |
| | (timer) | been met (e.g., the user routinely starts a timer at 5PM each day), |
| | | detection that the device is at a predetermined location, and/or |
| | | detection of ambient audio that is indicative of a timing event |
| | | (e.g., the sound of an alarm clock) |
| tips | tips | detecting that something new to learn is now available (e.g., a |
| | | new device feature to be learned) and/or the occurrence of a |
| | | major software release update |
| wallet | relevant | detection that the device is at a predetermined location (e.g., a |
| | passes | train station or airport) and/or occurrence of a predetermined |
| | | time (e.g., a scheduled flight boarding time) |
| weather | all | the occurrence of a time of day (e.g., morning), detection of |
| | | inclement changes in weather (e.g., expected precipitation, |
| | | expected severe weather, and/or an expected sudden change in |
| | | weather conditions), and/or determining that certain criteria are |
| | | met (e.g., user characteristics (e.g., skin type, age, and/or |
| | | physical capabilities) separately and/or in conjunction with |
| | | certain types of weather, such as a warning of high UV exposure |
| | | for a person who is likely to easily get a sunburn, a warning of |
| | | high temperatures for a person who is likely to get heat |
| | | exhaustion, or a warning of low temperatures for a person who is |
| | | likely to experience hypothermia)) |
| workout | workout | the occurrence of a condition that frequently corresponds to a |
| | | user starting a workout (e.g., the occurrence of a particular time |
| | | of day, the presence of the device at a location that is associated |
| | | with starting workouts such as arriving home, arriving at a park, |
| | | and/or arriving at a gym, and/or the detection of one or more |
| | | physiological changes that indicate that a person wearing the |
| | | device has started a workout such as an elevated heart rate and/or |
| | | speed of movement) |
| world clock | sunset | the occurrence of a time of day that is associated with morning, |
| | | evening, sunrise, and/or sunset (optionally based on a current |
| | | detected location of the device and/or a user wearing the device) |
| world clock | home city | detection that the device and/or user is in a foreign (e.g., non-home) |
| | time | city; in some embodiments, home city time widget shows |
| | | the time at the home city that is detected automatically based on |
| | | a typical or frequent location of the device or the user or a home |
| | | city that is set based on one or more user inputs. |

At FIG. 10I, region 1012b includes widget 1008c that corresponds to a weather application and widget 1008e that corresponds to a calendar application. Widget 1008c includes add affordance 1008c1 that currently indicates that widgets 1008c is not currently user-added (e.g., manually and/or explicitly added) to widget stack 612b. Selecting add affordance 1008c1 would manually add widget 1008c to widget stack 612b so that it will be included in widget stack 612b, independently of the suggestion criteria (e.g., become similar to already-added widget 1008b). Widget 1008e includes a corresponding add affordance 1008e1 that operates in a similar manner. In some embodiments, widget 1008c is suggested because device 600 determines that rain is about to start. In some embodiments, widget 1008e is suggested because an upcoming event is close in time.

In some embodiments, device 600 includes no more than a maximum number of widgets and/or a predetermined number of suggested widgets in widget stack 612b, such as from 3-5 suggested widgets or no more than 10 total widgets. In some embodiments, widget stack 612b includes no more than a predetermined number of widgets per application (e.g., no more than one widget per application) or no more than the predetermined number of suggested widgets per application. For example, referring back to Table 1, widget stack 612b could include the sunset widget or the home city time widget, but not both at the same time (or not include both as suggested widgets). In embodiments in which widget stack 612b includes a maximum number of total widgets and/or a maximum number of widgets per application, device 600 determines a priority for widgets that are suggested and/or included in widget stack 612b. In some embodiments, the prioritization affects whether a widget will be included in the widget stack and/or the order in which a widget is presented in the widget stack. In some embodiments, the prioritization is based on relevance score and/or value reported by an application (e.g., reported for the application as a whole or on a widget-by-widget basis for the widgets of that application) for the current context of device 600. In some embodiments, a widget is promoted for inclusion in the widget tack by its corresponding application. In some embodiments, the score is associated with a triggering contextual event, such as: a) A specific time has been reached (e.g. 12:30 PM), b) it is bedtime or wake-up (e.g. designated by a user's sleep schedule), c) a specific location has been reached (e.g. an airport), d) an inferred location has been reached (e.g. home, work), e) a device (e.g., wireless headphones) have been connected, f) music has been detected (e.g., detected in the environment and/or playing by device 600), and g) a physical workout has occurred or is occurring. In some embodiments, device 600 evaluates the scores for all potential widgets, orders the widgets by score, and then includes widgets up to a permissible maximum (e.g., 10 widgets). In some embodiments, each application generates its own score relative to itself for each of the applications widgets, and then device 600 looks at all the scores and normalizes those values. For example, a first application could give a score between 1-10 to its own widgets, while a second application could give a score from 100-1000 to its own widgets, but when device 600 ingests these scores and ranks the widgets, the scores for the widgets all get normalized.

At FIG. 10J, while user interface 1012 is currently scrolled to a position where widget 1008c is displayed, device 600 detects input 1004k. Input 1004k is a tap on add affordance 1008c1 of widget 1008c. In some embodiments, input 1004k is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10K, in response to input 1004k, device transitions widget 1008c to the “MY WIDGETS” region of user interface 1012, indicating that the widget has been manually/explicitly added to widget stack 612b such that widget 1008c will be included in widget stack 612b when widget stack 612b is displayed. In some embodiments, widget 1008c is presented at the top of the “MY WIDGETS” region because it is the most recently manually-added widget. At FIG. 10K, widget 1008c now includes pinning affordance 1008c2. At FIG. 10K, device 600 detects input 1004l, a tap on pinning affordance 1008c2. In some embodiments, input 1004l is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10L, in response to input 1004l, device pins widget 1008c so that the widget will be included at a predetermined position (e.g., at the top or immediately below widgets of a certain type, such as widgets for ongoing activities that are in progress) within the order of widget stack 612b (e.g., until it is unpinned), when widget stack 612b is displayed. Widget 1008c now includes pinned indication 1008c3 and pinning affordance 1008c2 has a modified visual appearance (e.g., filled in and/or shaded) to indicate that widget 1008c is now pinned. At FIG. 10L, device 600 detects input 1004m, a tap on affordance 1012a. In some embodiments, input 1004m is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10M, in response to input 1004m, device 600 exits the widget stack editing mode and redisplays user interface 1006. Widget 1008c, having been pinned, is displayed at the top of widget tack 612b (e.g., in front of widget 1008b that was in front before widget 1008c was pinned).

At FIG. 10N, device 600 displays user interface 1014, a wake screen and clock face that does not include widget stack 612b. In some embodiments, device 600 transitioned from having user interface 1006 as the currently-selected wake screen to user interface 1014, based on a set of user inputs configuring device 600 to use a new wake screen. User interface 1014 includes representation of time 1014a and weather complication 1014b. At FIG. 10N, device 600 detects input 1004n, an upwards swipe on display 602, and input 1010d, a clockwise rotation of rotatable and depressible input mechanism 604. In some embodiments, input 1004n and/or input 1010d is another type of touch input (e.g., a tap, a double tap, or a two-finger swipe), a hardware input (e.g., a button press, rotatable input mechanism rotation, and/or mouse movement), an air gesture, and/or a gaze-based input.

At FIG. 10O, in response to input 1004n and/or input 1010d, device 600 displays user interface 1016, which is a wake screen that includes widget stack 612b. User interface 1016 includes reduced-size clock face 1016a and day-and-date indication 1016b. At FIG. 10N, widget stack 612b includes widget 1008c in a top position (e.g., above widget 1008b). Thus, FIGS. 10N-10O illustrate that changes made to widget stack 612b (e.g., via editing user interface 1012) are maintained across different wake screens/user interfaces.

At FIG. 10P, device 600 displays widget stack 612b scrolled to display widget 1008f that corresponds to a home application that dynamically includes controls for various home devices and widget 1008d that is a shortcut widget. Both widget 1008f and widget 1008d include multiple selectable regions that can be selected to perform different operations. At FIG. 10P, device detects multiple tap inputs: input 1004o on main region 1008f2 of widget 1008f, input 1004p on affordance 1004f1 of widget 1008f that corresponds to a garage door opener, input 1004q on affordance 1008d1 of widget 1008d, input 1004r on affordance 1008d2 of widget 1008d, and input 1004s on affordance 1008d3 of widget 1008d. In response to input 1004q, device 600 displays a user interface of a workout application. In response to input 1004s, device 600 displays a user interface of a messaging application. In response to input 1004r, device 600 displays a user interface of a music application. In some embodiments, inputs 1004o, 1004p, 1004q, 1004r, and/or 1010s is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10Q, in response to input 1004o on main region 1008f2 of widget 1008f, device 600 displays user interface 1018 which is a user interface of the home application. The home application can be used to control multiple devices in the home, including the garage door opener. User interface 1018 includes affordance 1008f1, which was also displayed in widget 1008f at FIG. 10P. In some embodiments, one or more affordances accessible via user interface 1018 are included in widget 1008f based on a context of device 600 (e.g., proximity to a location and/or time of day). At FIGS. 10P and 10Q, widget 1008f includes affordance 1008f1 because device 600 detects that the user is driving and approaching the user's home.

At FIG. 10R, in response to input 1004p on affordance 1008d1 of widget 1008d (or selection of affordance 1008d1 from user interface 1018), device 600 displays garage control user interface 1020. User interface 1020 includes affordance 1020a for exiting user interface 1020 and affordance 1020b for opening the garage. Device 600 displays user interface 1020 because opening the garage door has been deemed to be a potentially high risk activity with negative consequences if opening the garage was not truly intended by the user. In some embodiments, operations (e.g., turning on a light or a fan) that are deemed to be lower risk of negative consequences on a false positive are performed immediately without requiring a confirmatory input. At FIG. 10R, device 600 detects input 1004t on affordance 1020a and in response, ceases to display user interface 1020 and returns to display of widget stack 612b as shown in FIG. 10P. Also, at FIG. 10R, device 600 detects input 1004u and in response, issues a command to the garage door to open. In some embodiments, in response to input 1004p on affordance 1008d1, device 600 issues a command to the garage door to open, without displaying user interface 1020 and without requiring a confirmation input.

At FIG. 10S, device 600 displays user interface 622 with widget stack 612b currently displaying widget 1022 at the top. Widget 1022 is a timer widget of a completed timer; widget 1022 includes affordance 1022a and affordance 1022b. At FIG. 10S, device 600 detects input 1004v on affordance 1022a and, in response, restarts the timer that just completed. At FIG. 10S, device 600 detects input 1004w on affordance 1022b and, in response, ends the timer. In some embodiments, in response to input 1004w, device 600 also removes widgets 1022 from widget stack 612b. In some embodiments, input 1004v and/or 1004w is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10T, device 600 displays user interface 1024, user interface for managing settings for suggestions for widgets to include in widget stack 612b. In some embodiments, user interface 1024 is displayed in response to a selection of affordance 644a of FIG. 6Z. User interface 1024 includes affordance 1024a for setting whether any widgets are ever suggested. When affordance 1024a is toggled to a disabled state, widget stack 612b only includes widgets that are manually selected by a user, without including any widgets that are suggested based on a set of suggestion criteria. User interface 1024 also includes a set of affordances for managing/configuring widget suggestions, on an application-by-application basis. The set of affordances includes affordance 1024b corresponding to a physical activity monitoring application and affordance 1024c corresponding to a weather application. At FIG. 10T, device 600 detects input 1004x at affordance 1024 and, in response toggles the state affordance 1024 (e.g., from enabled to disabled or vice versa). At FIG. 10T, device 600 detects input 1004y, a tap on affordance 1024b. At FIG. 10T, device 600 detects input 1004z, a tap on affordance 1024c. In some embodiments, input 1004x, input 1004y, and/or 1004z is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 10U, in response to input 1004y, device 600 displays user interface 1026 that corresponds to the physical activity monitoring application. As seen in user interface 1026, the physical activity monitoring application has two available widgets than be displayed in widget stack 612b: rings widget 1026b that tracks certain types of physical activity and timeline widget 1026c that tracks when physical activity is performed. User interface 1026 also includes affordance 1026 that controls whether any widgets of the physical activity monitoring application can be suggested for inclusion in widget stack 612b (e.g., based on a set of suggestion criteria). Rings widget 1026b includes affordance 1026b1 that can be selected to individually enable or disable whether rings widget 1026b can be suggested for inclusion in widget stack 612b (e.g., based on a set of suggestion criteria). Timeline widget 1026c includes similar affordance 1026c1 that does the same for that widget. Thus, a user can choose to disable all widgets for a given application or selectively enable or disable widgets on widget-by-widget basis for a given application.

At FIG. 10V, in response to input 1004z, device 600 displays user interface 1028 that corresponds to the weather application. The weather application has five available widgets. As with the physical activity monitoring application, a user can use the affordances of user interface 1028 to enable or disable suggestions for some or all of the widgets of the weather application.

FIG. 11 is a flow illustrating a method for managing widgets for inclusion in a set of widgets, in accordance with some embodiments. Method 1100 is performed at a computer system (e.g., 100, 300, 500, 600, 800a, and/or 800b) (e.g., a smartwatch, a smartphone, a tablet computer, a laptop computer, and/or a desktop computer) that is in communication with one or more display generation components (e.g., a display controller, a display, a touch-sensitive display system, a touchscreen, a head-mounted display, and/or a monitor) and one or more input devices (e.g., a touch-sensitive surface, a touchscreen display, a button, a keyboard, a mouse, a joystick, a camera sensor, and/or a microphone). Some operations in method 1100 are, optionally, combined, the orders of some operations are, optionally, changed, and some operations are, optionally, omitted.

As described below, method 1100 provides an intuitive way for managing widgets for inclusion in a set of widgets. The method reduces the cognitive burden on a user for managing widgets for inclusion in a set of widgets, thereby creating a more efficient human-machine interface. For battery-operated computing devices, enabling a user manage widgets for inclusion in a set of widgets faster and more efficiently conserves power and increases the time between battery charges.

The computer system receives (1102) a request (e.g., an input, a raise or rotation gesture, a tap gesture (e.g., on a touch-sensitive surface), a voice command, a button press, and/or a rotation of a rotatable input mechanism) to display a time user interface (e.g., 1006, 1016) concurrently with a set of widgets (e.g., a stack of widgets and/or a set of two or more widgets, wherein one widget at least partially overlaps another widget) (in some embodiments, a widget is a user interface object that provides information (e.g., information regarding an application and/or an ongoing process or activity) and/or a control (e.g., for controlling an application and/or an ongoing process or activity)).

In response to the request to display the time user interface concurrently with the set of widgets (1104) and in accordance with a determination (1106) that the computer system is operating in a first context (e.g., a context/criteria such as those of Table 1, above) (e.g., the context corresponding to FIG. 10B) (e.g., when a first set of one or more criteria regarding user activity, application data, and/or ambient conditions is met) while a first style of time user interface has been selected for the computer system, the computer system concurrently displays (1104): a representation of time (e.g., 1006a, 1016a) (e.g., a digital or analog representation of the current time) with a first appearance based on the first style (e.g., the style of 1006) (in some embodiments, the design, shape, text, font, and/or color(s) of the representation of time are based on the first style, such as the design, shape, text, font, and/or color(s) of the first style); and a set of widgets (e.g., 612b) that includes a first set of widgets.

In response to the request to display the time user interface concurrently with the set of widgets and in accordance with a determination (1108) that the computer system is operating in the first context (e.g., the context corresponding to FIG. 10B) while a second style of time user interface has been selected for the computer system, the computer system concurrently displays: a representation of time (e.g., a digital or analog representation of the current time) with a second appearance based on the second style (e.g., the style of 1016a) (in some embodiments, the design, shape, text, font, and/or color(s) of the representation of time are based on the second style, such as the design, shape, text, font, and/or color(s) of the second style); and the set of widgets that includes the first set of widgets (e.g., 612b of FIG. 10B).

In response to the request to display the time user interface concurrently with the set of widgets and in accordance with a determination (1110) that the computer system is operating in a second context (e.g., the context corresponding to FIG. 10M) (e.g., when a second set of one or more criteria regarding user activity, application data, and/or ambient conditions is met) while the first style of time user interface has been selected for the computer system, the computer system concurrently displays: a representation of time (e.g., a digital or analog representation of the current time) with the first appearance based on the first style; and a set of widgets that includes a second set of widgets (e.g., 612b of FIG. 10M) that is different from the first set of widgets.

In response to the request to display the time user interface concurrently with the set of widgets and in accordance with a determination (1112) that the computer system is operating in the second context (e.g., the context corresponding to FIG. 10M) while the second style of time user interface has been selected for the computer system (e.g., the style of 1016a), the computer system concurrently displays: a representation of time (e.g., a digital or analog representation of the current time) with the second appearance based on the second style; and the set of widgets that includes the second set of widgets. Displaying a set of widgets concurrently with different styles of representations of time, with the stack if widgets including different sets of widgets based on system context performs different actions when a set of conditions are met, without requiring further user input and also provides improved visual feedback as to the current context while providing contextually-relevant widgets. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the first set of widgets includes a first widget that is user-selected for inclusion in the set of widgets (e.g., 1008c as selected in FIGS. 10J-10K) (e.g., a manually-added widget and/or a widget that is included irrespective of the context in which the system is operating). In some embodiments, the second set of widgets also includes the first widget. Including both contextually-selected and manually-selected widgets in the set of widgets provides users with a greater degree of control over the contents of the set of widgets, while also automatically providing contextually relevant widgets without requiring further user input. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the set of widgets is displayed in an order (e.g., a predetermined sequence and/or arrangement) and wherein the position of at least one widget (e.g., 1008d as discussed with reference to FIG. 10I) in the order is user-selected (e.g., via a previous user input that pins a widget to a top position within the order). In some embodiments, the order of display determines what order the widgets of the set of widgets are displayed in when a navigation input (e.g., a swipe input or a rotational input) is detected. Providing the user with the ability to control the order of widgets in the stack provides the user with a greater degree of control over how the stack is organized. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, one or more widgets of the set of widgets are removable from the set of widgets via a first set of one or more user inputs detected via the one or more input devices (e.g., inputs 1004d, 1004f, 1004g, 1004h). Providing the user with the ability to remove widgets from the stack provides the user with a greater degree of control over the stack.

In some embodiments, the first set of one or more user inputs is received while the computer system is in an edit mode (e.g., as discussed with reference to FIGS. 10H-10L) (e.g., a mode for editing the composition of the set of widgets) (in some embodiments, a mode that is entered via a designated command/input while the set of widgets is displayed). In some embodiments, an edit mode is distinct from a display mode and provides for functionality that affects the set of widgets that are not available in the display mode. For example, the edit more can provide for adding, removing, and/or removing widgets from the set of widgets. In some embodiments, the computer system accepts different inputs and/or responds differently to inputs while in the edit mode (e.g., a long swipe across a widget can cause the widget to be removed from the set of widgets while in the edit mode whereas a long swipe while in the normal display mode would not cause the widget to be removed).

In some embodiments, the first set of one or more user inputs is received while the computer system is displaying the set of widgets (e.g., as discussed with reference to FIGS. 10B-10F).

In some embodiments, the first set of one or more user inputs includes detecting a movement input (e.g., 1004d) (e.g., such as a swipe gesture detected via touch-sensitive surface or an air gesture swipe) corresponding to (e.g., directed to or directed to a location of) a second widget (1008a) of the set of widgets that causes a user-selectable removal graphical object (1008a1) to be displayed and wherein the first set of one or more user inputs includes detecting a selection of the user-selectable removal graphical object that causes the second widget of the set of widgets to be removed.

In some embodiments, the first set of one or more user inputs includes a second movement input corresponding to (e.g., directed to or on) a third widget of the set of widgets. In response to the second movement input (e.g., 1004d) and in accordance with a determination that a characteristic of movement (e.g., a speed of movement and/or a magnitude (e.g., distance) of movement) of the second movement input does not meet a set of movement criteria, the computer system displays a second user-selectable removal graphical object (1008a1), wherein the first set of one or more user inputs includes detecting a selection of the second user-selectable removal graphical object that causes removal of the third widget of the set of widgets to be removed. In response to the second movement input (e.g., 1004d as discussed with reference to FIG. 10D) and in accordance with a determination that a characteristic of movement of the second movement input meets the set of movement criteria, the computer system removes the third widget of the set of widgets without displaying the second user-selectable removal graphical object. In some embodiments, a slow and/or short swipe causes display of a removal affordance for removing a specific widget whereas a fast and/or long swipe on the widget removes the widget without displaying the removal affordance.

In some embodiments, the first set of one or more user inputs is a swipe gesture (e.g., 1004d) corresponding to (e.g., directed to or on) a fourth widget (e.g., 1008a) of the set of widgets. In some embodiments, a swipe on a widget causes the widget to be removed, without requiring a separate confirmation input. In some embodiments, a selection input (e.g., a tap, a press-and-hold, a button press or air gesture while focus is directed to the widget) directed to a widget causes the computer system to perform an action corresponding to the widget, other than removing the widget. Exemplary actions can include displaying additional information pertaining to the widget and/or the ongoing activity or launching an application associated with the ongoing activity.

In some embodiments, the computer system detects, via the one or more input devices, a second set of one or more inputs (e.g., 1004d, 1004f) that corresponds to a request to remove a respective widget from the set of widgets. In response to detecting the second set of one or more inputs and in accordance with a determination that a set of prompting criteria are met (in some embodiments, the prompting criteria includes a criterion that is met when the second set of one or more inputs is identified as a first instance of a widget being removed and/or a first instance of the respective widget being removed), the computer system displays a prompt (e.g., prompt of user interface 812 of FIG. 10F) that includes information corresponding to the removal of widgets from the set of widgets. In some embodiments, the information includes information about how to further control what widgets are includes in the set of widgets; in some embodiments, the information includes information about how a removed widget can still be suggested for inclusion in the set of widgets. Conditionally displaying a prompt that includes information corresponding to the removal of widgets from the set of widgets performs an operation based on a set of criteria being met without requiring further input and provides improved visual feedback as to the widget removal process.

In some embodiments, after a respective widget that was previously included in the set of widgets was removed via the set of one or more user inputs, the computer system detects that the respective widget (e.g., 1008a) (in some embodiments, an ongoing activity and/or application corresponding to the respective widget) meets a set of contextual relevance criteria (e.g., a criteria shown in Table 1) (e.g., criterial based on a current context of the device, such as date, time, location, and/or current application usage). In response to detecting that the respective widget meets the set of contextual relevance criteria, the computer system re-introduces the respective widget to the set of widgets (in some embodiments, displaying the respective widget in the set of widgets while the set of widgets is currently displayed or causing the set of widgets to be displayed with the respective widget or flagging the respective widget for subsequent display in the set of widgets, when the set of widgets is not currently being displayed). In some embodiments, a removed widget is eligible for later inclusion in the set of widgets based on computer system context (e.g., a removed widget can be deemed to be contextually relevant and suggested for inclusion and/or automatically included in the set of widgets). Conditionally including a previously removed widget based on system context performs an operation based on a set of criteria being met without requiring further input and also reduces the risk that contextually-relevant information is missed due to removal under different circumstances. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, while the computer system is in a set of widgets edit mode (e.g., as discussed with reference to FIGS. 10H-10L) (in some embodiments, the set of widgets edit mode is the same as the edit mode described above with respect to other aspects of method 1100), the computer system displays one or more widgets (e.g., 1008c, 1008e) suggested for inclusion in the set of widgets (e.g., for inclusion the set of widgets for display when outside of the edit mode) that are suggested for inclusion based on a current computer system context.

In some embodiments, the computer system detects, via the one or more input devices, a set of one or more inputs (e.g., 1004k) corresponding to (e.g., directed to or on) a first suggested widget (e.g., 1008c) of the one or more widgets suggested for inclusion in the set of widgets. In response to detecting the set of one or more inputs corresponding to a first suggested widget, the computer system designates the first suggested widget for inclusion in the set of widgets when the set of widgets is displayed (e.g., displayed outside of the set of widgets edit mode). In some embodiments, the selected first suggested widget is designated for permanent inclusion in the set of widgets, irrespective of system context.

In some embodiments, after the first suggested widget has been designated for inclusion in the set of widgets when the set of widgets is displayed, the computer system detects, via the one or more input devices, a set of one or more inputs corresponding to designation of a position at which the first suggested widget is displayed in an ordered display sequence of the set of widgets (e.g., the sequence of pinned widgets of FIG. 10I) (e.g., via a user input that pins a widget to a top position within the order). In response to detecting the set of one or more inputs corresponding to designation of a position at which the first suggested widget is displayed in an ordered display sequence of the set of widgets, the computer system designates the first suggested widget to be displayed in the designated position in the set of widgets. In some embodiments, after detecting the set of one or more inputs corresponding to designation of a position at which the first suggested widget is displayed, receiving a request to display the time user interface concurrently with the set of widgets; in response to the request, displaying the timer user interface concurrently with the set of widgets, wherein: in accordance with a determination that the set of one or more inputs corresponding to designation of a position at which the first suggested widget designated that the first suggested widget be displayed in a first position of the set of widgets, displaying the first suggested widget at the first position in the set of widgets, and in accordance with a determination that the set of one or more inputs corresponding to designation of a position at which the first suggested widget designated that the first suggested widget be displayed in a second position of the set of widgets, different from the first position, displaying the first suggested widget at the second position in the set of widgets. Providing the user with the ability to control the position of a widget in the stack for a widget provides the user with a greater degree of control over how the stack is organized.

In some embodiments, while the computer system is in the set of widgets edit mode (e.g., as discussed with reference to FIGS. 10H-10L), the computer system displays one or more user-selected widgets (e.g., 1008b, 1008d) that are included in the set of widgets (e.g., that will be included in the set of widgets for display when outside of the edit mode).

In some embodiments, the one or more user-selected widgets includes: a first user-selected widget (e.g., 1008b) that has been designated for display at a predetermined order in an ordered display sequence of the set of widgets (e.g., a pinned widget); and a second user-selected widget (1008c in FIG. 10I) that has not been designated for display at a predetermined order in an ordered display sequence of the set of widgets (e.g., an unpinned widget). Providing the user with the ability to control the position of widgets in the stack for a widget provides the user with a greater degree of control over how the stack is organized.

In some embodiments, while the computer system is in the set of widgets edit mode (e.g., as discussed with reference to FIGS. 10H-10L), the computer system displays a plurality of headers (e.g., 1012b) (in some embodiments, as part of scrollable list of widgets) corresponding to sections of widgets that can be included in the set of widgets (e.g., that can be included in the set of widgets for display when outside of the edit mode). In some embodiments, the headers are “sticky” such that scrolling through the list of potential and/or included widgets causes a header to remain at designated position on the display until the current section of widgets has ended and the header is replaced by a new header as a new section of widgets is scrolled onto the display. Displaying headers for widgets that are included or can be included in the set of widgets provides improved visual feedback.

In some embodiments, changes made to the set of widgets (e.g., changes made to include and/or remove widgets from the set of widgets or to change the order of widgets) while in the set of widgets edit mode (e.g., as discussed with reference to FIGS. 10H-10L) affect the display of the set of widgets while the first style of time user interface is concurrently displayed with the set of widgets and while the second style of time user interface is concurrently displayed with the set of widgets. After a first set of changes were made to the set of widgets while in the set of widgets edit mode, resulting in a changed set of widgets, the computer system receives a first request to display the time user interface concurrently with the set of widgets while the first style of time user interface has been selected for the computer system. In response to receiving the first request, the computer system displays the time user interface with the first style concurrently with the changed set of widgets (e.g., as seen in FIG. 10M). The computer system receives a second request to display the time user interface concurrently with the set of widgets while the second style of time user interface has been selected for the computer system (e.g., as seen in 10O). In response to receiving the second request, the computer system displays the time user interface with the second style concurrently with the changed set of widgets. In some embodiments, changes made during the edit mode to the set of widgets is persistent across multiple different time user interfaces. Implementing changes made during the edit mode across multiple different time user interfaces reduces the number of inputs required to customize the set of widgets for multiple interfaces.

In some embodiments, the set of widgets includes a fifth widget (e.g., 1008f, 1008d) that includes: a first widget region (e.g., the left of 1008f, 1008d1) that can be selected to perform a first operation (e.g., resetting a timer for a timer widget) corresponding to the fifth widget; and a second widget region (e.g., 1008f1, 1008d2) that can be selected to perform a second operation (e.g., cancelling a timer for a timer widget), different from the first operation, corresponding to the fifth widget. The computer system detects, via the one or more input devices, a respective input (e.g., a tap or a button press or air gesture that is detected while focus is directed to the fifth widget) directed to the fifth widget. In response to detecting the respective input: in accordance with a determination that the respective input corresponds to the first widget region, performing the first operation corresponding to the fifth widget; and in accordance with a determination that the respective input corresponds to the second widget region, performing the second operation corresponding to the fifth widget (in some embodiments, without performing the first operation). Including first and second widget regions in the same widget that perform different operations provides the widget with improved functionality specific to the widget without cluttering the remainder of the user interface with controls and/or without requiring the user to provide multiple inputs to navigate through the user interface to perform a respective operation.

In some embodiments, the fifth widget (e.g., 1008f) corresponds to a respective application: the first operation includes displaying (in some embodiments, launching) a user interface of the respective application (e.g., a UI that is generated by the respective application); and the second operation includes performing an action corresponding to the respective application without displaying a user interface of the respective application. Providing a widget with different regions that allow for operations that include opening a user interface of a respective application or performing an action without opening the UI allows the user greater control of respective application and to determine whether to perform an operation without having to open the UI of the respective application. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the fifth widget includes a third widget region (1008d3) that can be selected to perform a third operation, different from the first and second operations, corresponding to the fifth widget. In response to detecting the respective input: in accordance with a determination that the respective input corresponds to the third widget region, performing the third operation corresponding to the fifth widget (in some embodiments, without performing the first operation and/or the second operation).

In some embodiments, the computer system detects, via the one or more input devices, a user input (1004o, 1004p) (e.g., a tap or double-tap) corresponding to (e.g., directed to or on) a respective widget region of the fifth widget. In response to detecting the user input corresponding to the respective widget region of the fifth widget: in accordance with a determination that the operation associated with the respective region is an operation of a first type (e.g., a destructive operation and/or an operation that is deemed to be high risk, consequential, and/or irreversible), displaying a selectable confirmation user interface object (e.g., 1020b) that must be selected to perform the operation associated with the respective region. In some embodiments, in response to detecting the user input corresponding to the respective widget region of the fifth widget and in accordance with a determination that the operation associated with the respective region is not an operation of the first type, performing the operation associated with the respective region (e.g., without displaying the selectable confirmation user interface). Requiring confirmation to perform operations of a certain type reduces the risk of false positives for such operations. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the computer system displays (e.g., while the computer system is in a set of widgets edit mode or while the computer system is in a normal display mode for the set of widgets (e.g., a mode separate from the set of widgets edit mode)) one or more widgets suggested for inclusion in the set of widgets (e.g., 1008c, 1008e).

In accordance with a determination that a set of suggestion criteria (e.g., contextual suggestion criteria) are met and a user-configurable setting (1026a) for a respective application has a first setting (e.g., an enabled setting), the one or more widgets suggested for inclusion includes a respective suggested widget (e.g., 1026b, 1026c) that corresponds to the respective application. In accordance with a determination that the set of suggestion criteria are met and the user-configurable setting for the respective application has a second setting (e.g., a disabled setting), the one or more widgets suggested for inclusion do not include a respective suggested widget that corresponds to the respective application. In some embodiments, in accordance with a determination that the set of suggestion criteria are not met, the one or more widgets suggested for inclusion includes a respective suggested widget that corresponds to the respective application (e.g., irrespective of the current setting of the user-configurable setting for a respective application). In some embodiments, in accordance with a determination that the set of suggestion criteria are met and the user-configurable setting for the respective application has the second setting, the one or more widgets suggested for inclusion do not include other widgets of the respective application that are different from the respective suggested widget that corresponds to the respective application. In some embodiments, in accordance with a determination that the set of suggestion criteria are met and the user-configurable setting for the respective application has the second setting, the one or more widgets suggested for inclusion do not include widgets of a second respective application, different from the respective application (e.g., an application that is different from, but in the same category as, the respective application). Providing the user with the ability to enable or disable suggested widgets for a given application provides the user with greater control over the computer system and the suggestion functionality of the system. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the computer system displays (e.g., while the computer system is in a set of widgets edit mode or while the computer system is in a normal display mode for the set of widgets (e.g., a mode separate from the set of widgets edit mode)) one or more widgets suggested for inclusion in the set of widgets. In accordance with a determination that a set of suggestion criteria (e.g., contextual suggestion criteria) are met and a user-configurable setting (1026b1, 1026c1) for a respective type of widget (e.g., an information-only widget or a control/functional widget) of a respective application (e.g., Activity application of FIG. 10U) has a first setting (e.g., an enabled setting), the one or more widgets suggested for inclusion includes a respective suggested widget that corresponds to the respective type of widget of the respective application. In accordance with a determination that the set of suggestion criteria are met and the user-configurable setting for the respective type of widget of the respective application has a second setting (e.g., a disabled setting), the one or more widgets suggested for inclusion do not include a respective suggested widget that corresponds to the respective type of widget of the respective application. In some embodiments, widget suggestions for particular types of widgets for a respective application can be separately enabled or disabled. Providing the user with the ability to enable or disable suggested widgets by type for a given application provides the user with greater control over the computer system and the suggestion functionality of the system.

In some embodiments, the first context corresponds to a first weather context (e.g., rainy weather or windy weather) and the first set of widgets includes a first weather widget (e.g., 1008c) (e.g., a precipitation widget or wind-speed widget); and the second context corresponds to a second weather context and the second set of widgets includes a second weather widget (e.g., humidity widget in FIG. 10V), different from the first weather widget. Displaying different weather widgets based on different weather context performs different actions when a set of conditions are met, without requiring further user input and also provides improved visual feedback as to the current context while providing contextually-relevant widgets.

In some embodiments, the first weather context corresponds to a forecasted start of a weather event (e.g., a forecasted change in weather conditions).

In some embodiments, the first context (e.g., as per Table 1) is selected from one or more of the group consisting of: a time and/or date based context, a location-based context, an external device connectivity context (e.g., whether headphones are connected), a predicted-user-behavior based context (e.g., bed time, wake time, and/or a commute time), a physical-activity based context (e.g., an ongoing workout or a physical activity goal), and an audio based context (e.g., music based or environmental noise based).

In some embodiments, the first set of widgets includes a predetermined number of widgets (e.g., from 3-5 widgets), wherein the widgets in the first set of widgets are selected based on priority (e.g., as discussed with reference to FIG. 10I and Table 1) (e.g., a prioritization value, ranking, and/or score) from a set of available widgets. In some embodiments, the prioritization is user-defined (e.g., based on manual selection). In some embodiments, the prioritization is system-defined (e.g., by a developer of the operating system, based on the current context, and/or based on historical usage patterns). Including widgets in the set of widgets based on prioritization ensures that higher priority widgets are included so as to provide the user with improved feedback as to the highest priority information.

In some embodiments, while concurrently displaying the representation of time with the first appearance based on the first style (e.g., 1006) and the set of widgets (e.g., 612b1) that includes the first set of widgets, the computer system detects, via the one or more input devices, a user input (e.g., 1004b) (e.g., a movement input such as a swipe directed to the set of widgets and/or rotation of a rotatable input mechanism) that corresponds to a request to navigate through the set of widgets. In response to detecting the user input that corresponds to the request to navigate through the set of widgets, the computer system navigates through the set of widgets to display one or more widgets (e.g., 1008c) from the first set of widgets that were not displayed prior to detecting the user input that corresponds to the request to navigate through the set of widgets. In some embodiments, one or more widgets that were displayed prior to detecting the user input continue to be displayed after navigating through the set of widgets. In some embodiments, display of the representation of time with the first appearance based on the first style is maintained while the set of widgets is updated. Enabling navigation through the widgets allows the user to select different information to display and allows the system to select more widgets to be included in the set of widgets even if the display is not large enough to display more than a threshold number of widgets concurrently.

Note that details of the processes described above with respect to method 1100 (e.g., FIG. 11) are also applicable in an analogous manner to the methods described above and below. For example, widgets that are managed according to method 1100 can correspond to ongoing activities that are synchronized across devices according to method 900. For brevity, these details are not repeated below.

FIG. 12A illustrates device 600 displaying a set of matched wake screen user interfaces. In some embodiments, a user of device 600 can select from among a plurality of options of different sets of matched (e.g., associated) user interfaces to use as a wake screen for device 600. On the left of FIG. 12A, device 600 displays user interface 614 (see, e.g., FIG. 6D), which is a wake screen that does not include a widget stack. On the right of FIG. 12A, device 600 displays user interface 618, which is a wake screen that includes widget stack 612b. As discussed in more detail above, widget stack 612b includes one or more widgets that include information relevant to a current context of device 600. A user can navigate between the matched user interfaces, using inputs as described with reference to FIGS. 6H and 6I.

On the left of FIG. 12A, user interface 614 includes digits 614a that are in a stacked arrangement and that indicate the current time, including first digit 614a1 (e.g., that shows a first digit of the current hour) that has a first color (e.g., red), as indicated by the pattern of digit 614a1. User interface 614 also includes second digit 614a2 (e.g., that shows a first digit of the current minute value) that has a second color (e.g., blue), as indicated by the pattern of digit 614a2 that is different than the pattern of digit 614a1. User interface 614 also includes third digit 614a3 (e.g., that shows a second digit of the current minute value) that has a third color (e.g., green), as indicated by the pattern of digit 614a3 that is different than the patterns of digit 614a1 and 614a2. User interface 614 also includes background 614b that has a fourth color (e.g., yellow), as indicated by the pattern of background 614b that is different than the patterns of digits 614a1, 614a2, and 614a3.

On the right of FIG. 12A, user interface 618 includes widget stack 612b, which includes widget 612b1 that corresponds to an ongoing timer activity that is in progress, as discussed above. User interface 618 (e.g., a time interface) also includes reduced-size digital clock face 618a that includes first digit 618a1 (e.g., that shows a first digit of the current hour) that has the same first color (e.g., red) as first digit 614a1 of user interface 614, as indicated by the matching patterns of first digit 618a1 and first digit 614a1. Similarly, reduced-size digital clock face 618a includes a second digit 618a2 (e.g., that shows a second digit of the current hour) that has the same second color (e.g., blue) as second digit 614a2 of user interface 614, as indicated by the matching patterns of second digit 618a2 and second digit 614a2. Third digit 618a3 of user interface 618 also has the same color as corresponding third digit 614a3 of user interface 614. Background 618b of user interface 618 also matches the color of background 614b of user interface 614. While all of the colors of the digits of matching using interfaces 614 and 618 are same, in some embodiments, not all of the digits match in color. For example, 1 of 4 digits, 2 of 4 digits, or 3 of 4 digits could have matching colors, with the others having non-matching colors. In some embodiments, a second user interface of a set of matched user interfaces includes at least one foreground element (e.g., an indication of time, an complication, a dial) that has a color that is based on a color of a foreground element of a first user interface of the set of matched user interfaces, as well as having a background that has a color that is based on a color of the background of the first user interface of the set of matched user interfaces.

FIG. 12B shows another set of matched user interfaces. On the left, device 600 displays user interface 1014 (e.g., FIG. 10N) that does not include a widget stack. User interface 1014 includes representation of time 1014a that includes linearly arranged digits for indicating the current time. Representation of time 1014a has a first font (e.g., Arial) and a first color (e.g., blue). User interface 1014 also includes weather complication 1014b that has a second font (e.g., Times New Roman) a second color (e.g., black). User interface 1014 also includes a background having a third color (e.g., white). In the middle, device 600 displays user interface 1202, which is a wake screen with reduced-size clock face 1202a and widget stack 612b. Reduced-size clock face 1202a includes digits 1202a1 that also present the current time and are also linearly arranged. Digits 1202a1 have the same font and color as representation of time 1014a. User interface 1202 also includes date-and-time indication 1202b that have a font and color that match the font and color of weather complication 1014b of user interface 1014. User interface 1202 includes background 1202c that matches the color and pattern of background 1014c of user interface 1014. On the right, device 600 displays user interface 1204, which is another wake screen that includes widget stack 612b and that matches user interface 1014. In some embodiments, user interface 1204 is an alternate user interface to user interface 1202. In some embodiments, device 600 alternates (e.g., based on time of day) between displaying user interface 1202 and user interface 1204. In some embodiments, a user can set device 600 to display user interface 1204 or user interface 1202. User interface 1204 includes reduced-size clock face 1204a that is larger than reduced-size clock face 1202a, but is still smaller than representation of time 1014a. The color and font of reduced-size clock face 1204a match the color and font of representation of time 1014a. User interface 1204 also includes date-and-time indication 1204b that have a font and color that match the font and color of weather complication 1014b of user interface 1014. User interface 1204 includes background 1204c that has a color that is based on (e.g., matches) the color of background 1014c of user interface 1014. However, background 1204c is blurred and/or less detailed than background 1014c. In some embodiments, background 1014c is an image or graphical element that includes details that are not included in background 1204c (e.g., background 1204c is a blurred version of background 1014c). In some embodiments, background 1204c is a color gradient that includes a color in background 1014c.

FIG. 12C shows another set of matched user interfaces. On the left, device 600 displays user interface 620 (e.g., FIG. 6F). User interface 620 includes digits 620a and background 620b. In the middle, device 600 displays user interface 1206 that includes reduced-size clock face 1206a that has a font and color that match digits 620a. User interface 1206 has background 1206b that matches background 620b and includes widgets stack 612b. On the right, device 600 displays user interface 621 that includes reduced-size digital clock face 621a and background 621b. The color of background 621b matches the color of background 620b, but background 621b has a pattern that is not the same as background 620b. In some embodiments, background 621b is a blurred version of background 620b. In some embodiments, the density of the pattern of background 621b differs from the density of background 620b.

FIG. 12D shows another set of matched user interfaces. On the left, device 600 displays user interface 1208, a wake screen that does not include a widget stack. On the right, device 600 displays user interface 1210 that includes widget stack 612b. User interfaces 1208 and 1210 have matching backgrounds that include gradients of matching colors. Both user interfaces 1208 and 1210 indicate the current time via analog clock faces that have matching colors.

FIG. 12E shows a set of matched user interfaces that include a distinct visual element and/or design element. On the left, device 600 displays user interface 1212, a wake screen that does not include a widget stack. User interface 1212 includes analog clock face 1212a and background 1212b that includes a distinct visual element in the form of repeating roulette curves. In the middle, device 600 displays user interface 1214, which is a wake screen with reduced-size clock face 1214a and widget stack 612b. Clock face 1214a includes hands 1214a1 that matches the color and design of the hands of clock face 1212a, though at a smaller size. Clock face 1214a also includes background 1214a2 that matches the color and design of background 1212b. On the right, device 600 displays user interface 1216, which is another wake screen that includes widget stack 612b and that is matched with user interface 1212. In some embodiments, user interface 1216 is an alternate user interface to user interface 1214. In some embodiments, device 600 alternates (e.g., based on time of day) between displaying user interface 1214 and user interface 1216. In some embodiments, a user can set device 600 to display user interface 1214 or user interface 1216. User interface 1216 includes reduced-size analog clock face 1216a that includes hands 1216a that match the color and design of the hands of clock face 1212a, though at a smaller size. In contrast to user interface 1214, clock face 1216a of user interface 1216 does not include a discrete background visual element. Rather, user interface 1216 includes a background 1216b that is a distinct visual element that is based on, but not identical to, background 1212b. In some embodiments, background 1216b shares one or more characteristics of background 1212b, such as the color, pattern, size, and or placement on display 602. In some embodiments, background 1216b is a blurred and/or simplified (e.g., having less curves) version of background 1212b. In contrast to user interface 1210 of FIG. 12D, user interface 1216 does not include a seconds hand (e.g., because the background of user interface 1216 would make a seconds hand difficult to distinguish).

FIG. 12F shows another set of matched user interfaces. On the left, device 600 displays user interface 1218, a wake screen that does not include a widget stack. User interface 1218 includes character 1218a (e.g., an individual and/or a being; a person, an animal, and/or an anthropomorphized animal or object). On the right, device 600 displays user interface 1220 that includes widget stack 612b. User interface 1220 includes reduced-sized analog clock face 1220a that includes character 1220a1. In some embodiments, character 1220a1 shares one or more characteristics of character 1218a (e.g., color, design, pose, size, and or placement) but is not identical to character 1218a. In some embodiments, character 1220a1 has the same posse or a different pose than character 1218a. In some embodiments, character 1220a1 is a simplified version (e.g., having less details and/or features (e.g., hands with four fingers rather than five fingers)) of character 1218a.

FIG. 12G illustrates another set of matched user interfaces. On the left, device 600 displays user interface 1222, a wake screen that does not include a widget stack. User interface 1222 includes analog clock face 1222a, with hands 1222a1, including seconds hand 1222a1a. Seconds hand 1222a1a has a first color (e.g., guava) as indicated by the shading pattern. Clock face 1222a also includes dial number 1222a2 (“10”) that also has the first color. User interface 1222 also includes complication 1222c that also has elements having the first color. On the right, device 600 displays user interface 1224 that includes widget stack 612b. User interface 1224 includes reduced-size analog clock face 1224a that includes seconds hand 1224a1, which has the same first color as seconds hand 1222a1a. User interface 1224 also includes day-and-date indication 1224b that also has the same first color as seconds hands 1224a1 and 1222a1a. At FIG. 12G, device 600 detects input 1226a, a long-press (e.g., a press and hold) on user interface 1222. In some embodiments, input 1226a is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 12H, in response to input 1226a, device 600 displays clock face editing user interface 1228. User interface 1228 includes representation 1228a of the clock face being edited and edit button 1228b. At FIG. 12H, device 600 detects input 1226b, a tap on edit button 1226b. In some embodiments, input 1226b is another type of touch input (e.g., a swipe, a double tap, or a two-finger swipe), a hardware input (e.g., a button press, rotatable input mechanism rotation, and/or mouse movement), an air gesture, and/or a gaze-based input.

At FIG. 12I, in response to input 1226b, device 600 updates editing user interface 1228 with editing menu 1228c that includes various editable parameters of the clock face. In FIG. 12I, color is currently selected for editing. The currently selected first color, guava, is displayed at the bottom of user interface 1228. At FIG. 12I, device 600 detects input 1230a, a clockwise rotation of rotatable and depressible input mechanism 604. In some embodiments, input 1230a is a type of touch input (e.g., a swipe, a double tap, or a two-finger swipe), a hardware input (e.g., a button press, rotatable input mechanism rotation, and/or mouse movement), an air gesture, and/or a gaze-based input. In response to input 1230a, device 600 changes the color of certain elements of the clock face being edited to a second color (e.g., red). In some embodiments, changes to an element (e.g., color) of the clock face affects the clock faces of both user interface 1222 and matched user interface 1224. After editing, device 600 detects inputs to exit editing user interface 1228.

FIG. 12J shows matched user interfaces 1222 and 1224, after the color has been edited as described at FIG. 12I. On the left, seconds hand 1222a1a, dial number 1222a2, and complication 1222c that now all have the second color (e.g., red) as indicated by the shading pattern. On the right, seconds hand 1224a1 and day-and-date indication 1224b now also have the second color. In some embodiments, complication 1222c has a different color than seconds hand 1222a1a and the color of seconds hand 1224a1 is based on (e.g., matches) the color of seconds hand 1222a1a while day-and-date indication 1224b has a color that is based on (e.g., matches) the color of complication 1222c.

FIG. 12K shows another set of matched user interfaces. On the left, device 600 displays user interface 1228 that does not include a stack of widgets. User interface 1228 includes watch hands 1228a that have a first color (e.g., red) and complications 1228b that have a second color (e.g., blue). On the right, device 600 displays user interface 1230 that includes widget stack 612b and also includes reduced-sized analog clock face 1230a that includes watch hands 1230a1 that have a color that is based on (e.g., matches) the first color of watch hands 1228a. User interface 1230 also includes day-and-date indication 1230b that has a color that is based on (e.g., matches) the second color of complications 1228b.

FIG. 12L shows another set of matched user interfaces. On the left, device 600 displays user interface 1232 that does not include a stack of widgets. User interface 1232 includes watch face 1232a that includes dial tick marks 1232a1 having a first style (e.g., color and/or pattern). On the left, device 600 displays user interface 1234 that includes widget stack 612b and also includes reduced-size analog clock face 1234a, which includes dial tick marks 1234a1 that have a style that is based on (e.g., matches) the style of dial tick marks 1232a1.

FIG. 12M illustrates an animation that is displayed when device transitions between displaying a wake screen without a widget stack and a matched wake screen that includes a reduced-size clock face and widget stack (e.g., based on an input as described at FIG. 6I). On the left, device 600 displays user interface 1236, a wake screen without a widget stack. User interface 1236 includes clock face 1236a that includes hands 1236a1 and dial 1236a2. Device 600 detects a request to transition to user interface 1240 (on the right). As part of the transition, device 600 displays an animation transition that includes displaying interim user interface 1238 that includes hands 1236a1 but does not include dial 1236a2. The transition also includes showing hands 1236a1 shrinking and translating to the upper right, resulting in user interface 1240, shown on the right. User interface 1240 includes reduced-size analog clock face 1240a that includes reduced size hands and a reduced size dial (as compared to user interface 1236).

FIG. 13 is a flow diagram illustrating a method for displaying corresponding representations of time using a computer system, in accordance with some embodiments. Method 700 is performed at a computer system (e.g., 100, 300, 500, 600, 800a, and/or 800b) (e.g., a smartwatch, a smartphone, a tablet computer, a laptop computer, and/or a desktop computer) that is in communication with one or more display generation components (e.g., a display controller, a display, a touch-sensitive display system, a touchscreen, a head-mounted display, and/or a monitor) and one or more input devices (e.g., a touch-sensitive surface, a touchscreen display, a button, a keyboard, a mouse, a joystick, a camera sensor, and/or a microphone). Some operations in method 1300 are, optionally, combined, the orders of some operations are, optionally, changed, and some operations are, optionally, omitted.

As described below, method 1300 provides an intuitive way for displaying corresponding representations of time. The method reduces the cognitive burden on a user for displaying corresponding representations of time, thereby creating a more efficient human-machine interface. For battery-operated computing devices, enabling a user to display corresponding representations of time faster and more efficiently conserves power and increases the time between battery charges.

The computer system displays (1302), via the one or more display generation components, a time user interface (e.g., 614, 1014, 620) (e.g., a watch face) that includes an expanded representation of time (e.g., 614a, 1014a, 620a).

The computer system detects (1304) the occurrence of a condition (e.g., input 624b). In some embodiments, the condition is receiving, via the one or more input devices, a request (e.g., an input, a raise or rotation gesture, a tap gesture (e.g., on a touch-sensitive surface), a voice command, a button press, and/or a rotation of a rotatable input mechanism) to display a second time user interface (e.g., a watch face and/or a user interface that includes an indication of time). In some embodiments, the condition is a system event (e.g., receiving information and/or updates from an application).

In response to detecting the occurrence of the condition (1306), the computer system displays a time user interface (e.g., 618, 1202, 1204, 1206, 621) (e.g., a watch face and/or a user interface that includes an indication of time) that includes a condensed representation of time (e.g., 618a, 1202a, 1204a, 1206, 621a) that is smaller than the expanded representation of time, including: in accordance with a determination (1308) that a foreground element (e.g., 614a1) (e.g., a watch hand, a tick mark, text, a complication, an animated element, a graphical element, and/or a portion thereof) of the expanded representation of time had a first foreground color, a corresponding foreground element (e.g., 618a1) (e.g., a corresponding watch hand, tick mark, text, complication, animated element, graphical element, and/or portion thereof) of the condensed representation of time with an appearance that includes the first foreground color. In some embodiments, the foreground element and the corresponding foreground element are not the same type of element (e.g., the foreground element is a complication and the corresponding foreground element is a watch hand). In accordance with a determination (1310) that the foreground element of the expanded representation of time had a second foreground color (e.g., 1014a) different from the first foreground color, the corresponding foreground element (e.g., 1202a1) of the condensed representation of time with an appearance that includes the second foreground color. In accordance with a determination (1312) that a background element (e.g., background color of 614 in FIG. 12A) (e.g., a solid background, a gradient, a pattern, a graphical design, an image, and/or a portion thereof) of the expanded representation of time had a first background color, a corresponding background element (e.g., background of 618 in FIG. 12A) (e.g., a corresponding solid background, gradient, pattern, graphical design, image, and/or portion thereof) of the condensed representation of time with an appearance that includes the first background color. In accordance with a determination (1314) that the background element of the expanded representation of time had a second background color (e.g., 620b) different from the first background color, the corresponding background element (e.g., 1206b) of the condensed representation of time with an appearance that includes the second background color. In some embodiments, the condensed representation of time is a miniature version of the expanded representation of time. In some embodiments, the condensed representation of time is a variation of the expanded representation of time, such as a simplified version of the expanded representation of time. Conditionally displaying a foreground element of a condensed representation of time with a color that is based on a color of a foreground element of the expanded representation of time and a conditionally displaying a background element of a condensed representation of time with a color that is based on a color of a background element of the expanded representation of time performs an operation (e.g., display of the condensed representation) without requiring further input.

In some embodiments, a color of the foreground element of the expanded representation of time is user-selectable (e.g., editable as shown in FIGS. 12H-12J) (e.g., via an edit mode for the expanded representation of time). While the foreground element of the expanded representation of time has the first foreground color (e.g., color of 1222a2 in FIG. 12G), the computer system detects, via the one or more input devices, a request to change the foreground element of the expanded representation of time to the second foreground color. In response to detecting the request to change the foreground element of the expanded representation of time to the second foreground color (e.g., color of 1222a2 in FIG. 12J), the computer system changes the foreground element of the expanded representation of time to the second foreground color.

In some embodiments, a color of the background element of the expanded representation of time is user-selectable (e.g., editable via the edit mode shown in FIGS. 12H-12J) (e.g., via an edit mode for the expanded representation of time). While the background element of the expanded representation of time has the first background color (e.g., 620b), the computer system detects, via the one or more input devices, a request to change the background element of the expanded representation of time to the second background color.

In response to detecting the request to change the background element of the expanded representation of time to the second background color, the computer system changes the background element of the expanded representation of time to the second background color (e.g., changes from background 620b to the background of 1208 in FIG. 12D).

In some embodiments, the time user interface that includes the expanded representation of time includes a first expanded region (e.g., 614a1) (e.g., a portion of a watch face such as a specific portion of a dial) and the time user interface that includes the condensed representation of time includes a first condensed region (e.g., 618a1) that corresponds to the first expanded region (e.g., the regions convey the same information (e.g., the portion of clock dial that corresponds to 3 o'clock) and/or have a predetermined relationship). Displaying the time user interface that includes the condensed representation of time includes: in accordance with a determination that the first expanded region had a first color for the expanded region, the first condensed region has an appearance that includes the first color for the expanded region; and in accordance with a determination that the first expanded region had a second color for the expanded region that is different from the first color for the expanded region, the first condensed region has an appearance that includes the second color for the expanded region. Conditionally displaying a region of a condensed representation of time with a color that is based on a color of the corresponding region of the expanded representation of time performs an operation (e.g., design and display of the condensed representation region) without requiring further input.

In some embodiments, the first condensed region includes an indication of a current date (e.g., 1224b) and the first expanded region includes a complication (e.g., 1222c) (e.g., an element of the expanded representation that is other than an indicator of the current time) of the time user interface that includes the expanded representation of time, or (in some embodiments, and) the first condensed region includes at least a portion of the indication of the current time of the condensed representation of time and the first expanded region includes at least a portion of the indication of the current time of the time user interface that includes the expanded representation of time. Displaying the condensed region (e.g., the current date or current time) with an appearance that includes a color from a corresponding expanded region (e.g., a complication or current time) maintains visual continuity/consistency between the expanded and condensed representations of time, which provides improved visual feedback as to the relationship between the representations and reduces the need for additional user inputs to configure the representations to include the same color.

In some embodiments, the time user interface that includes the expanded representation of time includes a first text element (e.g., 1014a) having a first appearance; in some embodiments, the first appearance is a user-selected appearance configured via a set of editing inputs (e.g., received while in an editing mode) and the set of editing inputs is made only for the expanded representation or the condensed representation but the change in appearance is propagated to the corresponding representation without requiring additional user inputs. Displaying the time user interface that includes the condensed representation of time includes a second text element (1202a1) having a second appearance. The second appearance of the second text element is based on (e.g., matches the style, font and/or size of) the first appearance of the first text element. Displaying the condensed representation of time (e.g., the second text element) with an appearance that includes an appearance from a corresponding representation of time (e.g., the first text element) maintains visual continuity/consistency between the expanded and condensed representations of time, which provides improved visual feedback as to the relationship between the representations and reduces the need for additional user inputs to configure the representations to include the corresponding appearance.

In some embodiments, the time user interface that includes the expanded representation of time includes a third text element (e.g., 620a) having a third appearance; the time user interface that includes the condensed representation of time includes a fourth text element (e.g., 1206a) having a fourth appearance; and the fourth appearance is based on (e.g., matches the style and/or size of) the third appearance. Displaying the condensed representation of time (e.g., the fourth text element) with an appearance that includes an appearance from a corresponding expanded representation of time (e.g., the third text element) maintains visual continuity/consistency between the expanded and condensed representations of time, which provides improved visual feedback as to the relationship between the representations and reduces the need for additional user inputs to configure the representations to include the corresponding appearance.

In some embodiments, the first text element is text of a complication (e.g., 1014b) (in some embodiments, a complication is a visual element of a representation of time (e.g., a clock face or a watch face) that provides information and/or functionality beyond presenting the current time; examples of complications can include, but are not limited to, a complication that displays the date, a complication that provides heart rate information and heart rate measurement functions, a complication that provides workout information and workout related functions, and a calendar complication that provides event information and calendar-related functions) and the second text element (e.g., 1202b) is a current date. The third text element is text of a current time and the fourth text element is text of the current time. In some embodiments, the appearance of the complication and/or current time is configured via a set of editing inputs (e.g., received while in an editing mode) and the set of editing inputs is made only for the expanded representation or the condensed representation but the change in appearance is propagated to the corresponding representation without requiring additional user inputs. Displaying the current date with an appearance that includes an appearance from a corresponding complication maintains visual continuity/consistency between the expanded and condensed representations of time, which provides improved visual feedback as to the relationship between the representations and reduces the need for additional user inputs to configure the representations to include the corresponding appearance.

In some embodiments, while a first element (e.g., 1222a) of the expanded representation of time is configured to have a first appearance, when displayed, and a second element (e.g., 1224a) of the condensed representation of time is configured to have a second appearance, when displayed, that is based on the first appearance, the computer system detects, via the one or more input devices, a first set of one or more inputs (e.g., 1226a, 1226b, 1230a) that correspond to a request to change the appearance of the of the first element of the expanded representation of time or the second element of the condensed representation of time (e.g., via the edit mode shown in FIGS. 12H-12J). In response to the first set of one or more inputs: the computer system changes the first element of the expanded representation of time from being configured to have the first appearance, when displayed, to being configured to have a third appearance, when displayed (e.g., appearance of 1222a in FIG. 12J); and the computer system changes the second element of the condensed representation of time from the being configured to have the third appearance, when displayed, to being configured to have a fourth appearance (e.g., appearance of 1224b in FIG. 12J), when displayed, that is based on the third appearance. In some embodiments, changes that are made to an appearance of a representation of time (expanded or condensed) apply to both the expanded and condensed representations of time without having to manually change both. Changing both the expanded and condensed representations of time when edits are made maintains visual continuity/consistency between the expanded and condensed representations of time, which provides improved visual feedback as to the relationship between the representations and reduces the need for additional user inputs to configure the representations to include the corresponding appearance.

In some embodiments, the computer system detects, via the one or more input devices, a second set of one or more inputs that correspond to a request to change a respective display property (e.g., a color, a font, background, language, text style, text arrangement, and/or inclusion or exclusion of elements) of the expanded representation of time and/or a respective display property the condensed representation of time. In response to the second set of one or more inputs and in accordance with a determination the second set of one or more inputs corresponds to a request to change a first display property: changing the first display property for the expanded representation of time without changing a second display property for the expanded representation of time (e.g., changing the color of the foreground elements of 1228 as shown in 12I without changing the background elements of 1228); and changing the first display property for the condensed representation of time without changing the second display property for the expanded representation of time. In response to the second set of one or more inputs and in accordance with a determination the second set of one or more inputs corresponds to a request to change the second display property: changing the second display property for the expanded representation of time without changing the first display property for the expanded representation of time; and changing the second display property for the condensed representation of time without changing the first display property for the expanded representation of time (e.g., changing the color of the foreground elements of 1224 as shown in 12J without changing the background elements of 1224). In some embodiments, changes that are made to a specific property of a representation of time (expanded or condensed) affect only the specific property and apply to both the expanded and condensed representations of time without having to manually change both. For example, the color of background of the expanded representation of time can be made without affecting foreground colors of the expanded representation of time, with a matching change in the condensed representation of time (e.g., the background color changing without any other color changing). In another example, a type of tick mark for the condensed representation of time without affecting the clock hands and a corresponding change is made to the tick marks of the expanded representation of time. Changing both the expanded and condensed representations of time when edits are made maintains visual continuity/consistency between the expanded and condensed representations of time, which provides improved visual feedback as to the relationship between the representations and reduces the need for additional user inputs to configure the representations to include the corresponding property.

In some embodiments, the time user interface that includes the condensed representation of time: in accordance with a determination that the expanded representation of time included a representation of a current seconds value of the current time (e.g., seconds hand of 1208), includes a representation of the current seconds value of the current time (e.g., seconds hand of 1210); and in accordance with a determination that the expanded representation of time did not include a representation of a current seconds value of the current time (e.g., 1206a), does not include a representation of the current seconds value of the current time (e.g., 621a). In some embodiments, the inclusion or exclusion of the seconds value is configured via a set of editing inputs (e.g., received while in an editing mode) and the set of editing inputs is made only for the expanded representation or the condensed representation but the change that affects the seconds value is propagated to the corresponding representation without requiring additional user inputs. Conditionally including a representation of the current seconds value based on whether the expanded representation of time included the current seconds value performs an operation (e.g., design and display of the condensed representation) without requiring further input.

In some embodiments, the time user interface that includes the expanded representation of time is organized according to a first organizational pattern (e.g., layout and/or style (e.g., a linear layout versus a stacked layout)); and the time user interface that includes the condensed representation of time is organized according to a second organizational pattern that is based on the first organizational pattern (e.g., matches and/or is derived from). In some embodiments, the organizational pattern is configured via a set of editing inputs (e.g., received while in an editing mode) and the set of editing inputs is made only for the expanded representation or the condensed representation but the change in pattern is propagated to the corresponding representation without requiring additional user inputs. Changing the organizational pattern of both the expanded and condensed representations of time when edits are made maintains visual continuity/consistency between the expanded and condensed representations of time, which provides improved visual feedback as to the relationship between the representations and reduces the need for additional user inputs to configure the representations to include the corresponding organizational pattern.

In some embodiments, the expanded representation of time (e.g., 1232) is an analog representation of time (e.g., a representation using clock hands) that includes tick marks (e.g., 1232a1) (e.g., repeating visual elements that indicate a repeating unit of time (e.g., 1 second and/or 1 minute tick marks or 5 second or 5 minute tick marks)) having a first tick mark style; and the condensed representation of time (e.g., 1232a) is an analog representation of time that includes tick marks (e.g., 1234a1) based on (e.g., matching shape, number, and/or color) the first tick mark style. In some embodiments, the tick marks are configured via a set of editing inputs (e.g., received while in an editing mode) and the set of editing inputs is made only for the expanded representation or the condensed representation but the change in tick marks is propagated to the corresponding representation without requiring additional user inputs. Changing the tick marks of both the expanded and condensed representations of time when edits are made maintains visual continuity/consistency between the expanded and condensed representations of time, which provides improved visual feedback as to the relationship between the representations and reduces the need for additional user inputs to configure the representations to include the corresponding tick marks.

In some embodiments, the expanded representation of time includes a first time indicator element (e.g., 620a) (e.g., a clock hand or a digit) that has a first indicator color and/or a first indicator shape; and the condensed representation of time includes a second time indicator element (e.g., 621a) that has a second indicator color that matches the first indicator color and/or a second indicator shape that matches the first indicator shape. In some embodiments, the appearance of the time indicator is configured via a set of editing inputs (e.g., received while in an editing mode) and the set of editing inputs is made only for the expanded representation or the condensed representation but the change in appearance of the time indicator is propagated to the corresponding representation without requiring additional user inputs. Changing the time indicators of both the expanded and condensed representations of time when edits are made maintains visual continuity/consistency between the expanded and condensed representations of time, which provides improved visual feedback as to the relationship between the representations and reduces the need for additional user inputs to configure the representations to include the corresponding time indicator.

In some embodiments, displaying the time user interface that includes a condensed representation of time includes displaying an animation of the expanded representation of time transitioning into the condensed representation of time (e.g., as discussed with reference to FIGS. 6I and 12M). In some embodiments, the expanded representation of time is displayed in a first region of the one or more display generation components and the condensed representation of time is displayed in a second region of the one or more display generation components and the animation includes translating (e.g., moving and/or shifting) the representation of time from the first region to the second region (in some embodiments, and reducing the size during translation).

In some embodiments, while displaying the time user interface with the condensed representation of time, the computer system detects (in some embodiments, an input (e.g., a swipe on a touch-sensitive surface or a rotation of a rotatable input mechanism) detected via the one or more input devices) a request to display the time user interface with the expanded representation of time. In response to detecting the request to display the time user interface with the expanded representation of time, the computer system displays an animation of the condensed representation of time transitioning into the expanded representation of time (e.g., as discussed with reference to FIGS. 6I and 12M). In some embodiments, the condensed representation of time is displayed in a second region of the one or more display generation components and the expanded representation of time is displayed in a first region of the one or more display generation components and the animation includes translating (e.g., moving and/or shifting) the representation of time from the second region to the first region (in some embodiments, and increasing the size during translation).

In some embodiments, the background element (e.g., 620b) of the expanded representation of time had a first set of colors arranged according to a first color pattern and the background element (e.g., 1206b) of condensed representation of time matches the first set of colors and is also arranged according to the first color pattern. In some embodiments, the background color scheme and pattern of the condensed representation of time matches the background color scheme and pattern of the expanded representation of time.

In some embodiments, the background element of the condensed representation of time has a reduced visual emphasis (e.g., is blurred out, dimmed, faded, and/or desaturated) in comparison to the background element of the expanded representation of time (e.g., as discussed with reference to FIG. 12B) (in some embodiments, is generated by blurring the background element of the expanded representation of time).

In some embodiments, the time user interface that includes the condensed representation of time includes a first user interface object (e.g., 612b1) (e.g., a widget) that includes contextual information (in some embodiments, contextual information that is not included in the user interface that includes the expanded representation of time) that corresponds to an ongoing activity (e.g., an activity of a first type). In some embodiments, the first user interface object is a representation of an activity of first type as described with respect to FIGS. 6A-6AQ. Including a user interface object that includes contextual information in the user interface that interface that includes the condensed representation of time optimizes use of real estate of the one or more display generation components that is freed up by displaying the condensed representation and also provides improved visual feedback as the current contextual state of the computer system. Doing so enhances the operability of the computer system and makes the user-system interface more efficient (e.g., by helping the user to provide proper inputs and reducing user mistakes when operating/interacting with the system) which, additionally, reduces power usage and improves battery life of the system by enabling the user to use the device more quickly and efficiently.

In some embodiments, the time user interface that includes the condensed representation of time includes a set of widgets (e.g., 612b) that includes at least one widget that includes contextual information (in some embodiments, contextual information that is not included in the user interface that includes the expanded representation of time). In some embodiments, the set of widgets includes one or more features described with respect to FIGS. 10A-10V. Including a set of widgets that includes a widget that includes contextual information in the user interface that interface that includes the condensed representation of time optimizes use of the real estate of the one or more display generation components that is freed up by displaying the condensed representation and also provides improved visual feedback as the current contextual state of the computer system.

Note that details of the processes described above with respect to method 1300 (e.g., FIG. 13) are also applicable in an analogous manner to the methods described above. For example, corresponding representations of time displayed according to method 1300 can include a representation of time displayed according to method 700. In another example, a representation of time displayed according to method 1300 can be displayed with a set of widgets that is managed according to method 1100. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve the display of representations of time and ongoing activities. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of representations of ongoing activities, the present technology can be configured to allow users to select to “opt in” or “opt out” of participation in the collection of personal information data during registration for notifications or anytime thereafter. In another example, users can select not to provide sensor data for tracking certain ongoing activities. In yet another example, users can select to limit the length of time such data is maintained or entirely prohibit the development of a baseline sensor profile data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, information for ongoing activities can be selected and delivered to users by inferring preferences based on non-personal information data or a bare minimum amount of personal information, such as the content being requested by the device associated with a user, other non-personal information available to the system, or publicly available information.

1-116. (canceled)

117. A computer system configured to communicate with one or more display generation components and one or more input devices, comprising:
one or more processors; and
memory storing one or more programs configured to be executed by the one or more processors, the one or more programs including instructions for:
receiving, via the one or more input devices, a request to display a time user interface;
in response to receiving the request to display the time user interface:
in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and
in accordance with a determination that an activity of the first type is not in progress and the first style has been selected for the time user interface, displaying, via the one or more display generation components, a second time user interface that includes a first expanded representation of the current time without including a representation of an activity of the first type, wherein:
the first condensed representation of the current time on the first time user interface is smaller than the first expanded representation of the current time on the second time user interface; and
both the first condensed representation of the current time and the first expanded representation of the current time are displayed with an appearance that is based on the first style; and
in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and
in accordance with a determination that an activity of the first type is not in progress and the second style has been selected for the time user interface, displaying, via the one or more display generation components, a fourth time user interface that includes a second expanded representation of the current time without including a representation of an activity of the first type, wherein:
the second condensed representation of the current time on the third time user interface is smaller than the second expanded representation of the current time on the fourth time user interface;
both the second condensed representation of the current time and the second expanded representation of the current time are displayed with an appearance that is based on the second style;
the first expanded representation of the current time has a different appearance than the second expanded representation of the current time; and
the first condensed representation of the current time has a different appearance than the second condensed representation of the current time.

118. The computer system of claim 117, wherein the activity of the first type is an activity that has a state that is updated over time, the one or more programs further including instructions for:
detecting a change in the state of the activity of the first type from a first state to a second state; and
in response to detecting the change in the state of the activity of the first type, updating the representation of the activity of the first type based on the second state of the activity of the first type.

119. The computer system of claim 117, wherein the first condensed representation of the current time includes date information.

120. The computer system of claim 117, wherein the representation of the activity of the first type is a user-selectable graphical user interface object that is displayed as part of a plurality of user-selectable graphical user interface objects.

121. The computer system of claim 120, wherein the plurality of user-selectable graphical user interface objects includes:
a first user-selectable graphical user interface object that corresponds to a first application; and
a second user-selectable graphical user interface object that corresponds to a second application, different from the first application.

122. The computer system of claim 120, the one or more programs further including instructions for:
while the plurality of user-selectable graphical user interface objects is displayed, detecting, via the one or more input devices, a first user input; and
in response to detecting the first user input, updating the plurality of user-selectable graphical user interface objects to include a third user-selectable graphical object.

123. The computer system of claim 117, wherein the representation of the activity of the first type includes a first set of information corresponding to the activity of the first type, the one or more programs further including instructions for:
while the representation of the activity of the first type is displayed, detecting, via the one or more input devices, a second user input; and
in response to detecting the second user input:
ceasing to display the representation of the activity of the first type; and
displaying an indicator of the activity of the first type that includes a second set of information corresponding to the activity of the first type, wherein the first set of information corresponding to the activity of the first type includes first information that is not included in the second set of information corresponding to the activity of the first type.

124. The computer system of claim 123, wherein displaying the indicator of the activity of the first type includes:
in accordance with a determination that the activity of the first type corresponds to an electronic device of a first type, displaying the indicator of the activity of the first type with a first visual appearance; and
in accordance with a determination that the activity of the first type corresponds to an electronic device of a second type, different from the first type, displaying the indicator of the activity of the first type with a second visual appearance, different from the first visual appearance.

125. The computer system of claim 123, wherein displaying the indicator of the activity of the first type includes:
in accordance with a determination that the activity of the first type is in a first state, displaying the indicator of the activity of the first type with a first animated effect; and
in accordance with a determination that the activity of the first type is in a second state different from the first state, displaying the indicator of the activity of the first type without the first animated effect.

126. The computer system of claim 123, wherein the indicator of the activity of the first type, when displayed, is displayed at a first location of the one or more display generation components, the one or more programs further including instructions for:
receiving data corresponding to a notification event; and
in response to receiving the data corresponding to the notification event, displaying, at the first location, a notification indicator.

127. The computer system of claim 123, wherein the activity of the first type corresponds to a respective application, the one or more programs further including instructions for:
detecting, via the one or more input devices, a user input corresponding to the indicator of the activity of the first type; and
in response to detecting the user input corresponding to the indicator of the activity of the first type:
in accordance with a determination that the respective application is available on the computer system, displaying a user interface of the respective application; and
in accordance with a determination that the respective application is not available on the computer system, displaying information corresponding to the activity of the first type without displaying the respective application.

128. The computer system of claim 117, the one or more programs further including instructions for:
receiving data corresponding to an event associated with the activity of the first type; and
in response to receiving the data corresponding to the event associated with the activity of the first type, displaying a notification corresponding to the activity of the first type.

129. The computer system of claim 128, wherein displaying the notification corresponding to the activity of the first type includes:
in accordance with a determination that the notification corresponding to the activity of the first type is being displayed concurrently with a respective application user interface, displaying the notification corresponding to the activity of the first type at a first size; and
in accordance with a determination that the notification corresponding to the activity of the first type is being displayed concurrently with a respective user interface, wherein the respective user interface is different from the respective application user interface, displaying the notification corresponding to the activity of the first type at a second size, that is different from the first size.

130. The computer system of claim 128, the one or more programs further including instructions for:
detecting, via the one or more input devices, a user input corresponding to the notification corresponding to the activity of the first type; and
in response to detecting the user input corresponding to the notification corresponding to the activity of the first type, displaying information corresponding to the activity of the first type.

131. The computer system of claim 130, wherein detecting the user input corresponding to the notification corresponding to the activity of the first type includes detecting a first portion of a respective input and wherein displaying information corresponding to the activity of the first type includes displaying a first set of information corresponding to the activity of the first type, the one or more programs further including instructions for:
after displaying the first set of information corresponding to the activity of the first type, detecting a second portion of the respective input; and
in response to detecting the second portion of the respective input, displaying a second set of information corresponding to the activity of the first type that includes information not included in the first set of information corresponding to the activity of the first type.

132. The computer system of claim 131, the one or more programs further including instructions for:
after displaying the second set of information:
in accordance with a determination that a characteristic of the second portion of the respective input meets a threshold, continuing to display at least the second set of information; and
in accordance with a determination that the characteristic of the second portion of the respective input does not meet the threshold, ceasing to display the second set of information.

133. The computer system of claim 128, wherein the notification corresponding to the activity of the first type has a visual appearance that is the same as the visual appearance of the representation of the activity of the first type.

134. The computer system of claim 133, wherein the notification corresponding to the activity of the first type is displayed at a location of the one or more display generation components that is a same location of the one or more display generation components at which the representation of the activity of the first type is displayed, when the representation of the activity of the first type is displayed.

135. The computer system of claim 117, the one or more programs further including instructions for:
detecting that a first activity of the first type has been initiated; and
in response to detecting that the first activity of the first type has been initiated:
in accordance with a determination that a first set of criteria is met, displaying a representation of the first activity of the first type as part of a second plurality of user-selectable graphical user interface objects that are arranged in an order, wherein the representation of the first activity of the first type is displayed at a predetermined position within the order.

136. The computer system of claim 135, wherein the first set of criteria includes a criterion that is met when a first user-selectable option is currently selected and wherein the first activity of the first type corresponds to a first respective application, the one or more programs further including instructions for:
detecting that a second activity of the first type has been initiated, wherein the second activity of the first type corresponds to a second respective application different from the first respective application; and
in response to detecting that the second activity of the first type has been initiated:
in accordance with a determination that a second set of criteria is met, wherein the second set of criteria includes a criterion that is met when the first user-selectable option is currently selected, displaying a representation of the second activity of the first type.
in accordance with a determination that the second set of criteria are not met, forgoing displaying the representation of the second activity of the first type.

137. The computer system of claim 135, wherein the first set of criteria includes a criterion that is met when a first user-selectable option is currently selected and wherein the activity of the first type corresponds to a first respective application, the one or more programs further including instructions for:
detecting that a second activity of the first type has been initiated, wherein the second activity of the first type corresponds to a second respective application different from the first respective application; and
in response to detecting that the second activity of the first type has been initiated:
in accordance with a determination that a second set of criteria is met, wherein the second set of criteria includes a criterion that is met when a second user-selectable option is currently selected, displaying a representation of the second activity of the first type, wherein the second user-selectable option is different from the first user-selectable option; and
in accordance with a determination that the second set of criteria are not met, forgoing displaying the representation of the second activity of the first type.

138. The computer system of claim 117, the one or more programs further including instructions for:
detecting that a fourth activity of the first type has been initiated; and
in response to detecting that the fourth activity of the first type has been initiated:
displaying a representation of the fourth activity of the first type; and
in accordance with a determination that a set of option display criteria is met, displaying an options user interface that includes one or more of:
a first user-selectable interface object that, when selected, configures the computer system to display representations of activity of the first type for subsequently initiated activity of the first type; and
a second user selectable interface object that, when selected, configures the computer to suppress display of representations of activity of the first type for subsequently initiated activity of the first type; and
in accordance with a determination that the set of option display criteria are not met, forgoing displaying the options user interface.

139. The computer system of claim 117, wherein the activity of the first type is selected from the group consisting of: a timer activity, an alarm activity, a stopwatch activity, a media-playback activity, a media recommendation activity, a physical-activity-tracking activity, a navigation activity, a phone-call activity, a voice-memorandum activity, a sporting-event-tracking activity, a reservation activity, a third-party application activity, and a combination thereof.

140. A non-transitory computer-readable storage medium storing one or more programs configured to be executed by one or more processors of a computer system that is in communication with one or more display generation components and one or more input devices, the one or more programs including instructions for:
receiving, via the one or more input devices, a request to display a time user interface;
in response to receiving the request to display the time user interface:
in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and
in accordance with a determination that an activity of the first type is not in progress and the first style has been selected for the time user interface, displaying, via the one or more display generation components, a second time user interface that includes a first expanded representation of the current time without including a representation of an activity of the first type, wherein:
the first condensed representation of the current time on the first time user interface is smaller than the first expanded representation of the current time on the second time user interface; and
both the first condensed representation of the current time and the first expanded representation of the current time are displayed with an appearance that is based on the first style; and
in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and
in accordance with a determination that an activity of the first type is not in progress and the second style has been selected for the time user interface, displaying, via the one or more display generation components, a fourth time user interface that includes a second expanded representation of the current time without including a representation of an activity of the first type, wherein:
the second condensed representation of the current time on the third time user interface is smaller than the second expanded representation of the current time on the fourth time user interface;
both the second condensed representation of the current time and the second expanded representation of the current time are displayed with an appearance that is based on the second style;
the first expanded representation of the current time has a different appearance than the second expanded representation of the current time; and
the first condensed representation of the current time has a different appearance than the second condensed representation of the current time.

141. A method, comprising:
at a computer system that is in communication with one or more display generation components and one or more input devices:
receiving, via the one or more input devices, a request to display a time user interface;
in response to receiving the request to display the time user interface:
in accordance with a determination that an activity of a first type is in progress, and a first style has been selected for the time user interface, displaying, via the one or more display generation components, a first time user interface that includes a first condensed representation of a current time that is displayed concurrently with a representation of the activity of the first type; and
in accordance with a determination that an activity of the first type is not in progress and the first style has been selected for the time user interface, displaying, via the one or more display generation components, a second time user interface that includes a first expanded representation of the current time without including a representation of an activity of the first type, wherein:
the first condensed representation of the current time on the first time user interface is smaller than the first expanded representation of the current time on the second time user interface; and
both the first condensed representation of the current time and the first expanded representation of the current time are displayed with an appearance that is based on the first style; and
in accordance with a determination that an activity of the first type is in progress and a second style, different from the first style, has been selected for the time user interface, displaying, via the one or more display generation components, a third time user interface that includes a second condensed representation of a current time that is displayed concurrently with the representation of the activity of the first type; and
in accordance with a determination that an activity of the first type is not in progress and the second style has been selected for the time user interface, displaying, via the one or more display generation components, a fourth time user interface that includes a second expanded representation of the current time without including a representation of an activity of the first type, wherein:
the second condensed representation of the current time on the third time user interface is smaller than the second expanded representation of the current time on the fourth time user interface;
both the second condensed representation of the current time and the second expanded representation of the current time are displayed with an appearance that is based on the second style;
the first expanded representation of the current time has a different appearance than the second expanded representation of the current time; and
the first condensed representation of the current time has a different appearance than the second condensed representation of the current time.
